(19) United States
(12) Patent Application Publication
(10) Pub. No.: US 2026/0101104 A1
(43) Pub. Date: Apr. 9, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KOTA IMAEDA, TOKYO (JP); KAZUHIRA OKADA, TOKYO (JP); DAISUKE TAHARA, TOKYO (JP); KEI KAKIDANI, TOKYO (JP)

(21) Appl. No.: 19/114,213

(22) PCT Filed: Sep. 15, 2023
(86) PCT No.: PCT/JP2023/033688

§ 371 Date: Mar. 21, 2025

(30) Foreign Application Priority Data
Sep. 29, 2022 (JP) 2022-157055

(51) Int. Cl. H04N 23/63; H04N 7/18; H04N 23/69

(52) U.S. Cl. CPC H04N 23/635; H04N 7/181; H04N 23/69

(57) ABSTRACT

An information processing apparatus includes a video processing unit that performs in parallel processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.

### TECHNICAL FIELD

The present technology relates to an information processing apparatus, an information processing method, and a program, and is a technology relating to display of a video or a virtual video of an imaging target space.

### BACKGROUND ART

There is known a technique of displaying an imaging direction and a depth of field by a camera.

Patent Document 1 below discloses a technique of displaying a depth of field and an angle of view on the basis of imaging information. Patent Document 2 below discloses expressing an imaging range in a captured image using a trapezoidal figure. Patent Document 3 below discloses that a map image for indicating a depth position and a focus position of an object to be imaged is generated and displayed.

### CITATION LIST

### Patent Document

Patent Document 1: Japanese Patent Application Laid-Open No. 2013-183217

Patent Document 2: Japanese Patent Application Laid-Open No. 2009-60337

Patent Document 3: Japanese Patent Application Laid-Open No. 2010-177741

### SUMMARY OF THE INVENTION

### Problems to be Solved by the Invention

For example, in a system that captures a video for broadcasting or distribution, it is convenient to enable a camera operator, a director, or the like to grasp an imaging direction or an angle of view of one or a plurality of cameras, a subject position being focused, or the like. Therefore, it is conceivable to display an imaging range according to the angle of view in a quadrangular pyramid shape. However, in the case of presenting such an imaging range, desirable information contents and display modes differ depending on roles. For example, the camera operator and the director have different desirable information contents and display modes.

Therefore, the present disclosure proposes a technique capable of presenting information by an appropriate video according to a role of a staff.

### Solutions to Problems

An information processing apparatus according to the present technology includes a video processing unit that performs in parallel processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.

The imaging range presentation video is a video indicating an imaging range determined by an imaging direction and a zoom angle of view of a camera. The first video data and the second video data are generated in parallel as the video data for displaying the video including the imaging range presentation video.

### BRIEF DESCRIPTION OF DRAWINGS

FIG. 1 is an explanatory diagram of imaging by an imaging system of an embodiment of the present technology.

FIG. 2 is an explanatory diagram of augmented reality (AR) superimposed video.

FIG. 3 is an explanatory diagram of a system configuration of the embodiment.

FIG. 4 is an explanatory diagram of another example of the system configuration of the embodiment.

FIG. 5 is an explanatory diagram of an environment map of the embodiment.

FIG. 6 is an explanatory diagram of drift correction of the environment map of the embodiment.

FIG. 7 is a block diagram of an information processing apparatus of the embodiment.

FIG. 8 is an explanatory diagram of a view frustum of the embodiment.

FIG. 9 is an explanatory diagram of a display example of a captured video on a focus plane of the view frustum of the embodiment.

FIG. 10 is an explanatory diagram of a display example of a captured video within a depth of field of the view frustum of the embodiment.

FIG. 11 is an explanatory diagram of a display example of a captured video at a position near a starting point of the view frustum of the embodiment.

FIG. 12 is an explanatory diagram of a display example of a captured video on a far end face of the view frustum of the embodiment.

FIG. 13 is an explanatory diagram in a case where the view frustum of the embodiment is at infinity.

FIG. 14 is an explanatory diagram of a change in a display state of a captured video on a far end side of the view frustum of the embodiment.

FIG. 15 is an explanatory diagram of a display example of a captured video outside the view frustum of the embodiment.

FIG. 16 is an explanatory diagram of a display example of a captured video inside and outside a plurality of view frustums of the embodiment.

FIG. 17 is an explanatory diagram of a display example of a captured video outside the view frustum of the embodiment.

FIG. 18 is an explanatory diagram of a display example of a captured video outside the view frustum of the embodiment.

FIG. 19 is a flowchart of a processing example of the information processing apparatus of the embodiment.

FIG. 20 is a flowchart of an example of display position setting processing for a captured image of the embodiment.

FIG. 21 is a flowchart of an example of display position setting processing for a captured image of the embodiment.

FIG. 22 is a flowchart of an example of display position setting processing for a captured image of the embodiment.

FIG. 23 is a flowchart of an example of display position setting processing for a captured image of the embodiment.

FIG. 24 is a flowchart of an example of display position setting processing for a captured image of the embodiment.

FIG. 25 is an explanatory diagram of collision determination of the embodiment.

FIG. 26 is an explanatory diagram of collision determination of the embodiment.

FIG. 27 is an explanatory diagram of a change of a bird's-eye view video in the embodiment.

FIG. 28 is an explanatory diagram of a bird's-eye view video on a director side of the embodiment.

FIG. 29 is an explanatory diagram of a determination of a video to be highlighted of the embodiment.

FIG. 30 is a flowchart of a processing example of the information processing apparatus of the embodiment.

FIG. 31 is a flowchart of an example of processing for highlighting of the embodiment.

FIG. 32 is a flowchart of an example of processing for highlighting of the embodiment.

FIG. 33 is an explanatory diagram of a display example using feedback of the embodiment.

FIG. 34 is a flowchart of a processing example of display using feedback of the embodiment.

FIG. 35 is an explanatory diagram of a display example of an overlapping view frustum of the embodiment.

FIG. 36 is a flowchart of a processing example of display of the overlapping view frustum of the embodiment.

FIG. 37 is an explanatory diagram of priority display of one view frustum of the embodiment.

FIG. 38 is a flowchart of a processing example in a case where priority display of the embodiment is performed.

FIG. 39 is an explanatory diagram of a display example on a director side of an instruction frustum of the embodiment.

FIG. 40 is an explanatory diagram of a display example on a camera operator side of the instruction frustum of the embodiment.

FIG. 41 is a flowchart of generation processing of a bird's-eye view video of a different embodiment.

FIG. 42 is an explanatory diagram of a display example on the camera operator side of the instruction frustum of the embodiment.

FIG. 43 is a flowchart of generation processing of a bird's-eye view video on the camera operator side of the embodiment.

FIG. 44 is an explanatory diagram of a display example on the camera operator side of instruction information of the embodiment.

FIG. 45 is a flowchart of generation processing of a bird's-eye view video on the camera operator side of the embodiment.

FIG. 46 is an explanatory diagram of a display example of a marker frustum of the embodiment.

FIG. 47 is an explanatory diagram of a display example of a marker of the embodiment.

FIG. 48 is a flowchart of a processing example of display of marker information of the embodiment.

FIG. 49 is an explanatory diagram of a display example of a bird's-eye view video of a different embodiment.

FIG. 50 is an explanatory diagram of a display example of a bird's-eye view video of a different embodiment.

FIG. 51 is an explanatory diagram of a display example on the director side of the embodiment.

FIG. 52 is a flowchart of generation processing of a bird's-eye view video of a different embodiment.

### MODE FOR CARRYING OUT THE INVENTION

Hereinafter, an embodiment will be described in the following order.
1. System configuration
2. Configuration of information processing apparatus
3. Display of view frustum
4. Screen examples of camera operator and director
4-1: Highlighting
4-2: Priority display
4-3: Instruction display
4-4: Marker display
4-5: Examples of various displays
5. Summary and modifications

Note that, in the present disclosure, a “video” or a “image” includes both a moving image and a still image. However, in an embodiment, a case of capturing a moving image will be described as an example.

### 1. System Configuration

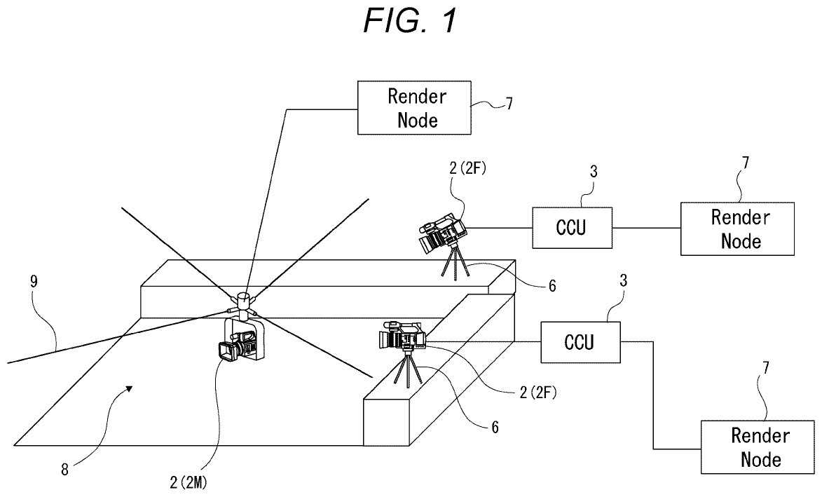

In the embodiment, an imaging system capable of generating a so-called AR video that combines a virtual video with a live-action video is taken as an example. FIG. 1 schematically illustrates a state of imaging by an imaging system.

FIG. 1 illustrates an example in which three cameras 2 are arranged in a real imaging target space 8 and imaging is performed. The three cameras are an example, and one or a plurality of cameras 2 is used.

The imaging target space 8 may be any place, and as an example, a stadium such as soccer or rugby is assumed.

In the example of FIG. 1, as the camera 2, a mobile camera 2M that is suspended by a wire 9 and can move above the imaging target space 8 is illustrated. The video captured by the mobile camera 2M and the metadata are sent to the render node 7.

Furthermore, as the camera 2, for example, a fixed camera 2F fixedly arranged by a tripod 6 or the like is also illustrated. The captured video and metadata of the fixed camera 2F are sent to the render node 7 via a camera control unit (CCU) 3.

Note that the captured video or metadata of the mobile camera 2M may be transmitted to the render node 7 via the CCU 3. Hereinafter, the “camera 2” collectively refers to the Cameras 2F and 2M.

The render node 7 described herein indicates a computer graphics (CG) engine that generates a CG and combines a CG with a live-action video, a video processing processor, and the like, and is, for example, a device that generates an AR video.

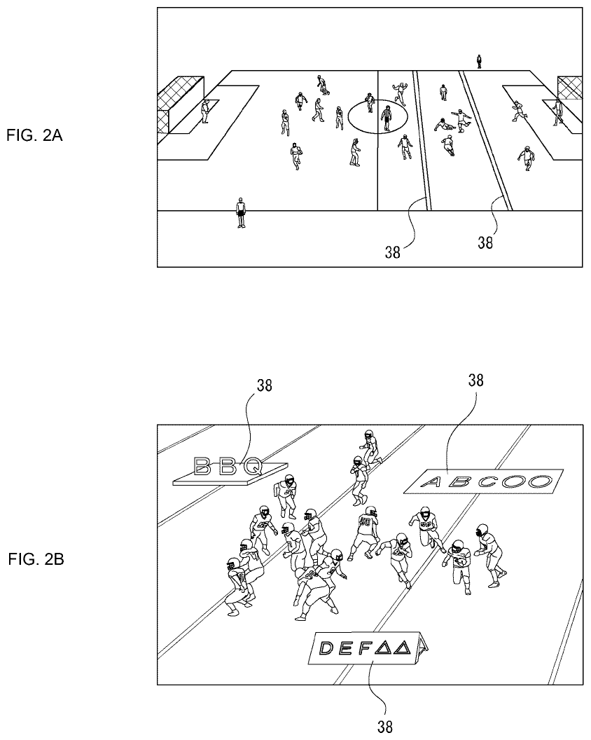

FIGS. 2A and 2B illustrate examples of the AR video. In FIG. 2A, a line that does not actually exist as image 38 by CG is combined with a video captured during a game in a stadium. In FIG. 2B, an advertisement logo that does not actually exist as image 38 is combined with the live-action video in the stadium.

By appropriately setting the shape, size, and synthetic position according to the position of the camera 2 at the time of imaging, the imaging direction, the angle of view, the imaged structural object, and the like and performing rendering, the image 38 by CG can be made to look as if it exists in reality.

It is known that an AR superimposed video is generated by combining a CG with such a captured video as a live image. In the imaging system of the embodiment, a camera operator or a director engaged in video production further performs production work such as imaging and instruction while visually recognizing the AR superimposed video. As a result, imaging can be performed while confirming a fusion state of a real scene and a virtual image, and video production can be performed according to a creation intention.

In particular, in the present embodiment, in an imaging system in which a camera operator or the like can confirm such an AR superimposed video, an imaging range presentation video suitable for a viewer of a monitor video such as a camera operator or a director is displayed.

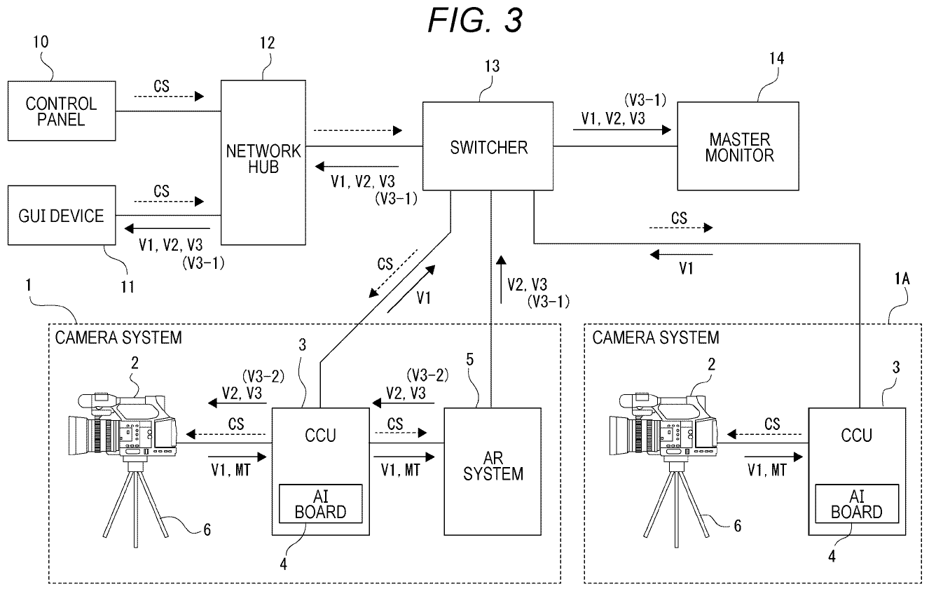

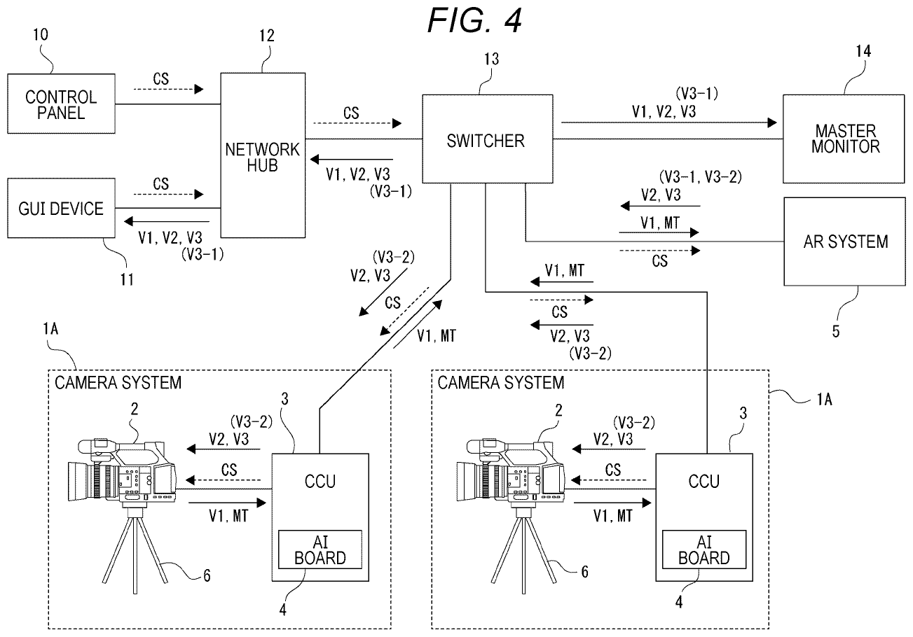

As configuration examples of the imaging system, two examples are illustrated in FIGS. 3 and 4.

In the configuration example of FIG. 3, the camera systems 1 and 1A, the control panel 10, a graphical user interface (GUI) device 11, a network hub 12, a switcher 13, and a master monitor 14 are illustrated.

Broken-line arrows indicate flows of various control signals CS. Furthermore, solid arrows indicate flows of video data of the captured video V1, the AR superimposed video V2, and the bird's-eye view video V3.

The camera system 1 is configured to perform AR cooperation, and the camera system 1A is configured not to perform AR cooperation.

Note that, although FIGS. 3 and 4 illustrate an example of the fixed camera 2F using the tripod 6, the mobile camera 2M may be used as the camera systems 1 and 1A.

The camera system 1 includes a camera 2, a CCU 3, for example, an artificial intelligence (AI) board 4 and an AR system 5 built in the CCU 3.

The video data of the captured video V1 and the metadata MT are transmitted from the camera 2 to the CCU 3. The CCU 3 sends the video data of the captured video V1 to the switcher 13. Furthermore, the CCU 3 transmits the video data of the captured video V1 and the metadata MT to the AR system 5.

The metadata MT includes lens information including a zoom field angle and a focal length at the time of capturing the captured video V1, and sensor information such as an inertial measurement unit (IMU) mounted on the camera 2. Specifically, these are information such as attitude information of 3 degrees of freedom (doF) of the camera 2, acceleration information, a focal length of a lens, an aperture value, a zoom angle of view, and lens distortion. These pieces of metadata MT are output from the camera 2 as, for example, information synchronized with a frame or asynchronous information.

Note that, in the case of FIG. 3, the camera 2 is the fixed camera 2F, and the position information does not change. Therefore, the camera position information may be stored in the CCU 3 or the AR system 5 as a known value. In a case where the mobile camera 2M is used, the position information is also included in the metadata MT sequentially transmitted from the camera 2M.

The AR system 5 is an information processing apparatus including a rendering engine that renders CG. The information processing apparatus as the AR system 5 is an example of the render node 7 illustrated in FIG. 1.

The AR system 5 generates video data of the AR superimposed video V2 obtained by superimposing the image 38 generated by the CG on the video V1 captured by the camera 2. In this case, the AR system 5 generates the video data of the AR superimposed video V2 in which the image 38 is naturally combined with the live-action scene by setting the size and shape of the image 38 with reference to the metadata MT and setting the combination position in the captured video V1.

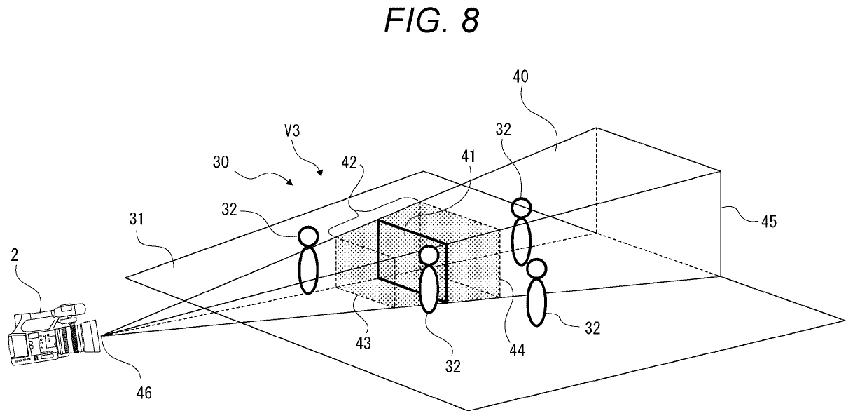

Furthermore, the AR system 5 generates video data of the bird's-eye view video V3 by the CG as described later. For example, it is video data of the bird's-eye view video V3 reproducing the imaging target space 8 by CG. Moreover, the AR system 5 displays a view frustum 40 as illustrated in FIG. 8 to be described later as an imaging range presentation video that visually presents the imaging range of the camera 2 in the bird's-eye view video V3.

For example, the AR system 5 calculates the imaging range in the imaging target space 8 from the metadata MT and the position information of the camera 2. By acquiring position information of the camera 2, an angle of view, and attitude information (corresponding to an imaging direction) of the camera 2 in three axis directions (yaw, pitch, roll) on the tripod 6, an imaging range of the camera 2 can be obtained.

The AR system 5 generates a video as the view frustum 40 according to the calculation of the imaging range of the camera 2. The AR system 5 generates video data of the bird's-eye view video V3 such that the view frustum 40 is presented from the position of the camera 2 in the bird's-eye view video V3 corresponding to the imaging target space 8.

Note that, in the present disclosure, the “bird's-eye view video” is a video from a viewpoint of viewing the imaging target space 8 in a bird's-eye view, but the entire imaging target space 8 is not necessarily displayed in the image. A video including the view frustum 40 of at least some of the cameras 2 and a space around the view frustum is referred to as a bird's-eye view video.

In the embodiment, the bird's-eye view video V3 is generated by the CG as an image expressing the imaging target space 8 such as a stadium, but the bird's-eye view video V3 may be generated by a live-action image. For example, a camera 2 as a viewpoint for a bird's-eye view video may be provided, and a captured video V1 of the camera 2 may be used as a bird's-eye view video V3. The captured video V1 of the camera 2M moved above by the wire 9 may be used as the bird's-eye view video V3. Moreover, the 3D (three dimensions)-CG model of the imaging target space 8 is generated using the captured videos V1 of the plurality of cameras 2, and the viewpoint position with respect to the 3D-CG model is set and rendered, so that the bird's-eye view video V3 with a variable viewpoint position can be generated.

The video data of the AR superimposed video V2 and the bird's-eye view video V3 by the AR system 5 is supplied to the switcher 13.

Furthermore, the video data of the AR superimposed video V2 and the bird's-eye view video V3 by the AR system 5 is supplied to the camera 2 via the CCU 3. As a result, in the camera 2, the camera operator can visually recognize the AR superimposed video V2 and the bird's-eye view video V3 on a display unit such as a viewfinder.

Note that the video data of the AR superimposed video V2 and the bird's-eye view video V3 by the AR system 5 may be supplied to the camera 2 without passing through the CCU 3. Moreover, there is an example in which the CCU 3 is not used in the camera systems 1 and 1A.

The AI board 4 in the CCU 3 performs processing of calculating the drift amount of the camera 2 from the captured video V1 and the metadata MT.

At each time point, the positional displacement of the camera 2 is obtained by integrating the acceleration information from the IMU mounted on the camera 2 twice. By integrating the displacement amounts at each time point from a certain reference origin attitude (attitude position as reference in each of three axes of yaw, pitch, and roll), attitude information corresponding to the positions of three axes of yaw, pitch, and roll at each time point, that is, the imaging direction of the camera 2 can be obtained. However, as the integration is repeated, the deviation (accumulation error) between the actual attitude position and the calculated attitude position increases. The amount of the deviation is referred to as a drift amount.

In order to eliminate such drift, the AI board 4 calculates the amount of drift using the captured video V1 and the metadata MT. Then, the calculated drift amount is sent to the camera 2 side.

The camera 2 receives the drift amount received from the CCU 3 (AI board 4) and corrects the attitude information of the camera 2. Then, the metadata MT including the corrected attitude information is output.

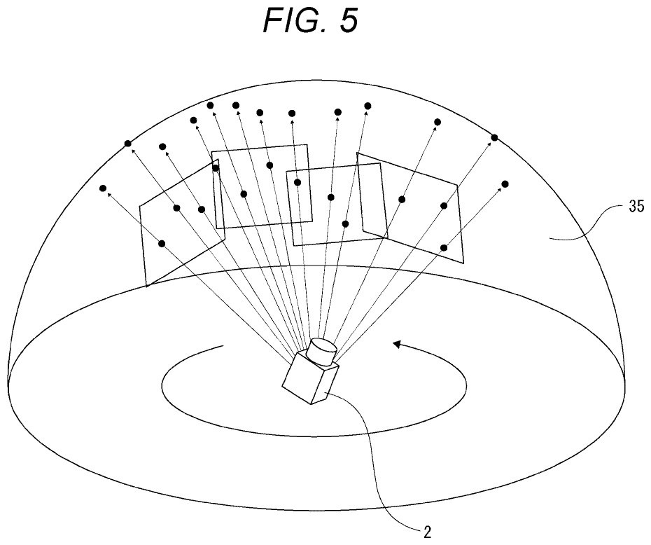

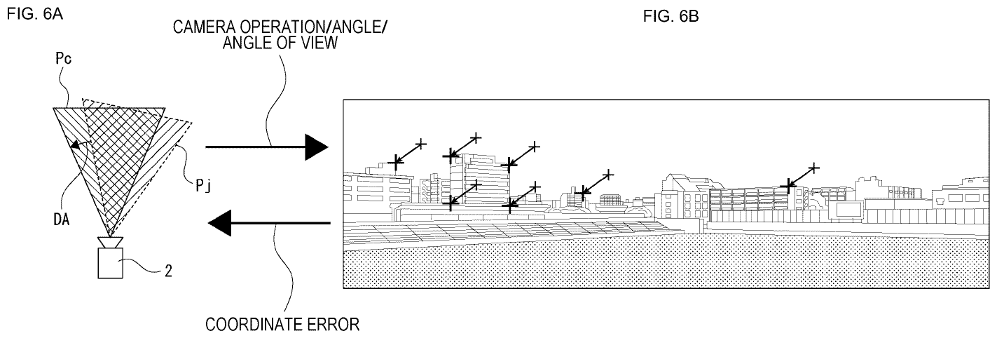

The drift correction described above will be described with reference to FIGS. 5 and 6.

FIG. 5 illustrates an environment map 35. The environment map 35 stores feature points and feature amounts in coordinates of the virtual dome, and is generated for each camera 2.

The camera 2 is rotated by 360 degrees, and an environment map 35 in which feature points and feature amounts are registered in global position coordinates on the celestial sphere is generated. As a result, even if the attitude is lost by the feature point matching, the attitude can be restored.

FIG. 6A schematically illustrates a state in which the drift amount DA occurs between the imaging direction Pc of the correct attitude of the camera 2 and the imaging direction Pj calculated from the IMU data.

From the camera 2 to the AI board 4, information of the operation, angle, and angle of view of the three axes of the camera 2 is sent as a guide for feature point matching. As illustrated in FIG. 6B, the AI board 4 detects the accumulated drift amount DA by feature point matching of video recognition. “+” in the drawing indicates a feature point of a certain feature amount registered in the environment map 35 and a feature point of a corresponding feature amount of the frame of the current captured video V1, and an arrow therebetween is a drift amount vector. The drift amount can be corrected by detecting the coordinate error by the feature point matching and correcting the coordinate error.

The AI board 4 obtains the drift amount by such feature point matching, and the camera 2 transmits the corrected metadata MT on the basis of the drift amount, whereby the accuracy of the attitude information of the camera 2 detected on the basis of the metadata MT in the AR system 5 can be improved.

The camera system 1A in FIG. 3 includes the camera 2 and the CCU 3 and does not include the AR system 5. The video data of the captured video V1 and the metadata MT are transmitted from the camera 2 of the camera system 1A to the CCU 3. The CCU 3 transmits the video data of the captured video V1 to the switcher 13.

The video data of the captured video V1, the AR superimposed video V2, and the bird's-eye view video V3 output from the camera systems 1 and 1A is supplied to the GUI device 11 via the switcher 13 and the network hub 12.

The switcher 13 selects a so-called main line video among the videos V1 captured by the plurality of cameras 2, the AR superimposed video V2, and the bird's-eye view video V3. The main line video is a video output for broadcasting or distribution. The switcher 13 outputs the selected video data to a transmission device, a recording device, or the like (not illustrated) as a main line video for broadcasting or distribution.

Furthermore, the Video Data of the Video Selected As the main line video is transmitted to the master monitor 14 and displayed. As a result, the video production staff can confirm the main line video.

Note that the AR superimposed video V2, the bird's-eye view video V3, and the like may be displayed on the master monitor 14 in addition to the main line video.

The control panel 10 is a device in which a video production staff performs an operation for a switching instruction of the switcher 13, an instruction related to video processing, and other various instructions. The control panel 10 outputs a control signal CS according to an operation of the video production staff. The control signal CS is transmitted to the switcher 13 and the camera systems 1 and 1A via the network hub 12.

The GUI device 11 includes, for example, a PC, a tablet device, or the like, and is a device in which a video production staff, for example, a director, or the like can confirm a video and perform various instruction operations.

The captured video V1, the AR superimposed video V2, and the bird's-eye view video V3 are displayed on the display screen of the GUI device 11. For example, in the GUI device 11, the captured videos V1 of the plurality of cameras 2 are divided into screens and displayed as a list, the AR superimposed video V2 is displayed, and the bird's-eye view video V3 is displayed.

Alternatively, the GUI device 11 may display the video selected by the switcher 13 as the main line video.

An interface for a director or the like to perform various instruction operations is also prepared in the GUI device 11.

The GUI device 11 outputs the control signal CS according to an operation of a director or the like. The control signal CS is transmitted to the switcher 13 and the camera systems 1 and 1A via the network hub 12.

Depending on the GUI device 11, for example, a display mode of the view frustum 40 in the bird's-eye view video V3 or the like can be instructed.

The control signal CS according to the instruction is transmitted to the AR system 5, and the AR system 5 generates video data of the bird's-eye view video V3 including the view frustum 40 in the display mode according to the instruction of the director or the like.

The example of FIG. 3 described above includes the camera systems 1 and 1A. In this case, the camera system 1 includes the camera 2, the CCU 3, and the AR system 5 as one set. In particular, by including the AR system 5, video data of the AR superimposed video V2 and the bird's-eye view video V3 corresponding to the captured video V1 of the camera 2 is generated. Then, the AR superimposed video V2 and the bird's-eye view video V3 are displayed on a display unit such as a viewfinder of the camera 2, displayed on the GUI device 11, or selected as a main line video by the switcher 13.

On the other hand, on the camera system 1A side, the video data of the AR superimposed video V2 and the bird's-eye view video V3 corresponding to the captured video V1 of the camera 2 is not generated.

Therefore, FIG. 3 illustrates a system in which the camera 2 performing the AR cooperation and the camera 2 performing the normal imaging are mixed.

The example of FIG. 4 is a system example in which one AR system 5 corresponds to each camera 2.

In the case of FIG. 4, a plurality of camera systems 1A is provided. The AR system 5 is provided independently of each camera system 1A.

The CCU 3 of each camera system 1A transmits the video data of the captured video V1 and the metadata MT from the camera 2 to the switcher 13. Then, the video data and the metadata MT of the captured video VI are supplied from the switcher 13 to the AR system 5.

As a result, the AR system 5 can acquire the video data and the metadata MT of the captured video V1 of each camera system 1A, and can generate the video data of the AR superimposed video V2 corresponding to the captured video VI of each camera system 1A and the video data of the bird's-eye view video V3 including the view frustum 40 corresponding to each camera system 1A. Alternatively, the AR system 5 can also generate video data of the bird's-eye view video V3 in which the view frustums 40 of the cameras 2 of the plurality of camera systems 1A are collectively displayed.

The video data of the AR superimposed video V2 and the bird's-eye view video V3 generated by the AR system 5 is transmitted to the CCU 3 of the camera system 1A via the switcher 13 and further transmitted to the camera 2. As a result, the camera operator can visually recognize the AR superimposed video V2 and the bird's-eye view video V3 on a display unit such as a viewfinder of the camera 2.

Furthermore, the video data of the AR superimposed video V2 and the bird's-eye view video V3 generated by the AR system 5 is transmitted to the GUI device 11 via the switcher 13 and the network hub 12 and displayed. As a result, the director or the like can visually recognize the AR superimposed video V2 and the bird's-eye view video V3.

In such a configuration of FIG. 4, the AR superimposed video V2 and the bird's-eye view video V3 of each camera 2 can be generated and displayed without providing the AR system 5 in each camera system 1A.

Meanwhile, in FIGS. 3 and 4, the bird's-eye view video V3 is added with “V3-1” and “V3-2”.

The video data of the bird's-eye view video V3-1 is video data of the bird's-eye view video V3 displayed on the GUI device 11 or the master monitor 14 assuming a director or the like as a viewer. Furthermore, the video data of the bird's-eye view video V3-2 is video data of the bird's-eye view video V3 displayed on the viewfinder or the like of the camera 2 on the assumption that the camera operator is a viewer.

The video data of the bird's-eye view videos V3-1 and V3-2 may be video data for displaying videos having the same contents. These are video data for displaying the bird's-eye view video V3 of the imaging target space 8 including at least the view frustum 40. However, in the embodiment, a case where these are video data including different display contents will also be described.

That is, the AR system 5 may generate the video data to be the bird's-eye view video V3 of the same video content regardless of the transmission destination, or may generate, for example, the video data of the first bird's-eye view video V3-1 to be transmitted to the GUI device 11 and the video data of the second bird's-eye view video V3-2 to be transmitted to the camera 2 in parallel.

Moreover, in the case of the system of FIG. 4, it is also assumed that the AR system 5 generates a plurality of second bird's-eye view videos V3-2 in parallel so that the content is different for each camera 2.

### 2. Configuration of Information Processing Apparatus

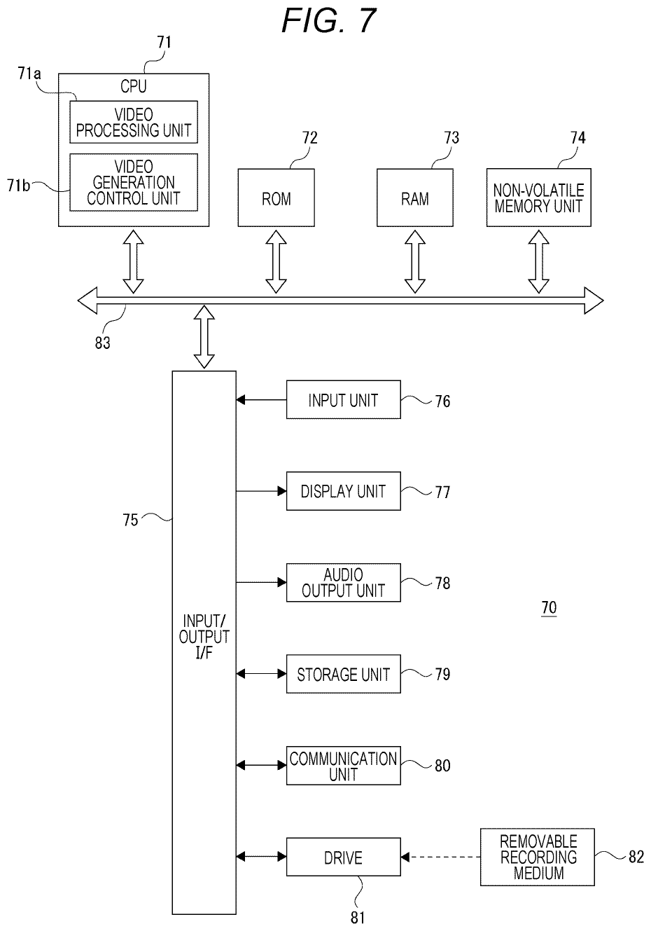

In the above imaging system, a configuration example of the information processing apparatus 70 serving as the AR system 5 will be described with reference to FIG. 7.

The information processing apparatus 70 is an apparatus capable of performing information processing, particularly video processing, such as a computer device. Specifically, a personal computer, a workstation, a portable terminal apparatus such as a smartphone or a tablet, a video editing apparatus, and the like are assumed as the information processing apparatus 70. Furthermore, the information processing apparatus 70 may be a computer apparatus configured as a server apparatus or a calculation apparatus in cloud computing.

A CPU 71 of the information processing apparatus 70 executes various processes in accordance with a program stored in a non-volatile memory unit 74 such as a ROM 72 or, for example, an electrically erasable programmable read-only memory (EEP-ROM), or a program loaded from a storage unit 79 to a RAM 73. The RAM 73 also stores, as appropriate, data and the like necessary for the CPU 71 to perform the various types of processing.

The CPU 71 is configured as a processor that performs various types of processing. The CPU 71 performs overall control processing and various arithmetic processing, and in the case of the present embodiment, has functions as a video processing unit 71a and a video generation control unit 71b in order to execute video processing as the AR system 5 on the basis of a program.

The video processing unit 71a has a processing function of performing various types of video processing. For example, the video processing unit performs any one of or a plurality types of the following processing: 3D model generation processing, rendering, video processing including color and brightness adjustment processing, video editing processing, video analysis and detection processing, and the like.

Furthermore, the video processing unit 71a also performs processing of generating the bird's-eye view video V3 as video data for simultaneously displaying the bird's-eye view video V3 of the imaging target space 8, the view frustum 40 for presenting the capturing range of the camera 2 in the bird's-eye view video V3, and the captured video V1 of the camera 2 in one screen.

The video generation control unit 71b in the CPU 71 variably sets the display position of the captured video VI to be simultaneously displayed in one screen in the bird's-eye view video V3 including the view frustum 40, which is generated by the video processing unit 71a, and performs processing of controlling generation of video data by the video processing unit 71a. The video processing unit 71a generates the bird's-eye view video V3 including the view frustum 40 according to the setting of the video generation control unit 71b.

Furthermore, the video processing unit 71a may perform the processing of generating the first video data for displaying the view frustum 40 of the camera 2 in the imaging target space 8 and the processing of generating the second video data for displaying a video that displays the view frustum 40 in the imaging target space 8 and has a display mode different from that of the video based on the first video data in parallel.

The first video data in this case is, for example, video data of the bird's-eye view video V3-1, and the second video data is, for example, video data of the bird's-eye view video V3-2.

Note that the functions of the video processing unit 71a and the video generation control unit 71b may be realized by a CPU, a graphics processing unit (GPU), a general-purpose computing on graphics processing unit (GPGPU), an artificial intelligence (AI) processor, or the like separate from the CPU 71.

Furthermore, the functions of the video processing unit 71a and the video generation control unit 71b may be implemented by a plurality of processors.

The CPU 71, the ROM 72, the RAM 73, and the non-volatile memory unit 74 are connected to each other via a bus 83. Furthermore, an input/output interface 75 is also connected to the bus 83.

An input unit 76 including an operation element and an operation device is connected to the input/output interface 75. For example, as the input unit 76, various operators and operation devices such as a keyboard, a mouse, a key, a trackball, a dial, a touch panel, a touch pad, and a remote controller are assumed.

A user operation is detected by the input unit 76, and a signal corresponding to an input operation is interpreted by the CPU 71.

A microphone is also assumed as the input unit 76. It is also possible to input voice uttered by the user as operation information.

Furthermore, a display unit 77 including a liquid crystal display (LCD), an organic electro-luminescence (EL) panel, or the like, and an audio output unit 78 including a speaker or the like are integrally or separately connected to the input/output interface 75.

The display unit 77 is a display unit that performs various displays, and includes, for example, a display device provided in a housing of the information processing apparatus 70, a separate display device connected to the information processing apparatus 70, and the like.

The display unit 77 performs display of various images, operation menus, icons, messages, and the like, that is, display as a graphical user interface (GUI), on a display screen on the basis of an instruction from the CPU 71.

In some cases, the storage unit 79 including a hard disk drive (HDD), a solid-state memory, or the like or a communication unit 80 is connected to the input/output interface 75.

The storage unit 79 can store various data and programs. A database can be configured in the storage unit 79.

The communication unit 80 performs communication processing via a transmission path such as the Internet, wired/wireless communication with various devices such as an external database, an editing device, and an information processing apparatus, bus communication, and the like.

For example, assuming the information processing apparatus 70 as the AR system 5, the communication unit 80 communicates with the CCU 3 and the switcher 13.

A drive 81 is also connected to the input/output interface 75, as necessary, and a removable recording medium 82 such as a magnetic disk, an optical disk, a magneto-optical disk, a semiconductor memory, or the like is appropriately mounted.

The drive 81 can read video data, various computer programs, and the like from the removable recording medium 82. The read data is stored in the storage unit 79, and video and audio included in the data are output by the display unit 77 and the audio output unit 78. Furthermore, the computer program and the like read from the removable recording medium 82 are installed in the storage unit 79, as necessary.

In the information processing apparatus 70, for example, software for the processing of the present embodiment can be installed via network communication by the communication unit 80 or the removable recording medium 82. Alternatively, the software may be stored in advance in the ROM 72, the storage unit 79, or the like.

### 3. Display of View Frustum

The display of the view frustum 40 will be described. As described above, the AR system 5 can generate the bird's-eye view video V3, transmit the bird's-eye view video V3 to the viewfinder of the camera 2, the GUI device 11, or the like, and display the bird's-eye view video V3. The AR system 5 generates video data of the bird's-eye view video V3 so as to display the view frustum 40 of the camera 2 in the bird's-eye view video V3.

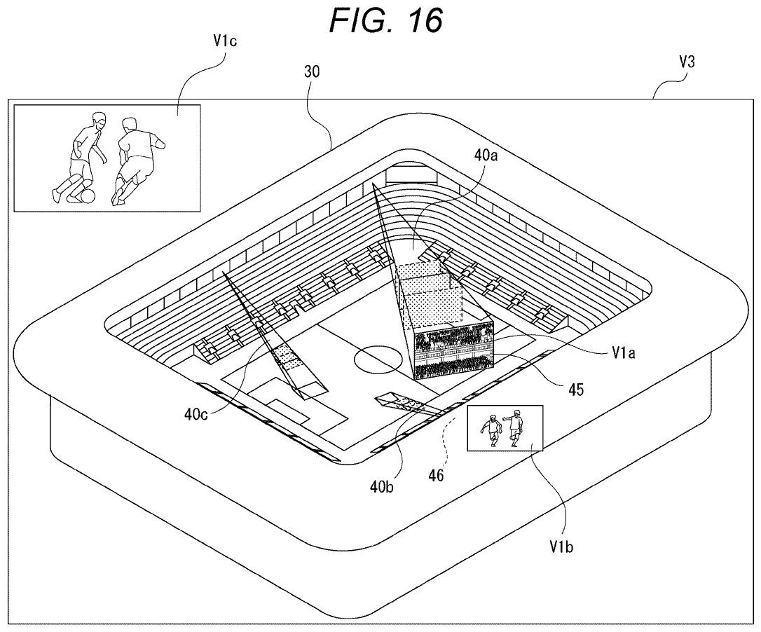

FIG. 8 illustrates an example of the view frustum 40 displayed in the bird's-eye view video V3. FIG. 8 is an example of a video by CG in a state where the imaging target space 8 of FIG. 1 is viewed in a bird's-eye view, but is illustrated in a simplified manner for the sake of description. For example, the bird's-eye view video V3 of the stadium is as illustrated in FIG. 16 to be described later.

The bird's-eye view video V3 of FIG. 8 includes, for example, an image representing a background 31 representing a stadium or the like and a person 32 such as a player. Note that, in FIG. 8, the camera 2 is illustrated, but this is illustrated for illustrative purposes. The bird's-eye view video V3 may or may not include the image of the camera 2 itself.

The view frustum 40 visually presents the imaging range of the camera 2 in the bird's-eye view video V3, and has a quadrangular pyramid shape spreading in the direction of the imaging optical axis with the position of the camera 2 in the bird's-eye view video V3 as the frustum starting point 46. For example, it is a quadrangular pyramid from the frustum starting point 46 to the frustum far end face 45.

The reason for the quadrangular pyramid is that the image sensor of the camera 2 is a quadrangle.

The degree of spread of the quadrangular pyramid changes depending on the angle of view of the camera 2 at that time. Therefore, the range of the quadrangular pyramid indicated by the view frustum 40 is an imaging range by the camera 2.

In practice, for example, it is conceivable that the view frustum 40 is represented by a quadrangular pyramid as a picture colored with a certain translucent color.

In the view frustum 40, a focus plane 41 and a depth of field range 42 at that time are displayed inside the quadrangular pyramid. As the depth of field range 42, for example, a range from a depth near end face 43 to the depth far end face 44 is expressed by a translucent color different from the others.

Furthermore, the focus plane 41 is also expressed by a translucent color different from others.

The focus plane 41 indicates a depth position at which the camera 2 is focused at that time. That is, by displaying the focus plane 41, it is possible to confirm that the subject at the same depth as the focus plane 41 (distance in the depth direction as viewed from the camera 2) is in the in-focus state. Furthermore, the range in the depth direction in which the subject is not blurred can be confirmed by the depth of field range 42.

The depth to be focused and the depth of field vary depending on a focus operation or a diaphragm operation of the camera 2. Therefore, the focus plane 41 and the depth of field range 42 in the view frustum 40 vary each time.

The AR system 5 can set the spread shape of the quadrangular pyramid of the view frustum 40, the display position of the focus plane 41, the display position of the depth of field range 42, and the like by acquiring the metadata MT including information such as the focal length, the diaphragm value, and the angle of view from the camera 2. Moreover, since the attitude information of the camera 2 is included in the metadata MT, the AR system 5 can set the direction of the view frustum 40 from the camera position (frustum starting point 46) in the bird's-eye view video V3.

Then, the AR system 5 displays the view frustum 40 and the video V1 captured by the camera 2 in which the view frustum 40 is shown in the bird's-eye view video V3.

That is, the AR system 5 generates a video of a CG space 30 to be the bird's-eye view video V3, combines the view frustum 40 generated on the basis of the metadata MT supplied from the camera 2 with the video of the CG space 30, and further combines the video V1 captured by the camera 2. The video data of the combined video is output as the bird's-eye view video V3.

An example in which the view frustum 40 and the captured video V1 in the video of the CG space 30 are simultaneously displayed in one screen will be described.

First, an example in which the AR system 5 generates video data of the bird's-eye view video V3 in which the captured video V1 is displayed in the view frustum 40 will be described.

In other words, this is an example of generating the video data in which the captured video V1 is arranged within the range of the view frustum 40. Moreover, it can be said that this is an example of generating video data for displaying the captured video V1 in a state of being arranged within the range of the view frustum 40.

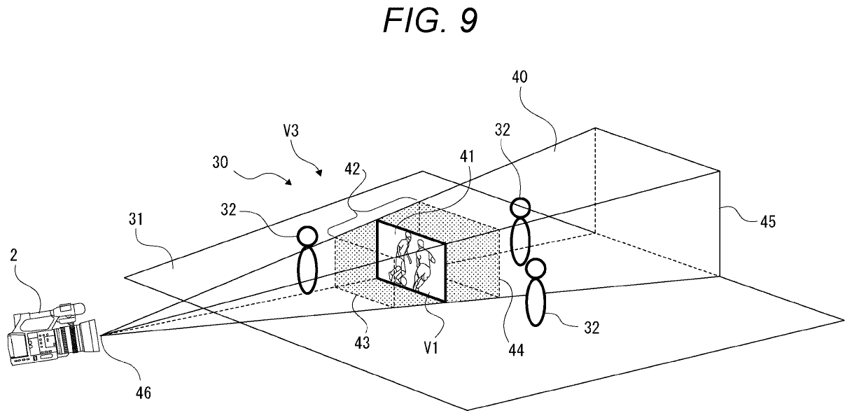

FIG. 9 is an example in which the captured video V1 is displayed on the focus plane 41 in the view frustum 40. This enables visual recognition of an image captured at the focus position. The example of FIG. 9 is also an example of displaying the captured video V1 within the depth of field range 42.

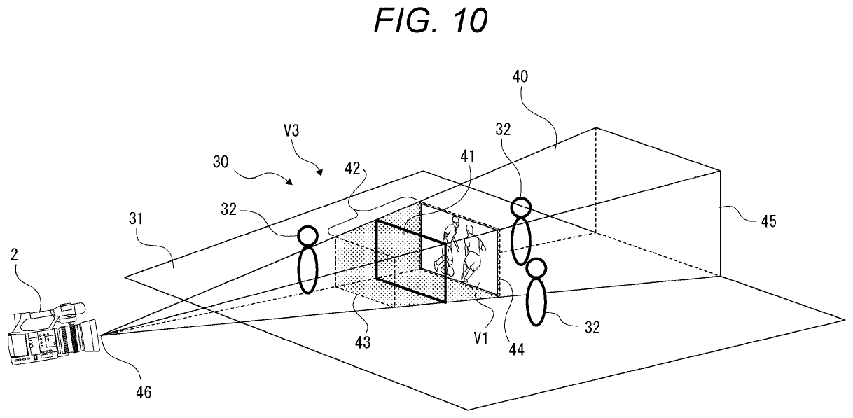

FIG. 10 illustrates an example in which the captured video V1 is displayed on a portion other than the focus plane 41 within the depth of field range 42 in the view frustum 40. In the example of the drawing, the captured video V1 is displayed on the depth far end face 44.

In addition to this, an example of displaying the captured video V1 on the depth near end face 43 and an example of displaying the captured video V1 at a depth position in the middle of the depth of field range 42 are also conceivable.

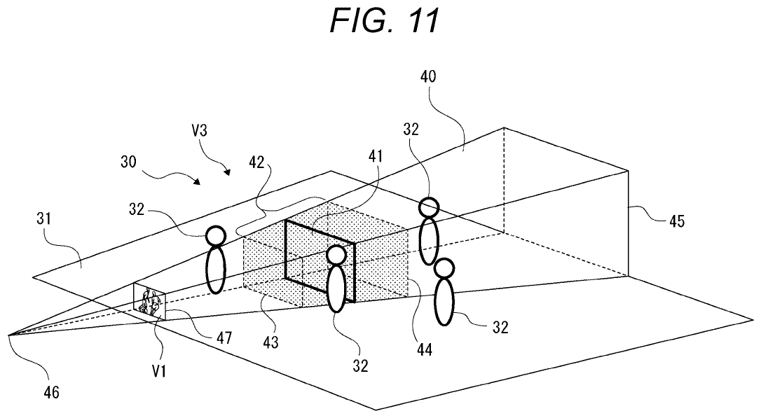

FIG. 11 illustrates an example in which the captured video V1 is displayed at a position closer to the frustum starting point 46 than the depth near end face 43 of the depth of field range 42 (a surface 47 near a frustum starting point) in the view frustum 40. Considering the display in the view frustum 40, the size of the captured video V1 decreases as it is closer to the frustum starting point 46, but by displaying the captured video V1 on the surface 47 near the frustum starting point in this way, the focus plane 41, the depth of field range 42, and the like are easily viewed.

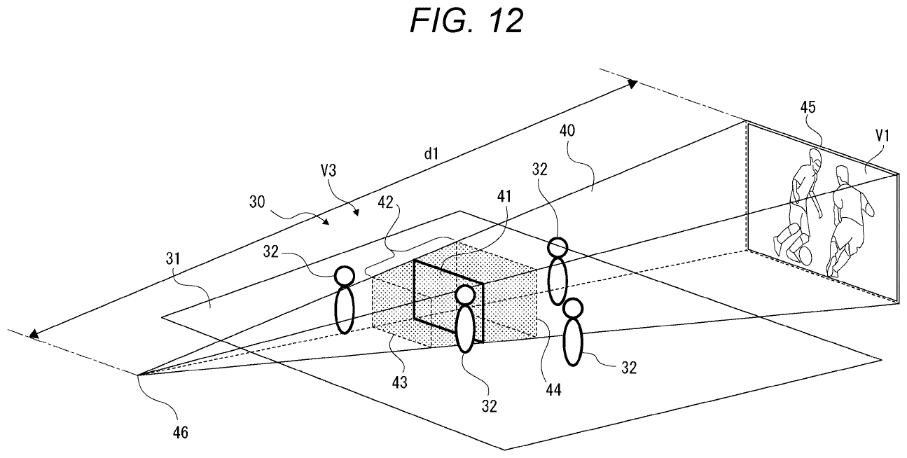

FIG. 12 illustrates an example in which the captured video V1 is displayed on the farther side than the depth far end face 44 of the depth of field range 42 in the view frustum 40. Note that “far” means far from the camera 2 (the frustum starting point 46).

In the example of the drawing, for example, the captured video V1 is displayed on the frustum far end face 45 which is a position on the far side.

As described above, in a case where the captured video V1 is displayed on the farther side than the depth of field range 42 in the view frustum 40, the area of the captured video V1 can be increased. Therefore, it is preferable in a case where it is desired to confirm the positions of the focus plane 41 and the depth of field range 42 while confirming the content of the captured video V1 well.

The distance of the view frustum 40 to be drawn may be finite or infinite. For example, drawing the view frustum 40 at a finite distance, such as the drawing distance dl of FIG. 12, is considered as an example. For example, the drawing distance d1 is twice the distance from the frustum starting point 46 to the focus plane 41.

In this way, since the frustum far end face 45 is determined, the captured video V1 can be displayed in a state of having the largest area in the view frustum 40 as illustrated in FIG. 12.

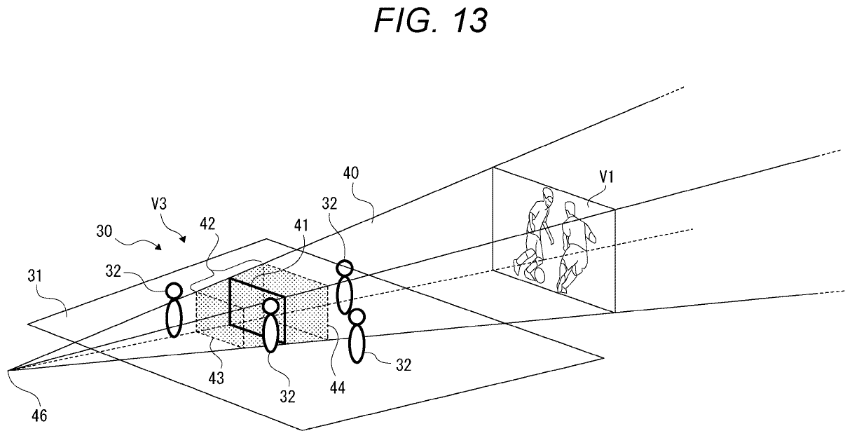

On the other hand, the view frustum 40 may perform drawing at infinity as illustrated in FIG. 13 without particularly determining a drawing distance. That is, it is assumed that the frustum far end face 45 is not constantly specified. In this case, the captured video V1 may be displayed at an indefinite position on the farther side than the depth of field range 42.

Furthermore, even in the case of infinity, it is preferable to draw up to a portion colliding with a wall or the like expressed by the CG for the actual far side of the view frustum 40. Therefore, the far end of the drawing range is only required to be the frustum far end face 45.

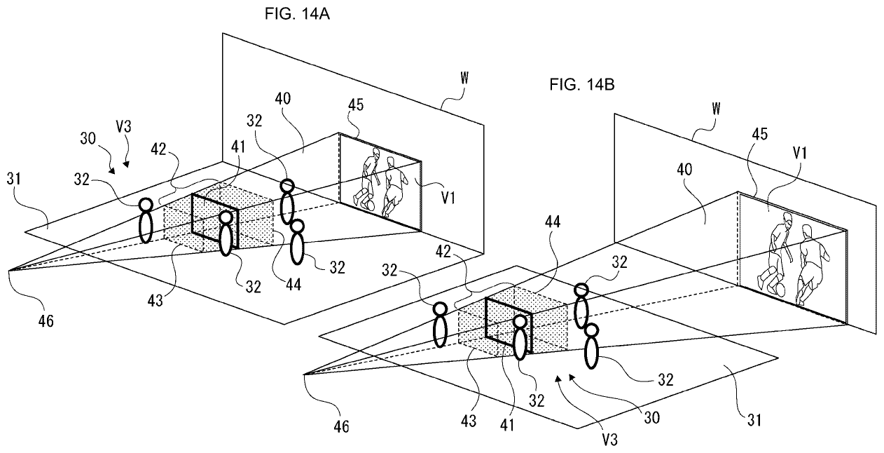

FIGS. 14A and 14B illustrate that in a case where the view frustum 40 is drawn up to the position of the wall W, the position colliding with the wall W is the frustum far end face 45. That is, the frustum far end face 45 changes depending on the positional relationship with the object by CG.

In a case where the view frustum 40 is set to infinity as described above, it is conceivable that a far end within a drawable range in the bird's-eye view video V3 is set as the frustum far end face 45, and the captured video V1 is displayed on the frustum far end face 45.

Note that, even in a case where the view frustum 40 is set to a finite distance as illustrated in FIG. 12, the view frustum may collide with the wall W before the drawing distance dl. In this case, the position where the light beam collides with the wall W may be the frustum far end face 45.

Although the example in which the captured video V1 is displayed in the view frustum 40 has been described above, the captured video V1 may be displayed at a position outside the view frustum 40 in the same screen as the bird's-eye view video V3.

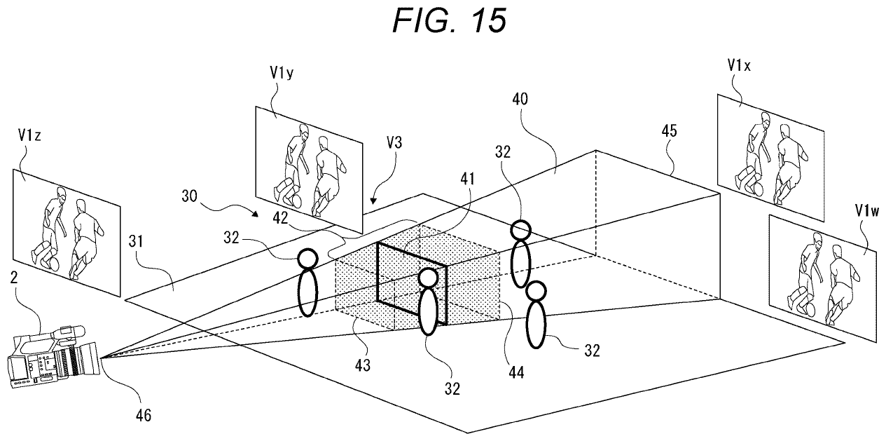

FIG. 15 collectively illustrates four examples (captured videos V1w, V1x, V1y, and V1z) as examples of display positions outside the view frustum 40. In particular, these four examples are examples in which the captured video V1 is displayed in the vicinity of the view frustum 40.

It is conceivable that the captured video V1 is displayed in the vicinity of the frustum far end face 45 like the captured video V1w.

Furthermore, it is conceivable that the captured video V1 is displayed farther than the frustum far end face 45 like the captured video V1x. In a case where the view frustum 40 is a finite distance, it means a position beyond the drawing distance d1 (See FIG. 12.).

Furthermore, it is conceivable that the captured video V1 is displayed in the vicinity of the focus plane 41 (or the depth of field range 42) like the captured video V1y in FIG. 15. In this case, it is easy to collectively view the focus plane 41 or the depth of field range 42, which is a portion that the viewer easily pays attention to in the view frustum 40, and the captured video V1.

Furthermore, it is conceivable that the captured video V1 is displayed in the vicinity of the camera 2 (or the frustum starting point 46) like the captured video Viz. In this case, the relationship between the camera 2 and the video V1 captured by the camera 2 can be easily understood.

It is preferable that the viewer easily understand the correspondence relationship between the view frustum 40 (or the camera 2) of the camera 2 and the captured video V1 of the camera 2. By displaying the captured video V1 in the vicinity of the view frustum 40, it is possible to easily grasp the relationship.

In particular, in the case of sports video production or the like, it is assumed that the view frustums 40 of the plurality of cameras 2 are displayed in the bird's-eye view video V3 as illustrated in FIG. 16. In such a case, if the relationship between the view frustum 40 and the captured video V1 is not clear, the viewer is expected to be confused. Therefore, the captured video V1 of a certain camera 2 may be displayed in the vicinity of the view frustum 40 of the camera 2.

However, there may be a case where the captured video V1 cannot be displayed in the vicinity of the view frustum 40 or a case where the correspondence relationship is not clear due to a direction or an angle of the view frustum 40 or a positional relationship between the view frustums 40 due to a structure or the like in the bird's-eye view video V3.

Therefore, for example, the color of the frame of the captured video V1 and the translucent color of the corresponding view frustum 40, the color of the contour line, or the like may be matched to indicate the correspondence.

In the example of FIG. 16, view frustums 40a, 40b, and 40c corresponding to the three cameras 2 are displayed in the bird's-eye view video V3. Moreover, the captured videos V1a, V1b, and V1c corresponding to the view frustums 40a, 40b, and 40c are also displayed.

The captured video V1a is displayed on the frustum far end face 45 of the view frustum 40a. The captured video V1b is displayed in the vicinity of the frustum starting point 46 of the view frustum 40b (in the vicinity of the camera position).

The captured video V1c is displayed in a screen corner. However, it is displayed in an upper left corner close to the view frustum 40c among four corners of the bird's-eye view video V3.

Note that, for example, in the case of the mobile camera 2M, the view frustum 40 fluctuates more intensely than the view frustum 40 of the camera 2 on the fixed side. Therefore, the captured video V1 of the mobile camera 2 may be fixedly displayed at a screen corner or the like.

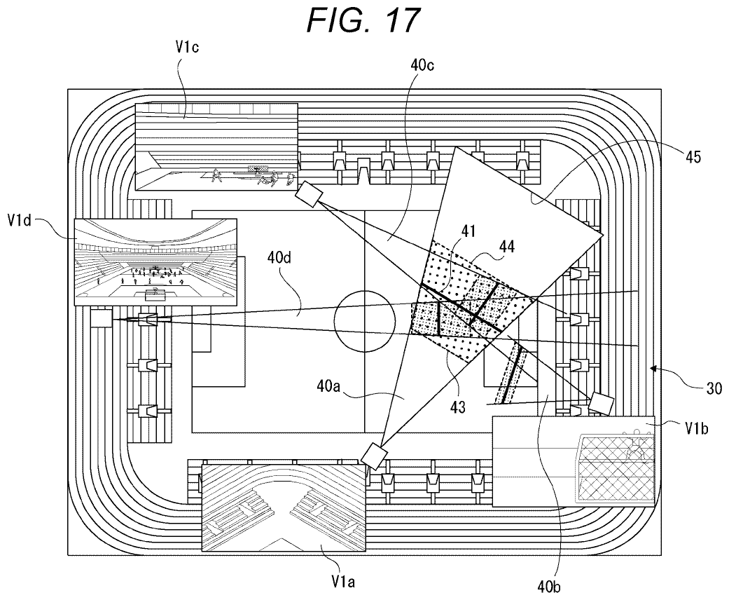

Although FIG. 16 illustrates an example of the bird's-eye view video V3 as if the imaging target space 8 is viewed obliquely from above, the AR system 5 may display a planar bird's-eye view video V3 viewed from directly above as in FIG. 17.

In this example, there are cameras 2a, 2b, 2c, and 2d, their corresponding view frustums 40a, 40b, 40c, and 40d, and further, the captured videos V1a, V1b, V1c, and V1d are displayed as the bird's-eye view video V3.

The captured videos V1a, V1b, V1c, and V1d are displayed in the vicinity of the corresponding cameras 2a, 2b, 2c, and 2d, respectively.

In the AR system 5, a viewpoint direction of the bird's-eye view video V3 illustrated in FIGS. 16 and 17 may be continuously changed by the viewer performing an operation of the GUI device 11 or the like.

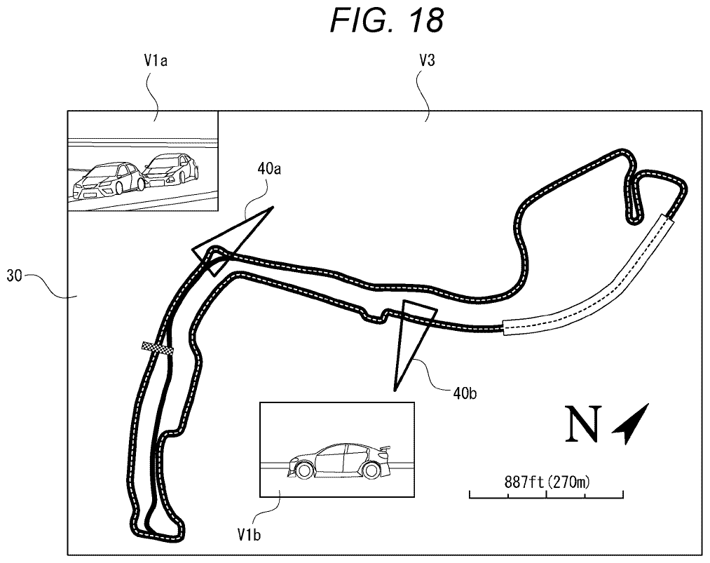

FIG. 18 is another example of the bird's-eye view video V3. In the bird's-eye view video V3 representing the automobile racecourse in CG, the view frustums 40a and 40b are displayed, and the captured videos V1a and V1b of the cameras 2 of the view frustums 40a and 40b are displayed in screen corners, near Camera positions, and the like.

For example, in the case of imaging a race, it is difficult to understand which part of the course is imaged only by the captured video V1, but the relationship can be easily understood by simultaneously displaying the bird's-eye view video V3, the view frustum 40, and the captured video V1.

In particular, in a case where a plurality of cameras 2 is arranged with respect to the course, as in the example of the figure, displaying each view frustum 40 and the captured video V1 makes it easy to understand the imaging situation.

As illustrated in FIGS. 9 to 18, the AR system 5 displays the view frustum 40 of the camera 2 in the CG space 30, and generates the video data of the bird's-eye view video V3 so as to simultaneously display the captured video V1 of the camera 2. Since the bird's-eye view video V3 is displayed on the camera 2 or the GUI device 11, a viewer such as a camera operator or a director can easily grasp an imaging situation.

A specific description will be given.

By displaying the view frustum 40 and the captured video V1 in the CG space 30, the correspondence between the captured video V1 of the camera 2 and the spatial position becomes clear, and the viewer can easily grasp the correspondence between the captured video V1 of the camera 2 and the position in the imaging target space 8.

Furthermore, it is easy for the viewer to grasp what each of the cameras 2 captures, where the camera 2 is focused, or the like.

In particular, if there is little experience in imaging or video production by the camera 2, it is difficult to understand the correspondence between the position of the camera 2 and the captured video V1, and the viewer may go back and forth between the screen of the captured video V1 and the screen of the bird's-eye view video V3. By displaying the captured video V1 in the CG space 30 as one screen, such going back and forth between the screens can be eliminated.

Furthermore, from the position of the camera 2 and the captured video V1, the camera 2 in which the target subject appears next can be predicted.

For example, when a player runs to the right in the video V1a captured by the camera 2a, it can be predicted that the player will appear in the camera 2b next. Such prediction is difficult only with the captured video V1a.

For example, from the viewpoint of a director or the like who uses the GUI device 11, by visually recognizing the view frustums 40 of the plurality of cameras 2 and the bird's-eye view video V3 displaying the captured video V1, it is possible to extremely easily grasp the positional relationship between the cameras, the relationship between the imaging directions, the subject being imaged, and the like. This allows appropriate instructions to be given.

For the director, rough contents of the individual captured videos V1 may be known. Therefore, there is no problem even in a relatively small captured video V1 in the bird's-eye view video V3. Conversely, by displaying the view frustum 40 of each camera 2 in the CG space 30, the director can confirm and simulate the composition, the standing position, and the camera position in comprehensive consideration of the situation of each camera 2.

The camera operator can view the depth of field range 42 of the view frustum 40 and perform a focusing operation when focusing.

Furthermore, by confirming the view frustum 40 of the camera 2 operated by the user, it is possible to easily confirm a portion and a direction of capturing in the bird's-eye view video V3 of the imaging target space 8 expressed by CG.

Furthermore, the user can view the view frustum 40 and the captured video V1 of another camera 2 and reflect the view frustum and the captured video V1 in his/her camera operation.

Since it is possible to grasp the relationship with the content captured by the other camera 2, the subject direction, and the like, it is possible to perform preferable capturing in view of the relationship with the other camera 2. For example, a position and an angle of view captured by another camera 2 are confirmed, and the own camera 2 captures images at different positions and angles of view.

From the viewpoint of an operation staff who remotely performs a remote operation of the camera 2, for example, a focus operation of the mobile camera 2, it is convenient when it is difficult to see the situation of the site due to the remote operation. That is, if the bird's-eye view video V3 is present, the information amount (captured video V1, position, etc.) increases, and it becomes easy to grasp the situation of the site.

In FIGS. 9 to 18, various display positions of the captured video V1 are illustrated as an example of displaying the captured video V1 together with the view frustum 40. However, it is preferable that the display positions are appropriately changed in user's intention or automatic determination.

Hereinafter, a processing example of the AR system 5 including the change of the display setting of the captured video V1 will be described.

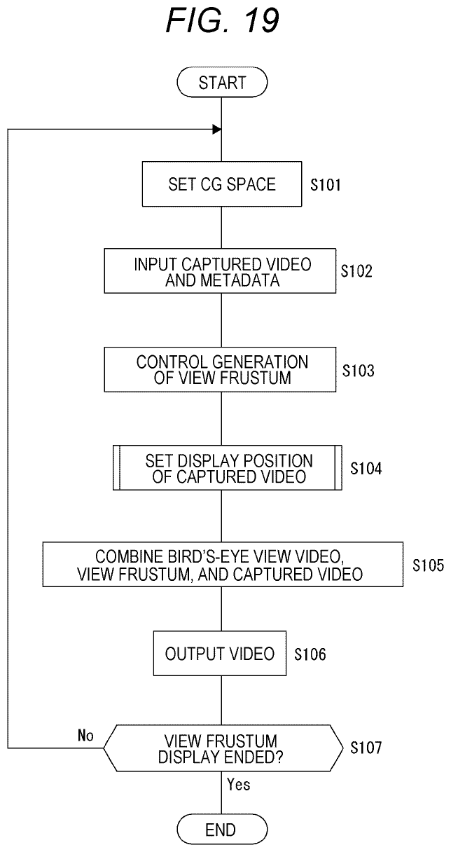

FIG. 19 is a processing example of the AR system 5 that generates the video data of the bird's-eye view video V3. The video data of the bird's-eye view video V3 in this case is video data obtained by combining the view frustum 40 and the captured video V1 with the CG space 30 corresponding to the imaging target space 8. That is, the video data is video data for performing display as illustrated in FIGS. 9 to 18.

The AR system 5 performs the processing of steps S101 to S107 of FIG. 19 for each frame as the video data of the bird's-eye view video V3, for example. These processing can be considered as control processing of the CPU 71 (video processing unit 71a, video generation control unit 71b) in the information processing apparatus 70 in FIG. 7 as the AR system 5.

In step S101, the AR system 5 sets the CG space 30. For example, a viewpoint position of the CG space 30 corresponding to the imaging target space 8 is set, and a video as the CG space 30 from the viewpoint position is rendered. In particular, if there is no change in the viewpoint position and the video content with respect to the previous frame and the CG space 30, the video of the CG space of the previous frame is only required to be used in the current frame.

In step S102, the AR system 5 inputs the captured video V1 and the metadata MT from the camera 2. That is, the captured video V1 of the current frame and the attitude information, the focal length, the angle of view, the diaphragm value, and the like of the camera 2 at the frame timing are acquired.

For example, as illustrated in FIG. 4, in a case where one AR system 5 displays the view frustum 40 and the captured video V1 for the plurality of cameras 2, the AR system 5 inputs the captured video V1 and the metadata MT of each camera 2.

As illustrated in FIG. 3, in a case where there is a plurality of camera systems 1 in which the camera 2 and the AR system 5 correspond to 1:1, and each of the camera systems 1 generates the bird's-eye view video V3 including a plurality of view frustums 40 and the captured video V1, it is preferable that the AR systems 5 cooperate so as to be able to share the metadata MT and the captured video V1 of the corresponding camera 2.

At step S103, the AR system 5 generates a view frustum 40 for the current frame. The AR system 5 sets the direction of the view frustum 40 in the CG space 30 according to the attitude of the camera 2, the quadrangular pyramid shape according to the angle of view, the position of the focus plane 41 or the depth of field range 42 based on the focal length or the diaphragm value, and the like from the metadata MT acquired in step S102, and generates a video image of the view frustum 40 according to the setting.

In a case where the view frustum 40 is displayed for the plurality of cameras 2, the AR system 5 generates the video of the view frustum 40 according to the metadata MT of each camera 2.

In step S104, the AR system 5 sets the display position of the captured video V1 acquired in step S103. Various examples of this processing will be described later.

In step S105, the AR system 5 combines the view frustum 40 corresponding to one or a plurality of cameras 2 and the captured video V1 in the CG space 30 to be the bird's-eye view video V3, and generates video data of one frame of the bird's-eye view video V3.

Then, in step S106, the AR system 5 outputs video data of one frame of the bird's-eye view video V3.

The above processing is repeatedly performed until the display of the view frustum 40 and the captured video V1 ends. As a result, the bird's-eye view video V3 as illustrated in FIGS. 9 to 18 is displayed on the GUI device 11 or the camera 2.

An example of the display position setting of the captured video V1 in step S104 will be described.

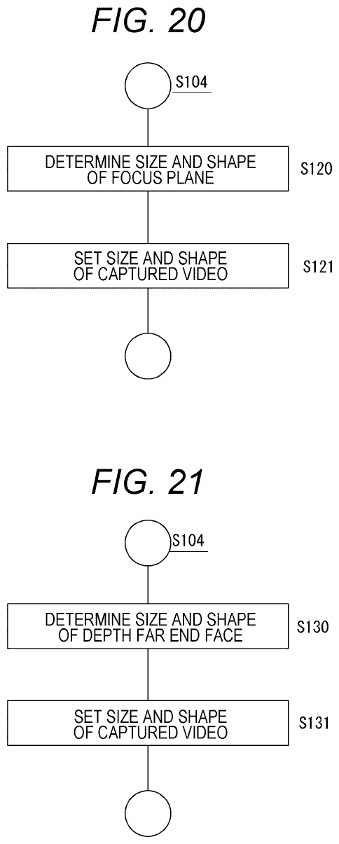

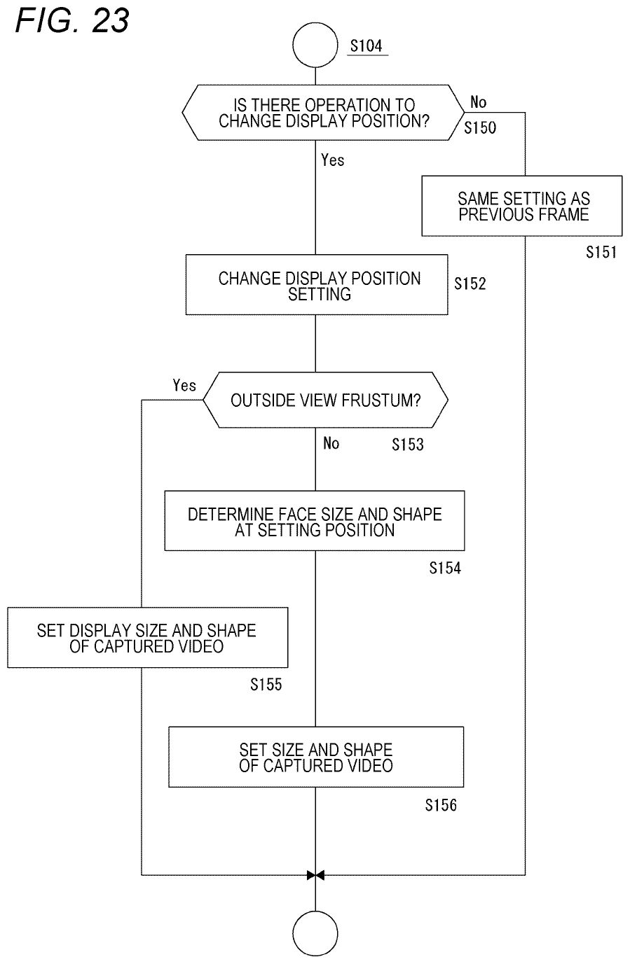

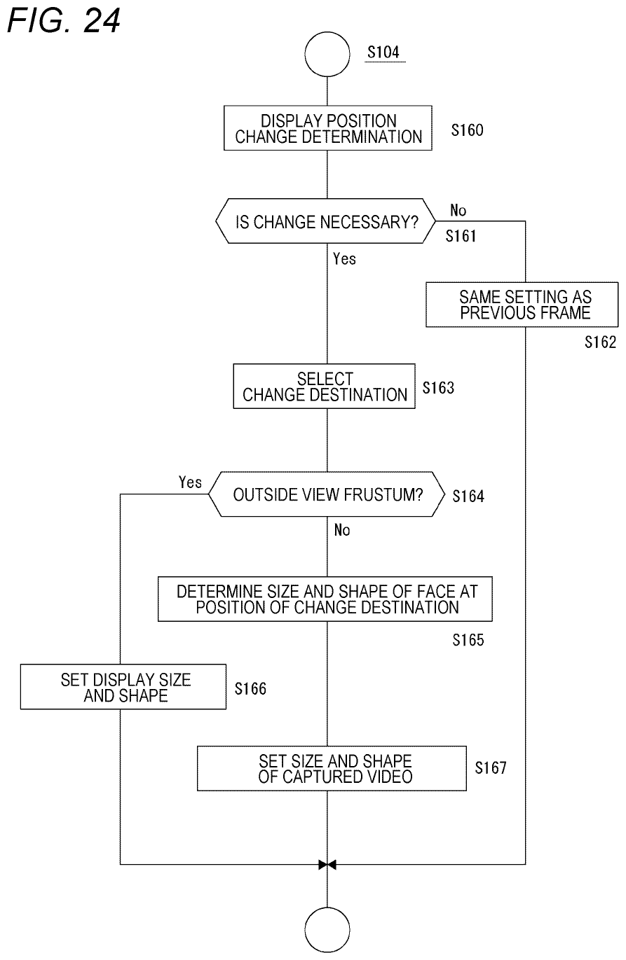

FIGS. 20, 21, and 22 are examples in which the display position of the captured video V1 is fixedly set, and FIGS. 23 and 24 are examples in which the display position of the captured video V1 is variably set.

Note that FIGS. 20, 21, 22, 23, and 24 below are examples of display position setting of the captured video V1 corresponding to one camera 2. In a case where the view frustum 40 and the captured video V1 are displayed for the plurality of cameras 2, processing as illustrated in FIGS. 20 to 24 may be performed for each camera 2. Furthermore, each camera 2 may perform the same display position setting process or may perform different display position setting processes.

First, FIG. 20 illustrates display position setting processing in a case where the captured video V1 is displayed on the focus plane 41 as illustrated in FIG. 9.

In step S120, the AR system 5 determines the size and shape of the focus plane 41 in the view frustum 40 generated in step S103 of FIG. 19 in the current frame. In step S121 of FIG. 20, the AR system 5 sets the size and shape of the captured video V1 so as to match the focus plane 41.

Note that the shape of the captured video V1 to be combined in the view frustum 40 is only required to be the cross-sectional shape of the view frustum 40. For example, the shape of the focus plane 41 varies depending on the viewpoint of the bird's-eye view video V3, the position and direction of the view frustum 40 to be displayed, and the like, but is only required to be a cross-sectional shape cut perpendicular to the optical axis of the camera 2 by the focus plane 41 of the view frustum 40 in the frame.

Therefore, in a case where the captured video V1 is displayed in the view frustum 40, the captured video V1 is deformed into a cross-sectional shape perpendicular to the optical axis and combined.

However, the optical axis is not necessarily displayed in a cross-sectional shape perpendicular to the optical axis. A cross-sectional shape non-perpendicular to the optical axis of the camera 2 may be provided and displayed within the view frustum 40.

After the above processing, when the processing proceeds to step S105 in FIG. 19, the size and shape of the captured video V1 are adjusted, and the bird's-eye view video V3 in which the captured video V1 is combined with the focus plane 41 of the view frustum 40 is generated.

FIG. 21 illustrates display position setting processing in a case where the captured video V1 is displayed on the depth far end face 44 as illustrated in FIG. 10.

In step S130, the AR system 5 determines the size and shape of the depth far end face 44 in the view frustum 40 generated in step S103 in the current frame.

In step S131, the AR system 5 sets the size and shape of the captured video V1 so as to match the size of the depth far end face 44.

As a result, when the process proceeds to step S105 in FIG. 19, the size and shape of the captured video V1 are adjusted, and the bird's-eye view video V3 in which the captured video V1 is combined with the depth far end face 44 of the view frustum 40 is generated.

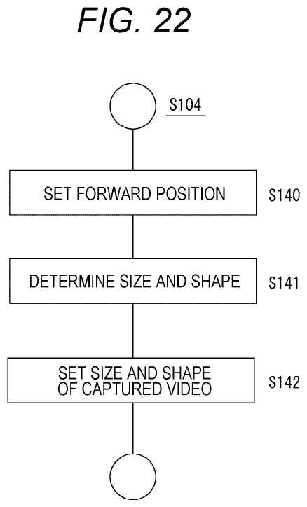

FIG. 22 illustrates the display position setting processing in a case where the captured video V1 is displayed near the frustum starting point 46 as illustrated in FIG. 11.

In step S140, the AR system 5 sets the display position of the captured video V1 in the view frustum 40 generated in step S103 in the current frame. That is, a certain position is set on the frustum starting point 46 side with respect to the depth of field range 42. The position in this case may be fixedly set as a distance from the frustum starting point 46, or may be set as a position where a minimum area can be obtained as a cross section of a quadrangular pyramid shape according to the angle of view.

In step S141, the AR system 5 determines the cross section at the set display position, that is, the size and shape of the display area.

In step S142, the AR system 5 sets the size and shape of the captured video V1 so as to match the cross section of the determined display position.

As a result, when the process proceeds to step S105, the size and shape of the captured video V1 are adjusted, and the bird's-eye view video V3 in which the captured video V1 is combined at the position in the vicinity of the frustum starting point 46 of the view frustum 40 is generated.

Subsequently, FIG. 23 illustrates display position setting processing in which the display position of the captured video V1 is changed according to the operation of the camera operator, the director, or the like who is the user.

In step S150, the AR system 5 confirms the presence or absence of the display position change operation for the captured video V1. For example, the GUI device 11 and the camera 2 are configured such that a director, a camera operator, or the like can perform a display position change operation by a predetermined operation. The AR system 5 confirms the operation information of the display position change operation among the received control signals CS.

For example, the display position setting can be changed in the view frustum 40 such as “focus plane 41”, “depth far end face 44”, “surface 47 near the frustum starting point”, and “frustum far end face 45”. An operation interface capable of switching each surface by a toggle operation may be provided, or an operation interface capable of directly designating each surface may be prepared.

Furthermore, the switching of the display position setting may include not only a position inside the view frustum 40 but also a position outside the view frustum 40.

For example, an operation that can be changed in “focus plane 41”, “frustum far end face 45”, “screen corner”, and “near camera”is enabled.

Moreover, the display position setting may be switched outside the view frustum 40. For example, it is possible to perform an operation that can be changed “near the focus plane 41”, “near the frustum far end face 45”, “screen corner”, and “near the camera 2”.

Note that, in FIGS. 9 to 18 described above, various examples have been described as the display position of the captured video V1. The “focus plane 41”, the “depth near end face 43”, the “depth far end face 44”, the “surface 47 near the frustum starting point”, and the “frustum far end face 45” are illustrated in the view frustum 40. Furthermore, “a screen corner”, “near the camera”, “near the focus plane 41”, “farther than the frustum far end face 45”, and the like outside the view frustum 40 are exemplified.

Among these, a position that the user can select by the switching operation may be set.

Furthermore, for example, the user may be allowed to adjust the position of a display position within the depth of field range 42, a display position near the focus plane 41, and the like.

If the display position change operation is not particularly confirmed at the time of processing of the current frame, the AR system 5 proceeds to step S151, maintains the same display position setting as that of the previous frame, and terminates the processing of FIG. 23.

As a result, when the process proceeds to step S105 in FIG. 19, a frame of the current bird's-eye view video V3 in which the captured video V1 is displayed at the same position as the previous frame is generated.

In a case where the display position change operation is particularly confirmed at the time of processing of the current frame, the AR system 5 proceeds from step S150 to step S152 in FIG. 23, and changes the display position setting according to the operation. For example, the setting that has been the focus plane 41 is switched to the frustum far end face 45.

In step S153, the AR system 5 branches the process depending on whether the changed position setting is outside the view frustum 40.

If the changed position setting is the position in the view frustum 40, the AR system 5 proceeds to step S154 and determines the size and shape of the display area as the cross-section of the view frustum 40 at the setting position.

Then, in step S156, the AR system 5 sets the size and shape of the captured video V1 so as to match the cross section of the determined display position.

As a result, when the process proceeds to step S105 in FIG. 19, the size of the captured video V1 is adjusted, and the bird's-eye view video V3 in which the captured video V1 is combined at a position in the view frustum 40 different from that of the previous frame is generated.

In a case where the position setting changed according to the operation is outside the view frustum 40 this time, the AR system 5 proceeds from step S153 to step S155 in FIG. 23, and sets the display size and shape of the captured video V1 at the new setting position. In the case of the outside of the view frustum 40, the shape of the captured video V1 to be combined is not limited to the cross-sectional shape of the view frustum 40, and may be, for example, a rectangle, or may be a parallelogram according to the angle of the view frustum 40 as long as the parallelogram is in the vicinity of the view frustum 40. The size of the captured video V1 can also be set relatively freely, but is desirably set appropriately according to other display in the screen.

As a result, when the process proceeds to step S105 in FIG. 19, the size and shape of the captured video VI are adjusted, and the bird's-eye view video V3 in which the captured video V1 is combined at a position outside the view frustum 40 different from that of the previous frame is generated.

Note that, in the processing example of FIG. 23, the display position can be changed to the outside of the view frustum 40, but the display position can be changed only in the view frustum 40. In this case, steps S153 and S155 are unnecessary.

The display position may be changed only outside the view frustum 40. In that case, steps S153 and S154 are unnecessary, and the process is only required to proceed from step S152 to step S155.

Next, FIG. 24 illustrates a processing example in which the AR system 5 automatically changes the display position of the captured video V1.

In step S160, the AR system 5 performs display position change determination.

The display position change determination is processing of determining whether or not to change the setting of the display position of the previous frame and the captured video V1 in the current frame.

Examples of the determination processing include the following processing (P1), (P2), and (P3).
(P1) Determination based on positional relationship between the view frustum 40 and the object in the bird's-eye view video V3
(P2) Determination based on the angle of the view frustum 40 in the bird's-eye view video V3
(P3) Determination based on viewpoint position of bird's-eye view video V3

First, an example of (Pl) will be described.

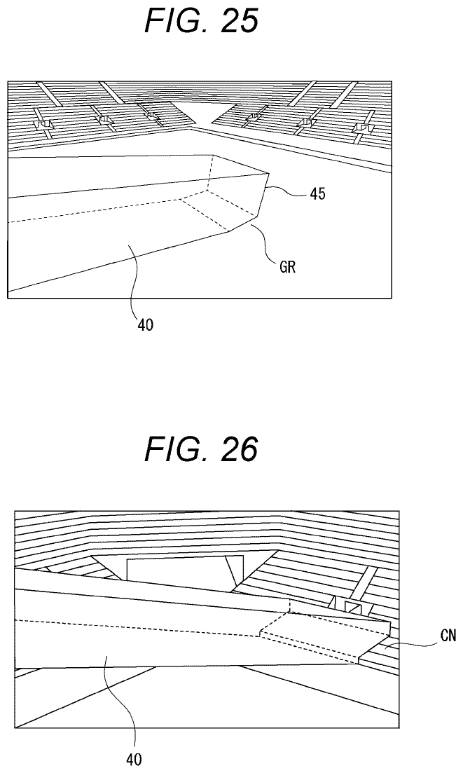

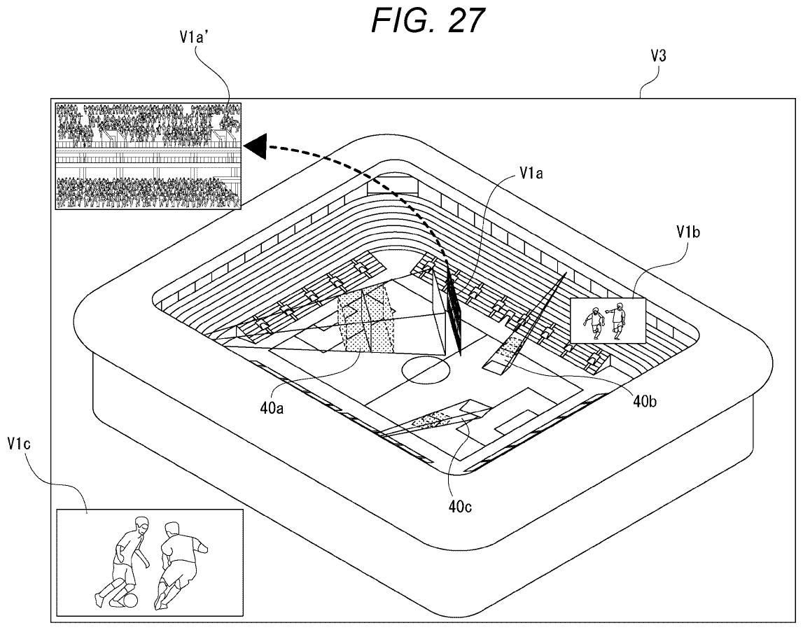

For example, a collision between the view frustum 40 and the ground, a wall, or the like in the bird's-eye view video V3 is determined. For example, FIG. 25 illustrates a state in which the frustum far end face 45 of the view frustum 40 at a finite distance has partially sunk in collision with the ground GR. FIG. 26 illustrates a state in which the far end side of the view frustum 40 at finite or infinity collides with the structure CN and the beyond cannot be displayed.

For example, it is assumed that the captured video V1 is displayed on or near the frustum far end face 45 in the view frustum 40 until the previous frame, and the far end side of the view frustum 40 collides with an object and gets stuck in the current frame as illustrated in FIGS. 25 and 26. In such a case, the display of the captured video V1 with the same setting as the previous setting is not appropriate. It is assumed that a part of the captured video V1 is missing or the entire captured video V1 is not visible. Therefore, it is determined that the display position needs to be changed.

Furthermore, in a case where the shape of the quadrangular pyramid of the view frustum 40 is widened or the direction is changed due to the change in the angle of view or the imaging direction of the camera 2, when it is determined that the display position of the captured video V1 so far is not appropriate from the positional relationship between the specific position (the frustum far end face 45, the focus plane 41, or the like) of the view frustum 40 and another object to be displayed, it may be determined that the display position needs to be changed.

Furthermore, considering other view frustums 40 as the object in the bird's-eye view video V3, in a case where it is determined that the display position of the captured video V1 is not appropriate based on the positional relationship with the other view frustums 40, it may be determined that the display position needs to be changed.

Furthermore, in a case where the relationship between the 40 view frustum 40 and the captured video V1 is unclear due to overlapping of the plurality of view frustums 40 as illustrated in FIG. 17, or the like, it may be determined that the display position needs to be changed.

Next, the example of (P2) considers the viewability of the captured video V1 according to the cross-sectional shape of the view frustum 40.

Depending on the direction of the view frustum 40 in the bird's-eye view video V3, the cross-sectional shape may not be appropriate as the display surface. The shape and direction of the view frustum 40 change according to the angle of view and the imaging direction of the camera 2. Then, the angle of the view frustum 40 displayed in the bird's-eye view video V3 also changes. That is, the angle between the direction from the viewpoint of the entire bird's-eye view video V3 and the axial direction of the view frustum 40 changes. This angle is the normal direction on the display screen and the angle between the displayed view frustum 40 and the axial direction in the case of being viewed in the line-of-sight direction from the viewpoint set for the bird's-eye view video V3 at a certain time point. Note that the axial direction of the view frustum 40 is a direction of a vertical line in a case where the vertical line perpendicular to the frustum far end face 45 is drawn from the frustum starting point 46.

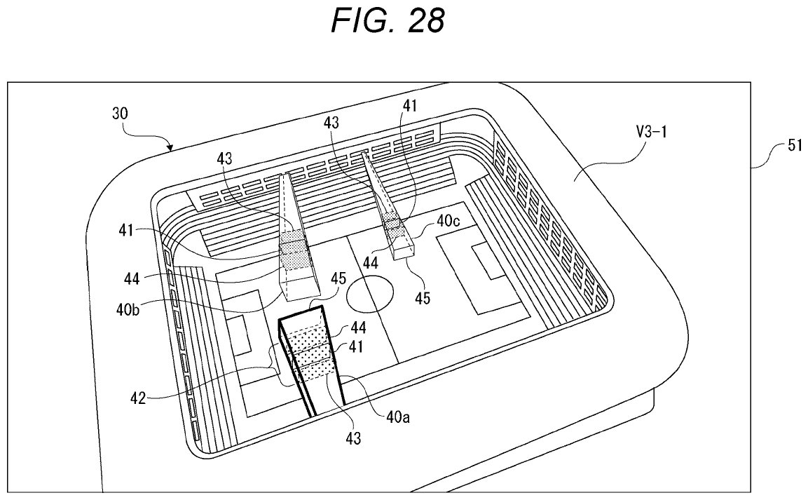

For example, FIG. 27 illustrates captured videos V1a, V1b, and V1c corresponding to the view frustums 40a, 40b, and 40c. In this case, depending on the angle of the view frustum 40a in the bird's-eye view video V3, the captured video V1a to be displayed in accordance with the cross-sectional shape becomes a parallelogram having a large difference between an acute angle and an obtuse angle. In this state, the visibility of the captured video V1a is not good. In such a case, the display position may be changed as indicated by a broken line arrow and displayed at the position as the captured video V1a′.

In this way, it is conceivable to determine that the display position needs to be changed in a case where the angle between the acute angle and the obtuse angle of the captured video V1 is equal to or larger than a predetermined value.
(P3) An example of (P2) is a similar concept.

The viewpoint position of the bird's-eye view video V3 can be changed in accordance with an operation performed by a director or the like. For example, the viewpoint position of the bird's-eye view video V3 may be changed from the state illustrated in FIG. 16 by the operation as illustrated in FIG. 27.

In the case of FIG. 27, similarly to the above mentioned, the visibility of the captured video V1a is not good. That is, even if there is no change in the angle of view or the imaging direction of the camera 2, the shapes of the view frustum 40 and the captured video V1 to be drawn change due to the viewpoint change of the bird's-eye view video V3, and thus, visibility may be deteriorated. Also in such a case, for example, in a case where the angle between the acute angle and the obtuse angle of the captured video V1 becomes equal to or larger than a predetermined value as a result, it is determined that the display position needs to be changed.

Furthermore, depending on the viewpoint change of the bird's-eye view video V3, the size of the captured video V1 may be reduced. It may be determined that the display position needs to be changed when the size in a case where the captured video V1 becomes smaller than or equal to a predetermined size by changing the viewpoint position in the case of drawing the bird's-eye view video V3 to a distant position.

In step S160 of FIG. 24, the AR system 5 performs the display position change determination as described above, for example, and in step S161, the process branches depending on whether or not the change is necessary.

In a case where it is determined that the change is unnecessary, the AR system 5 proceeds to step S162, maintains the same display position setting as the previous frame, and terminates the processing of FIG. 24.

As a result, when the process proceeds to step S105 in FIG. 19, a frame of the current bird's-eye view video V3 in which the captured video V1 is displayed at the same position as the previous frame is generated.

In a case where it is determined that the change is necessary in the display position change determination, the AR system 5 proceeds from step S161 to step S163 in FIG. 24 and selects a change destination of the display position setting.

The change destination is only required to be determined according to the cause that the change is required in the display position change determination.

For example, in the above (P1), in the case of collision with an object in the bird's-eye view video V3, it is conceivable to change the position to a position not affected by the collision point, such as the surface 47 near the frustum starting point or a screen corner.

In the above (P2) and (P3), in a case where the visibility of the captured video V1 decreases, it is conceivable to select the outside of the view frustum 40 capable of performing display with good visibility in terms of shape, such as a screen corner and the vicinity of the focus plane 41.

Furthermore, the type information of the camera 2 can also be used to set a change destination of the captured video V1.

For example, in a case where the object to be changed is the mobile camera 2M, the change destination is a screen corner or the like. For example, it is conceivable that the captured video V1 of the mobile camera 2M is displayed in the view frustum 40 during a period in which the mobile camera 2M is not moving, and is changed to a screen corner during movement. This is because the movement of the view frustum 40 in the bird's-eye view video V3 increases during the movement, and the visibility of the captured video V1 in the view frustum 40 decreases.

In step S164, the AR system 5 branches the process depending on whether the selected change destination is outside the view frustum 40.

If the change destination is the position in the view frustum 40, the AR system 5 proceeds to step S165 and determines the size and shape of the display area as the cross-section of the view frustum 40 at the setting position. Then, in step S167, the AR system 5 sets the size and shape of the captured video V1 so as to match the cross section of the determined display position.

As a result, when the process proceeds to step S105 in FIG. 19, the size of the captured video V1 is adjusted, and the bird's-eye view video V3 in which the captured video V1 is combined at a position in the view frustum 40 different from that of the previous frame is generated.

In a case where the position selected as the change destination is outside the view frustum 40 this time, the AR system 5 proceeds to step S166 in FIG. 24 and sets the display size and shape of the captured video V1 at the new setting position (similar to step S155 in FIG. 23).

As a result, when the process proceeds to step S105 in FIG. 19, the size and shape of the captured video VI are adjusted, and the bird's-eye view video V3 in which the captured video V1 is combined at a position outside the view frustum 40 different from that of the previous frame is generated.

Note that, in the processing example of FIG. 24 described above, an example in which the display position is changed only in the view frustum 40 is considered. In this case, steps S164 and S166 are unnecessary.

Furthermore, the display position may be changed only outside the view frustum 40. In that case, steps S164 and S165 are unnecessary, and the process is only required to proceed from step S163 to step S166.

Although the example in which the captured video V1 is displayed together with the view frustum 40 has been described with reference to FIGS. 8 to 24, for example, the view frustum 40 and the captured video V1 may be displayed together at all times or temporarily.

For example, it is conceivable that the view frustum 40 is normally displayed but the captured video V1 is not displayed. In this case, the captured video V1 corresponding to the selected view frustum 40 may be displayed by the camera operator or the director performing an operation of selecting the view frustum 40.

Alternatively, the mode of only the view frustum 40 and the mode of simultaneously displaying the view frustum 40 and the captured video V1 may be switchable by the camera operator or the director.

### 4. Screen Examples of Camera Operator and Director

In the system of the present embodiment, the bird's-eye view video V3-1 is displayed for the director on the GUI device 11, and the bird's-eye view video V3-2 is displayed for the camera operator on a display unit such as a viewfinder of the camera 2.

In this case, both the bird's-eye view videos V3-1 and V3-2 are images showing the view frustum 40 in the CG space 30 imitating the imaging target space 8, but are images in different display modes. As a result, information suitable for roles such as a director and a camera operator can be provided.

### 4-1: Highlighting

Various examples are assumed in which the bird's-eye view videos V3-1 and V3-2 are images of different modes.

First, in FIGS. 28 to 32, an example in which the AR system 5 sets the bird's-eye view video V3-1 on the director side and the view frustum 40 of the specific camera including a subject of interest in the captured video V1 to a display mode different from the other view frustums 40 will be described. In particular, an example in which a certain view frustum 40 is highlighted will be described. On the other hand, such highlighting is not performed in the bird's-eye view video V3-2 for the camera operator.

FIG. 28 illustrates an example in which a bird's-eye view video V3-1 is displayed as the device display image 51 in the GUI device 11.

The bird's-eye view video V3-1 is an image that includes, for example, the CG space 30 overlooking the stadium, which is the imaging target space 8, and displays the view frustums 40 of the plurality of cameras 2 capturing an image in the stadium. Then, view frustums 40a, 40b, and 40c for the three cameras 2 are displayed.

In this example, the display mode of the view frustum 40a is different from the display modes of the other view frustums 40b and 40c. In particular in this case, the view frustum 40a is highlighted and made more conspicuous than the other view frustums 40b and 40c.

Note that, as described above, the shape and direction of the view frustum 40, the display positions of the focus plane 41 and the depth of field range 42, and the like are determined by the angle of view, the imaging direction, the focal length, the depth of field, and the like of the camera 2 at that time, and thus, these differences are not included in the difference in the display mode described herein. The difference in the display mode of the view frustum 40 does not refer to a difference determined by a state such as an angle of view or an imaging direction of the camera 2, but refers to a difference in the display itself of the view frustum 40. For example, a difference in color, a difference in luminance, a difference in density, a difference in type or thickness of a contour line, a difference in display of a quadrangular pyramid surface, a difference between normal display and blinking display, a difference in blinking cycle, and the like.

In the example of FIG. 28, for example, in a case where the view frustum 40 is normally displayed as translucent white, the view frustum 40a is highlighted to be, for example, translucent red. As a result, the view frustum 40a is highlighted and shown to the director or the like.

As one of the conditions for the highlight display, there is a condition that the subject of interest is being imaged.

Various settings can be made for the subject of interest, but in the case of sports relay, “a specific player”, “a player involved in competition equipment such as a ball”, “competition equipment such as a ball”, and the like are assumed.

Then, for example, the AR system 5 having the configuration of FIG. 4 determines whether or not a subject of interest such as a specific player is captured by image recognition processing of the captured video V1 of each camera 2.

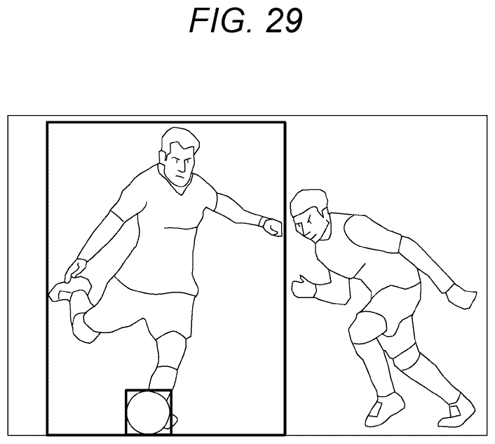

For example, it is determined whether or not the image of the captured video V1 of the camera 2 shows the subject of interest as illustrated in FIG. 29. Then, the AR system 5 generates the bird's-eye view video V3-1 so as to display the view frustum 40 of the camera 2 capturing the subject of interest in a highlighted display mode.

However, when highlighting is performed simply on the condition that the subject of interest is captured, a large number of view frustums 40 may be highlighted, and the meaning of highlighting is reduced. Therefore, a processing example of selecting the camera 2 of the captured video V1 most appropriate as the video of the subject of interest will be described below.

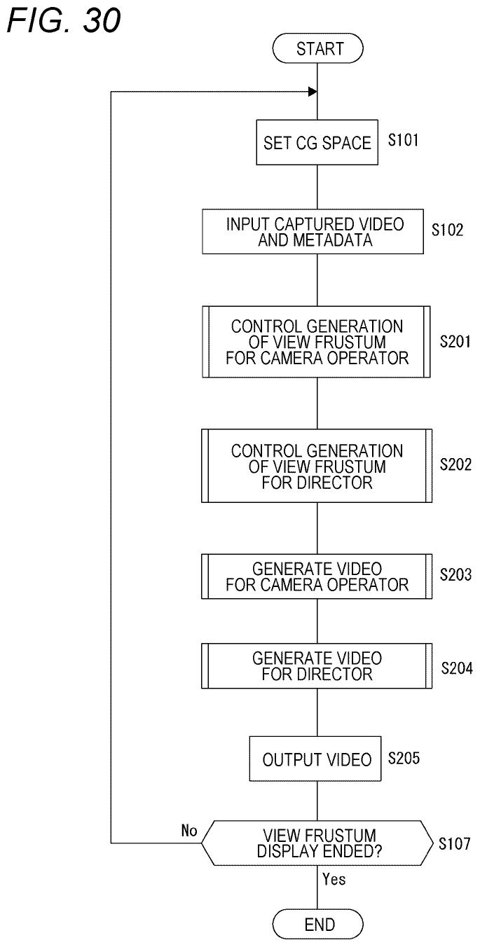

Note that the following processing examples of FIGS. 30, 31, 32, 34, 36, 38, 41, 43, 45, 48, and 52 are easy to understand in the case of a system in which the AR system 5 integrally supports each camera 2 as illustrated in FIG. 4. However, even in the case of the configuration of FIG. 3, it is possible to implement the configuration by providing a plurality of camera systems 1 and cooperating with the AR system 5 of each camera system 1.

FIG. 30 is a processing example of the AR system 5 that generates each video data of the bird's-eye view videos V3-1 and V3-2. The video data of the bird's-eye view videos V3-1 and V3-2 in this case is video data obtained by combining the view frustum 40 with the CG space 30 corresponding to the imaging target space 8.

Note that the bird's-eye view videos V3-1 and V3-2 may be obtained by further combining the captured videos V1 as described above.

The AR system 5 performs the processing of steps S101 to S107 of FIG. 30 for each frame as the video data of the bird's-eye view videos V3-1 and V3-1, for example. These processes can be considered as control processes of the CPU 71 (the video processing unit 71a) in the information processing apparatus 70 in FIG. 7 as the AR system 5.

In step S101, the AR system 5 sets the CG space 30. For example, a viewpoint position of the CG space 30 corresponding to the imaging target space 8 is set, and a video as the CG space 30 from the viewpoint position is rendered. In particular, if there is no change in the viewpoint position and the video content with respect to the previous frame and the CG space 30, the video of the CG space of the previous frame is only required to be used in the current frame.

In step S102, the AR system 5 inputs the captured video V1 and the metadata MT from the camera 2. That is, the captured video V1 of the current frame and the attitude information, the focal length, the angle of view, the diaphragm value, and the like of the camera 2 at the frame timing are acquired.

In a case where the view frustum 40 and the captured video V1 are displayed for the plurality of cameras 2, the AR system 5 inputs the captured video V1 and the metadata MT of each camera 2.

At step S201, the AR system 5 generates a view frustum 40 for the camera operator for the current frame. The view frustum 40 for the camera operator is the view frustum 40 to be combined with the bird's-eye view video V3-2 to be transmitted to and displayed by the camera 2.

In the case of the AR system 5 configured in FIG. 4, a view frustum 40 for the camera operator is generated separately corresponding to each of the cameras 2.

In the case of the AR system 5 having the configuration of FIG. 3, the AR system 5 in the camera system 1 generates the view frustum 40 displayed by the camera 2 of the camera system 1.

The AR system 5 sets the direction of the view frustum 40 in the CG space 30 according to the attitude of the camera 2, the quadrangular pyramid shape according to the angle of view, the position of the focus plane 41 or the depth of field range 42 based on the focal length or the diaphragm value, and the like from the metadata MT acquired in step S102, and generates a video image of the view frustum 40 according to the setting.

In a case where the view frustum 40 is displayed for the plurality of cameras 2, the AR system 5 generates the video of the view frustum 40 according to the metadata MT of each camera 2.

At step S202, the AR system 5 generates a view frustum 40 for the director for the current frame. The view frustum 40 for a director is the view frustum 40 to be combined with the bird's-eye view video V3-1 to be transmitted to and displayed on the GUI device 11.

Basically, similarly to step S201, the video of the view frustum 40 based on the attitude (imaging direction), the angle of view, the focal length, and the diaphragm value of each camera 2 is generated.

However, the display modes of the view frustum 40 for the Camera operator generated in step S201 and the view frustum 40 for the director generated in step S202 may be different. Specific examples will be described later.

In step S203, the AR system 5 combines the view frustum 40 generated for the camera operator with the CG space 30 to be the bird's-eye view video V3-2, and generates video data of one frame of the bird's-eye view video V3-2. Note that the captured video V1 may be combined corresponding to each view frustum 40.

In step S204, the AR system 5 combines the view frustum 40 generated for the director with the CG space 30 to be the bird's-eye view video V3-1 to generate video data of one frame of the bird's-eye view video V3-1. Note that the captured video V1 may be combined corresponding to each view frustum 40.

Then, in step S205, the AR system 5 outputs video data of one frame of the bird's-eye view videos V3-1 and V3-2.

The above process is repeated until the display of the view frustum 40 ends.

A process of highlighting one view frustum 40, for example, the view frustum 40a as illustrated in FIG. 28 by the process of FIG. 30 will be described.

Note that FIG. 28 is an example of the bird's-eye view video V3-1 visually recognized by the director. It is assumed that the bird's-eye view video V3-2 visually recognized by the camera operator at this time is not highlighted. That is, in the bird's-eye view video V3-2, the view frustums 40a, 40b, and 40c are all displayed in the same display mode of white translucency.

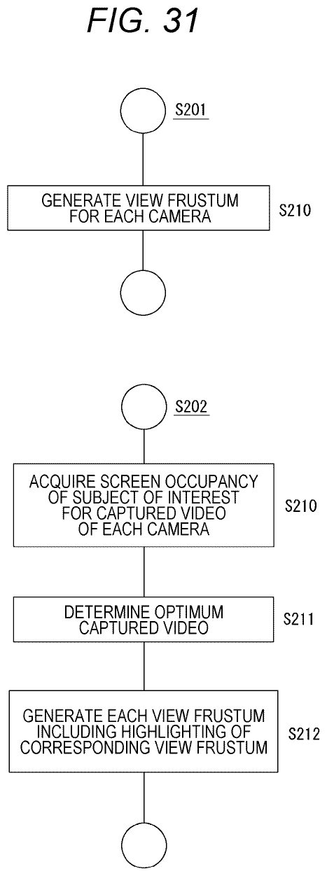

FIG. 31 illustrates a specific example of the processing in steps S201 and S202 in FIG. 30.

In step S201, the AR system 5 generates a view frustum 40 for each camera 2 in step S210. That is, for example, the view frustums 40a, 40b, and 40c are generated as the same white translucent image for the camera operator.

In subsequent step S202, the AR system 5 acquires the value of the screen occupancy rate of the subject of interest for the captured video V1 of each camera 2 in step S210.

For example, the AR system 5 constantly executes image recognition processing on the captured video V1 of each camera 2, determines whether or not the set subject of interest is imaged, and determines the screen occupancy in each frame. For example, the screen occupancy is obtained by determining that the subject of interest is captured as illustrated in FIG. 29 and the area of the subject of interest in the screen. In step S210, the AR system 5 acquires the screen occupancy of the subject of interest in each captured video V1 at the current time point calculated as described above.

In step S211, the AR system 5 determines the optimum captured video V1. For example, the captured video V1 having the highest screen occupancy is optimized.

At step S212, the AR system 5 generates a video of each view frustum 40 including a highlighting of the view frustum 40 corresponding to the camera 2 of the optimal captured video V1 as the view frustum 40 for the director. For example, the view frustum 40a is a red translucent image as a mode of highlight display, and the view frustums 40b and 40c are white translucent images.

After performing the processing of steps S201 and S202 of FIG. 30 as illustrated in FIG. 31, the AR system 5 performs the processing of steps S203, S204, and S205. As a result, the bird's-eye view video V3-1 displayed on the GUI device 11 is as illustrated in FIG. 28. On the other hand, in the bird's-eye view video V3-2 displayed by each camera 2, the view frustum 40 is not highlighted.

As a result, the director can recognize the camera 2 that currently captures the subject of interest in the largest size.

In the above description, the view frustum 40 to be highlighted by the screen occupancy of the subject of interest is selected, but may be selected by the continuous imaging time instead of the screen occupancy.

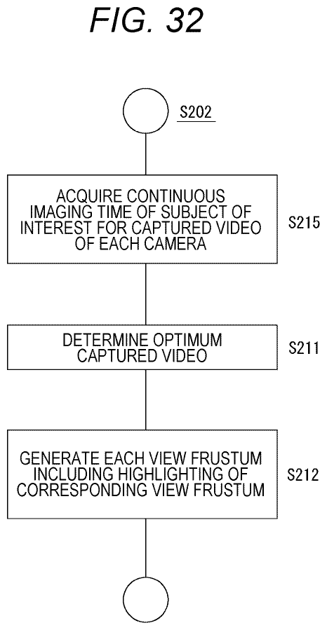

FIG. 32 illustrates another example of step S202. Note that step S201 is similar to that in FIG. 31.

In step S202 of FIG. 30, at step S215 of FIG. 32, the AR system 5 acquires the value of the continuous imaging time of the subject of interest for the captured video V1 of each camera 2.

As described above, the AR system 5 always executes the image recognition processing on the captured video V1 of each camera 2, and determines whether or not the set subject of interest is imaged. In this case, the duration (the number of continuous frames) in which the subject of interest is recognized is obtained for each captured video V1. Then, in step S215, the AR system 5 acquires the continuous imaging time calculated as described above.

In step S211, the AR system 5 determines the optimum captured video V1. In this case, the captured video V1 having the longest continuous imaging time is optimized.

At step S212, the AR system 5 generates a video of each view frustum 40 including a highlighting of the view frustum 40 corresponding to the camera 2 of the optimal captured video V1 as the view frustum 40 for the director.

Thereafter, the AR system 5 performs the processing of steps S203, S204, and S205 in FIG. 30. As a result, the bird's-eye view video V3-1 displayed on the GUI device 11 is as illustrated in FIG. 28.

As a result, the director can recognize the camera 2 continuously capturing the subject of interest for a long time.

Note that, in a case where the highlighting of the view frustum 40 is performed according to the screen occupancy of the subject of interest or the continuous imaging time in the bird's-eye view video V3-1 as described above, it is also conceivable to perform processing of displaying the captured video V1 only on the view frustum 40 to be highlighted. This allows the director to simultaneously confirm how the subject of interest is captured.

Next, an example in which the display mode of the bird's-eye view video V3-1 visually recognized by the director is changed by feedback from the camera operator will be described.

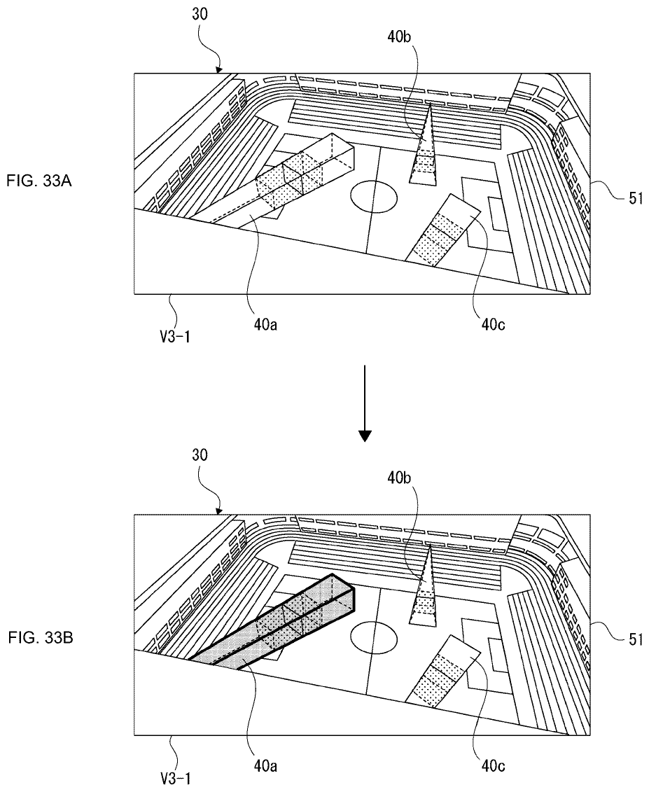

FIG. 33A illustrates a bird's-eye view video V3- as the device display image 51 of the GUI device 11. In this example, the view frustums 40a, 40b, and 40c are displayed in the same display mode, for example, white translucent.

Here, it is assumed that a specific operation is performed by a camera operator (or a remote operator) of the camera 2 corresponding to the view frustum 40a among the plurality of cameras 2.

In this case, the bird's-eye view video V3-1 is as illustrated in FIG. 33B. That is, the view frustum 40a is in a mode of highlighting different from the view frustums 40b and 40c, and is clearly indicated to the director.

For example, the specific operation by the camera operator is an operation in which the camera operator notifies the director that “Now, good video is obtained”. In a case where such an operation is enabled on the camera 2 side and the operation is performed, the AR system 5 sets the display mode of the view frustum 40 of the camera 2 on which the operation is performed to be different from the others in the bird's-eye view video V3-1.

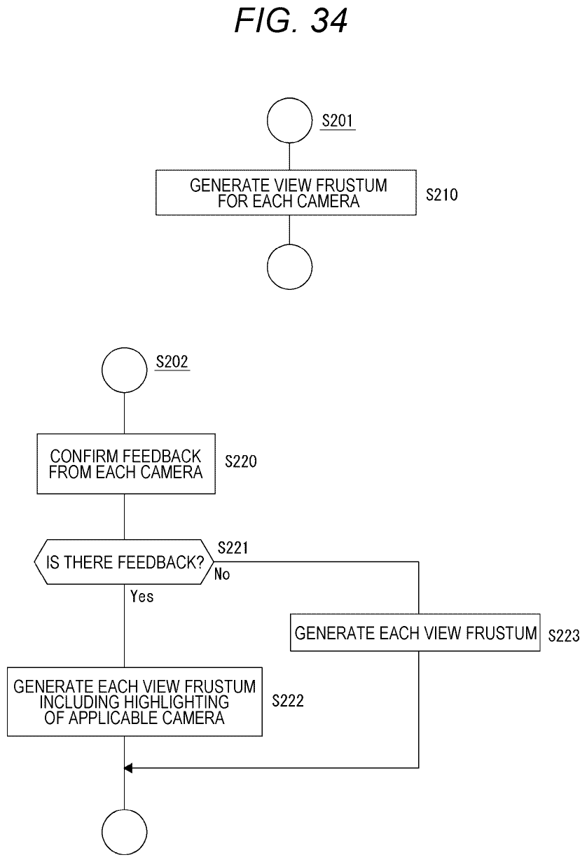

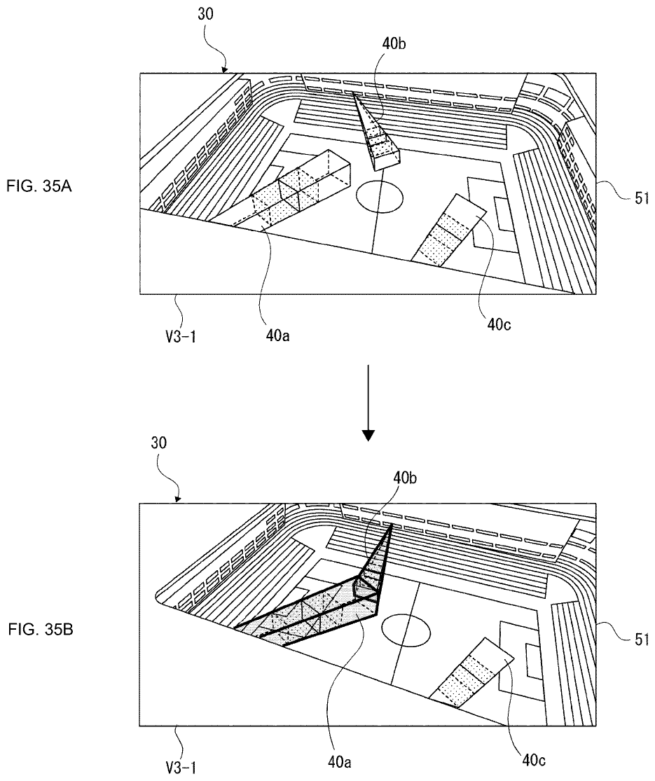

A processing example is illustrated in FIG. 34. FIG. 34 illustrates a specific example of steps S201 and S202 in FIG. 30.

In step S201 of FIG. 30, the AR system 5 generates an image of the view frustum 40 for the camera operator in step S210 of FIG. 34. For example, the same white translucent image is generated as the view frustums 40a, 40b, and 40c.

In step S202 of FIG. 30, the AR system 5 first confirms whether or not there is feedback from each camera, that is, a specific operation by the camera operator in step S220 of FIG. 34, and branches the process in step S221.

If there is no identification operation, the AR system 5 proceeds from step S221 to step S223 and generates an image of the view frustum 40 for the director. For example, the same white translucent image is generated as the view frustums 40a, 40b, and 40c.

On the other hand, in a case where the identifying operation is detected, the AR system 5 proceeds to step S222 and generates an image of the view frustum 40 for the director including the highlight display. For example, the view frustum 40a is generated as a red translucent image, and the view frustums 40b and 40c are generated as a white translucent image.

Thereafter, the AR system 5 performs the processing of steps S203, S204, and S205 in FIG. 30. As a result, the bird's-eye view video V3-1 displayed on the GUI device 11 is as illustrated in FIG. 33A or 33B. That is, in a case where there is no specific operation from the camera operator, the video is as illustrated in FIG. 33A, and the video is as illustrated in FIG. 33B from the time point when there is the specific operation from the camera operator. As a result, the director can recognize appeal of “Now, good video is obtained” from the camera operator.

On the other hand, in the bird's-eye view video V3-2 displayed by each camera 2, the view frustums 40a, 40b, and 40c are displayed in the same display mode.

Next, an example of changing the display mode in a case where the view frustum 40 overlaps on the video will be described.

FIG. 35A illustrates a bird's-eye view video V3-1 as the device display image 51 of the GUI device 11. In this example, the view frustums 40a, 40b, and 40c are displayed in the same display mode.

Here, as illustrated in FIG. 35B, it is assumed that the view frustums 40a and 40b overlap each other on the video. In that case, the view frustums 40a and 40b are in a mode of highlighting different from a normal mode so that the director can easily recognize the view frustums.

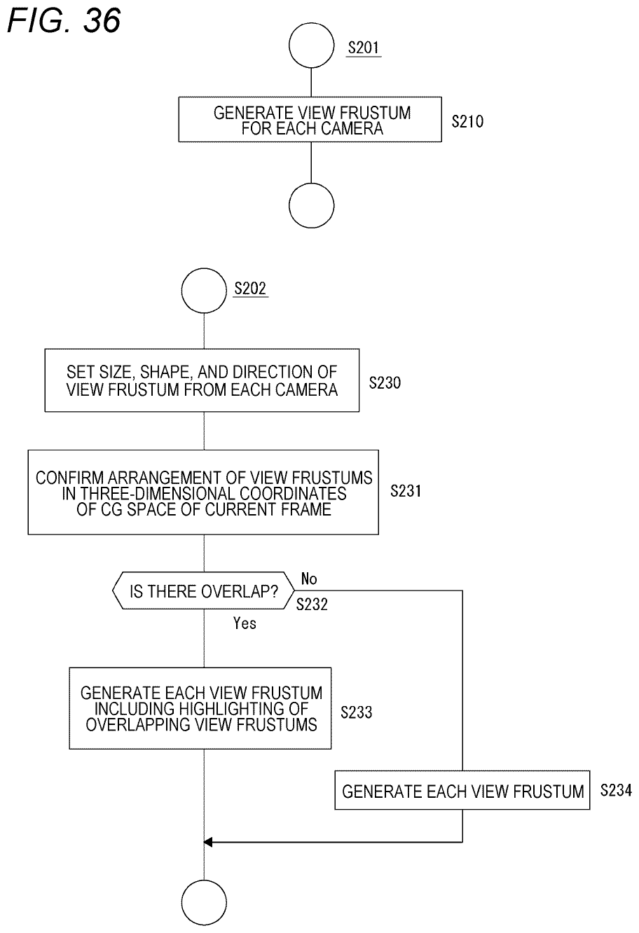

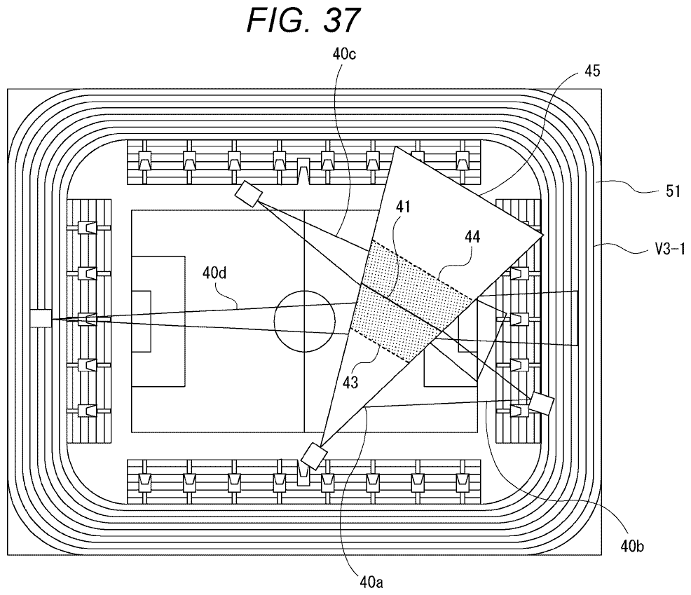

A processing example is illustrated in FIG. 36. FIG. 36 illustrates a specific example of steps S201 and S202 in FIG. 30.

In step S201 of FIG. 30, the AR system 5 generates an image of the view frustum 40 for the camera operator in step S210 of FIG. 36. For example, the same white translucent image is generated as the view frustums 40a, 40b, and 40c.

In step S202 of FIG. 30, the AR system 5 first sets the size, shape, and direction of the view frustum 40 of each camera 2 on the basis of the metadata MT of each camera 2 in step S230 of FIG. 36.

In step S231, the AR system 5 confirms the arrangement of each view frustum 40 in the three-dimensional coordinates of the CG space 30 of the current frame. Thereby, the presence or absence of overlapping of the view frustum 40 can be confirmed.

In step S232, the AR system 5 branches the process depending on the presence or absence of the overlap.

In a case where there is no overlapping view frustum 40, the AR system 5 proceeds to step S234 to generate an image of the view frustum 40 for the director. For example, the same white translucent image is generated as the view frustums 40a, 40b, and 40c.

On the other hand, in a case where there is the overlap, the AR system 5 proceeds to step S233 to generate an image of the view frustum 40 for the director including highlighting. In this case, the plurality of overlapping view frustums 40, for example, the view frustums 40a and 40b are generated as a red translucent image, and the non-overlapping view frustum 40c is generated as a white translucent image.

Thereafter, the AR system 5 performs the processing of steps S203, S204, and S205 in FIG. 30. As a result, the bird's-eye view video V3-1 displayed on the GUI device 11 is as illustrated in FIG. 35A or 35B. That is, in a case where there is no overlap of the view frustum 40, the video is as illustrated in FIG. 35A, and when there is an overlap, the video is as illustrated in FIG. 35B. As a result, a director or the like can easily recognize a situation in which the same subject is imaged from different viewpoints by the plurality of cameras 2. This makes it possible to clarify an instruction to each camera operator. Furthermore, it is also convenient to switch the main line video in a case where it is desired to switch the video of the same subject.

On the other hand, in the bird's-eye view video V3-2 displayed by each camera 2, the view frustums 40a, 40b, and 40c are displayed in the same display mode.

### 4-2: Priority Display

Next, an example in which a certain view frustum 40 is preferentially displayed in a case where the view frustum 40 overlaps on the video will be described.

As illustrated in FIG. 17, considering a case where the view frustums 40a, 40b, 40c, and 40d overlap, visibility may be reduced due to the overlap. In particular, by overlapping the translucent view frustum 40, it is difficult to understand the focus plane 41, the depth of field range 42, and the like.

Therefore, as illustrated in FIG. 37, one view frustum 40 is preferentially displayed.

FIG. 37 illustrates a bird's-eye view video V3-1 as the device display image 51 of the GUI device 11. In this example, the view frustums 40a, 40b, 40c, and 40d overlap each other, but the view frustum 40a is preferentially set, and the focus plane 41 and the depth of field range 42 of the view frustum 40a are displayed in the overlapping portion.

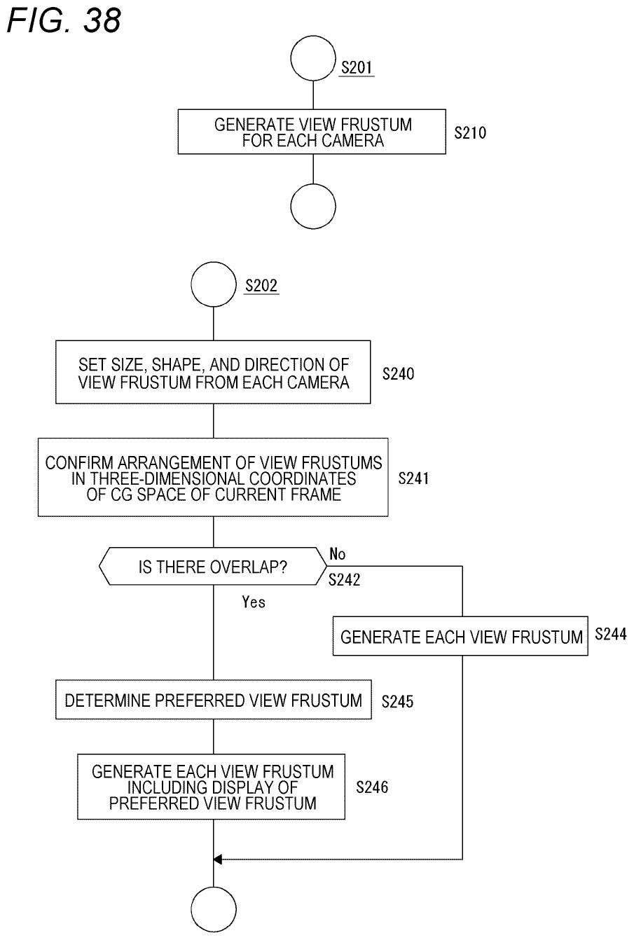

A processing example is illustrated in FIG. 38. FIG. 38 illustrates a specific example of steps S201 and S202 in FIG. 30.

In step S201 of FIG. 30, the AR system 5 generates an image of the view frustum 40 for the camera operator in step S210 of FIG. 38. For example, images as view frustums 40a, 40b, 40c, and 40d are generated. The image of the view frustum 40 for the camera operator is not particularly prioritized.

In step S202 of FIG. 30, the AR system 5 first sets the size, shape, and direction of the view frustum 40 of each camera 2 on the basis of the metadata MT of each camera 2 in step S240 of FIG. 38.

In step S241, the AR system 5 confirms the arrangement of each view frustum 40 in the three-dimensional coordinates of the CG space 30 of the current frame. Thereby, the presence or absence of overlapping of the view frustum 40 can be confirmed.

In step S242, the AR system 5 branches the process depending on the presence or absence of the overlap.

In a case where there is no overlapping view frustum 40, the AR system 5 proceeds to step S244 to generate an image of the view frustum 40 for the director. For example, images as view frustums 40a, 40b, 40c, and 40d are generated.

On the other hand, in a case where there is an overlap, the AR system 5 proceeds to step S245 to determine a preferred view frustum 40 among the overlapping view frustums 40.

Alternatively, the preferred view frustum 40 may be determined among all view frustums 40, including non-overlapping ones.

Several methods of determination are conceivable.

For example, it is conceivable to prioritize the view frustum 40 of the camera 2 that is currently the main line video.

Alternatively, a director or the like may arbitrarily select a preferred view frustum 40.

Furthermore, as described above, the view frustum 40 selected to be highlighted by imaging the subject of interest or a specific operation of the camera operator may be prioritized.

At step S246, the AR system 5 generates an image of the view frustum 40 for the director. In this case, the prioritized view frustum 40 is an image in which the focus plane 41 and the depth of field range 42 are normally displayed. Other view frustums 40 are images in which the focus plane 41 and the depth of field range 42 are not displayed in a portion overlapping the prioritized view frustum 40. Alternatively, all the other view frustums 40 may be images in which the focus plane 41 and the depth of field range 42 are not displayed.

Thereafter, the AR system 5 performs the processing of steps S203, S204, and S205 in FIG. 30. As a result, the bird's-eye view video V3-1 displayed on the GUI device 11 becomes an image in which the focus plane 41 and the depth of field range 42 can be clearly recognized for the prioritized view frustum 40 even if the view frustum 40 overlaps as illustrated in FIG. 37.

On the other hand, in the bird's-eye view video V3-2 displayed by each camera 2, the view frustums 40a, 40b, 40c, and 40d are displayed as illustrated in FIG. 17.

Note that, in FIGS. 37 and 38, priority is set for the bird's-eye view video V3-1 on the director side, but priority may be set for the bird's-eye view video V3-2 on the camera operator side. Considering that the camera operator visually recognizes, the view frustum 40 of the camera 2 operated by the camera operator is preferably prioritized.

Therefore, in step S201 in FIG. 30 in which the view frustum generation for the camera operator is performed, processing similar to that in steps S240 to S246 in FIG. 38 may be performed. However, the prioritized view frustum determination in step S245 is the view frustum 40 of the own camera 2.

As a result, even if the view frustum 40 overlaps the view frustum 40 of another camera 2, the camera operator can clearly visually recognize the focus plane 41 and the depth of field range 42 of the camera 2 operated by the camera operator.

In a case where priority is set on the bird's-eye view video V3-2 in this manner, priority may be set on the bird's-eye view video V3 visually recognized by the director as described above, or priority may not be set on the bird's-eye view video V3-1.

Even in a case where priority is set for both of the bird's-eye view videos V3-1 and V3-2, the bird's-eye view video V3-1 and all of the bird's-eye view videos V3-2 displayed by the cameras 2 do not have the same display mode because the determination condition of the prioritized view frustum 40 is different.

Furthermore, in the bird's-eye view video V3-2 visually recognized by the camera operator, it is conceivable to display only the view frustum 40 of the own camera 2 and not to display the view frustum 40 of another camera 2.

### 4-3: Instruction Display

Next, an example in which an instruction from the director can be visually conveyed to the camera operator will be described.

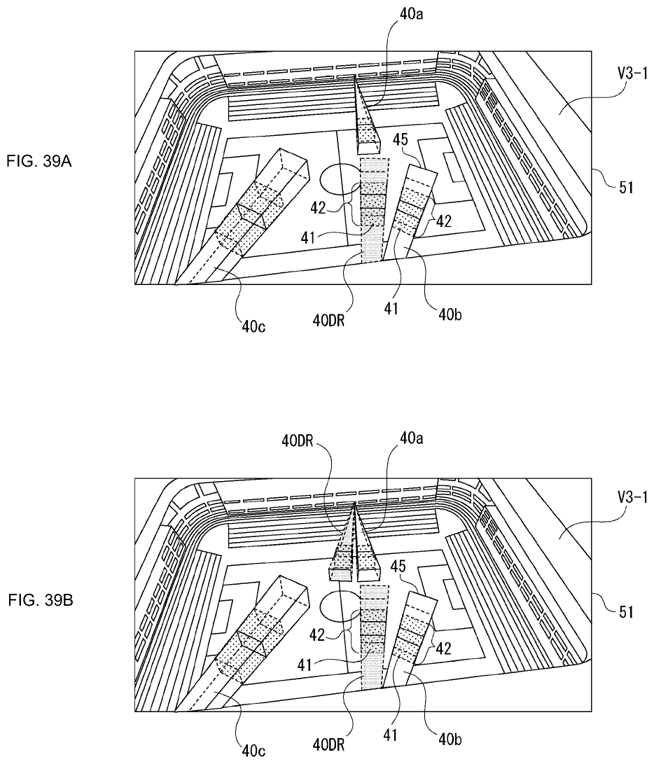

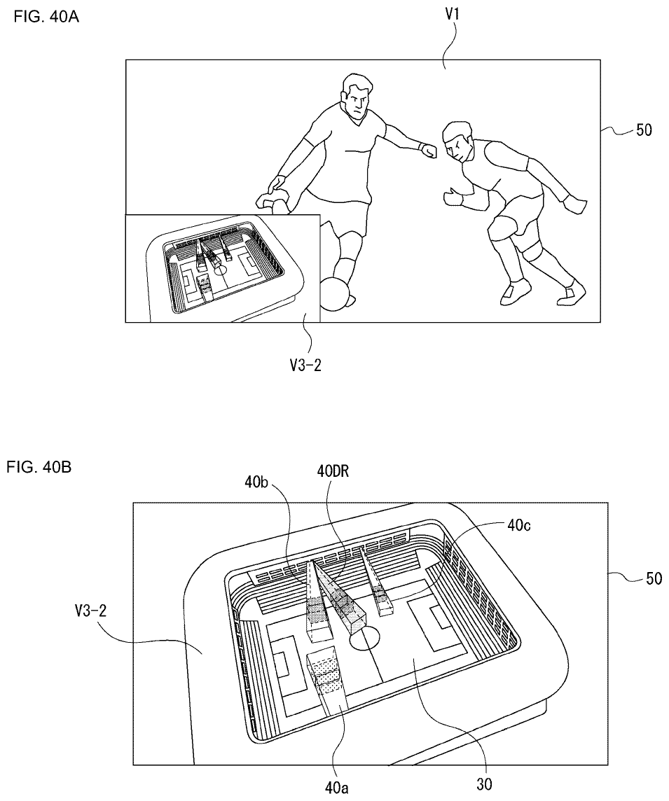

FIGS. 39A and 39B illustrate the bird's-eye view video V3-1 as the device display image 51 of the GUI device 11. In this example, view frustums 40a, 40b, and 40c are displayed.

Furthermore, FIG. 40A illustrates a bird's-eye view video V3-2 as a viewfinder display video 50 of the camera 2. In this example, it is assumed that the bird's-eye view video V3-2 is combined at the corner of the screen of the captured video V1. FIG. 40B illustrates the bird's-eye view video V3-2 in an enlarged manner.

FIG. 39A illustrates an example of a case where a director performs an instruction operation on the camera 2 of the view frustum 40a. For example, the director causes the GUI device 11 to display the instruction frustum 40DR according to an operation such as dragging the view frustum 40b. This is an instruction by the director for the camera operator of the camera 2 of the view frustum 40b to change the imaging direction to the direction of the instruction frustum 40DR.

Therefore, in this case, as illustrated in FIGS. 40A and 40B, the AR system 5 causes the instruction frustum 40DR to be displayed for the view frustum 40b also in the bird's-eye view video V3-2 visually recognized by the camera operator.

The camera operator operating the camera 2 of the view frustum 40b can respond to the director's instruction by changing the imaging direction such that the view frustum 40b matches the instruction frustum 40DR.

In the instruction frustum 40DR, not only the imaging direction but also the angle of view, the focus plane 41, and the like may be instructed. For example, a director may operate the instruction frustum 40DR to move the focus plane 41 back and forth or to widen the angle of view (change the inclination of the quadrangular pyramid).

The camera operator can also perform focus adjustment such that the focus plane 41 of the view frustum 40b matches the instruction frustum 40DR, or perform angle of view adjustment such that the inclinations of the quadrangular pyramids match.

Note that the bird's-eye view video V3-1 in FIG. 39A and the bird's-eye view video V3-2 in FIGS. 40A and 40B illustrate examples in which viewpoint positions with respect to the CG space 30 are different. The bird's-eye view videos V3-1 and V3 -2 enable a director and a camera operator to change viewpoint positions by operation. The illustrated example indicates that the CG space 30 is not necessarily displayed in a state of being viewed from the same viewpoint position in the bird's-eye view video V3-1 and the bird's-eye view video V3-2.

FIG. 39B illustrates a state in which the director further performs an instruction operation on the view frustum 40a to display the instruction frustum 40DR. As described above, in the bird's-eye view video V3-1, an instruction can be given to each view frustum 40.

Note that even when a new instruction is issued as illustrated in the drawing, it is desirable to display the instruction frustum 40DR of the previous instruction (instruction to the view frustum 40b) as it is. This is to enable the director to confirm valid instructions currently being made.

It is conceivable that the instruction frustum 40DR is erased from the bird's-eye view videos V3-1 and V3-2 when the view frustum 40 of the indicated camera 2 substantially matches the instruction frustum 40DR.

Alternatively, the instruction frustum 40DR is also deleted from the bird's-eye view videos V3-1 and V3-2 by the cancellation operation of the director. For example, this is to be able to cope with cancellation of instructions, change of instructions, and the like.

Furthermore, in the bird's-eye view video V3-2, the instruction frustum 40DR for all the cameras 2 may be displayed, or only the instruction frustum 40DR for the own camera 2 may be displayed. These may be selected by the camera operator.

By displaying the instruction frustum 40DR for all the cameras 2 in each camera 2, each camera operator can grasp what kind of instruction is issued as a whole.

On the other hand, by displaying the instruction frustum 40DR only for the own camera 2, the camera operator can easily recognize the instruction from the director to the camera operator.

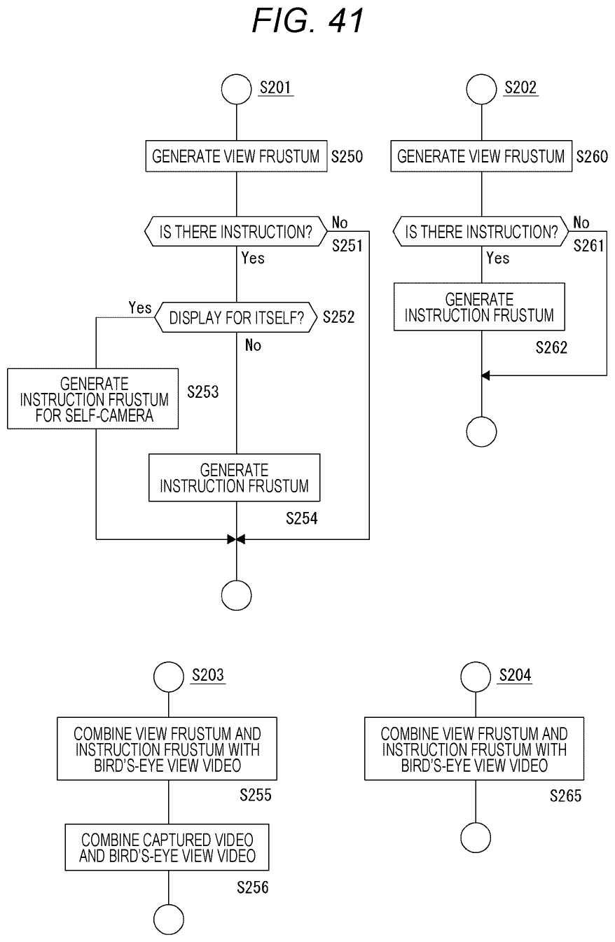

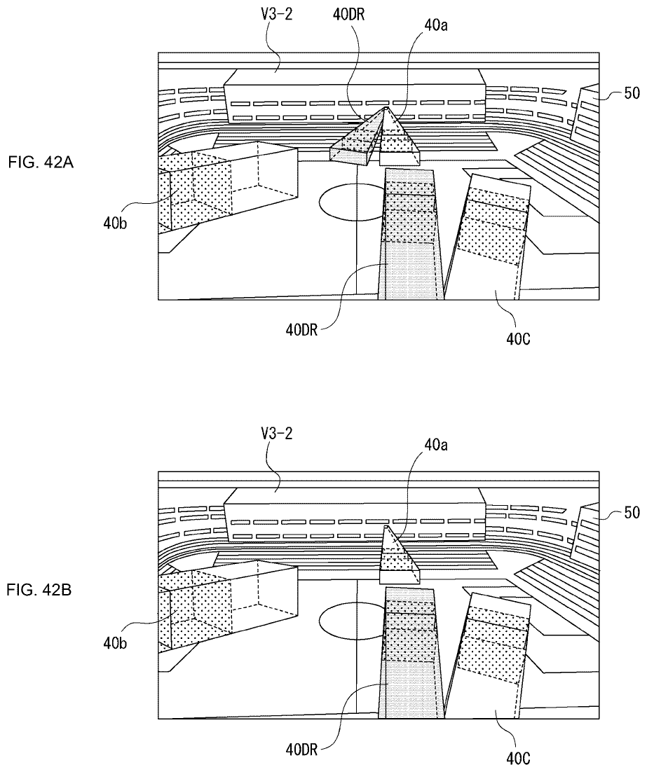

A processing example is illustrated in FIG. 41. FIG. 41 illustrates a specific example of steps S201, S202, S203, and S204 in FIG. 30.

In Step S201 of FIG. 30, the AR System 5 Performs the

processing of steps S250 to S254 of FIG. 41.

First, in step S250, the AR system 5 generates an image of the view frustum 40 for the camera operator. For example, images as the view frustums 40a, 40b, and 40c are generated.

In step S251, the AR system 5 confirms the presence or absence of an instruction operation by the director. Especially in a case where there is no instruction operation, the process proceeds to step S202 in FIG. 30.

In a case where the instruction operation has been performed, the AR system 5 proceeds from step S251 to step S252 in FIG. 41 and branches the process according to the display mode of the instruction frustum 40DR.

The display mode in this case includes a mode of displaying only the instruction frustum 40DR for the camera operator and a mode of displaying all the instruction frustums 40DR, and the camera operator can select the display mode.

Note that such mode selection may not be enabled, and only the instruction frustum 40DR for the own device may be always displayed, or all the instruction frustums 40DR may be always displayed.

In the case of the mode for displaying the instruction frustum 40DR for itself, the AR system 5 proceeds to step S253 and generates an image of the instruction frustum 40DR. However, in a case where the instruction from the director is not an instruction to the camera 2 of the generation processing target of the bird's-eye view video V3-2, the image of the instruction frustum 40DR may not be generated in step S253.

In this case, the respective pieces of video data as the bird's-eye view video V3-2 transmitted to the respective cameras 2 have different display contents. That is, for each camera 2, there are video data that is a video including the instruction frustum 40DR and video data that is a video not including the instruction frustum 40DR.

In the case of the mode for displaying all the instruction frustums 40DR, the AR system 5 proceeds to step S254 and generates an image of the instruction frustum 40DR valid at that time.

Following the above processing of steps S250 to S254, the AR system 5 performs the processing of step S202 of FIG. 30 as illustrated in steps S260 to S262 of FIG. 41.

At step S260, the AR system 5 generates an image of the view frustum 40 for the director. For example, images as the view frustums 40a, 40b, and 40c are generated.

In step S261, the AR system 5 confirms the presence or absence of an instruction operation by the director. If there is no instruction operation, the process proceeds to step S203 in FIG. 30.

In a case where the instruction operation has been performed, the AR system 5 proceeds from step S261 to step S262 in FIG. 41, and generates an image of the instruction frustum 40DR valid at that time.

As step S203 of FIG. 30, the AR system 5 performs the processing of steps S255 and S256 of FIG. 41.

In step S255, the AR system 5 combines the view frustum 40 and the instruction frustum 40DR with the bird's-eye view video V3-2. As a result, video data of the bird's-eye view video V3-2 as illustrated in FIG. 40B is generated.

In step S256, the AR system 5 combines the bird's-eye view video V3-2 and the captured video V1 to generate the video data of the combined image as illustrated in FIG. 40A.

Note that the combination of the bird's-eye view video V3-2 and the captured video V1 may be performed on the camera 2 side.

At step S204 of FIG. 30, the AR system 5 performs the processing of step S265 of FIG. 41.

In step S265, the AR system 5 combines the view frustum 40 and the instruction frustum 40DR with the bird's-eye view video V3-1. As a result, video data of the bird's-eye view video V3-1 as illustrated in FIGS. 39A and 39B is generated.

Thereafter, in step S205 of FIG. 30, the bird's-eye view video V3-1 is transmitted to the GUI device 11, and the bird's-eye view video V3-2 corresponding to each camera 2 is transmitted to each camera 2.

As a result, the director can confirm his/her instruction operation on the instruction frustum 40DR in the bird's-eye view video V3-1, and each camera operator can visually confirm the instruction from the director on the instruction frustum 40DR.

Meanwhile, the display of the instruction frustum 40DR visually recognized by the camera operator can be seen in the bird's-eye view video V3-2, but it is preferable to control the viewpoint position of the bird's-eye view video V3-2 to make it easier for the camera operator to understand the instruction.

For example, FIGS. 42A and 42B illustrate a bird's-eye view video V3-2 as a viewfinder display video 50 of the camera 2. These are bird's-eye view videos V3-2 with the position of the camera 2 of the view frustum 40c as the viewpoint position, and are images visually recognized by the camera operator of the camera 2.

Note that the bird's-eye view video V3-2 of FIG. 42A is an example in which the instruction frustum 40DR for the view frustum 40c is displayed and the instruction frustum 40DR for the view frustum 40a of another camera 2 is also displayed.

Furthermore, in the bird's-eye view video V3-2 of FIG. 42B, the instruction frustum 40DR for the view frustum 40c is displayed, but the instruction frustum 40DR for the view frustum 40a of another camera 2 is not displayed.

As illustrated in FIG. 42A or FIG. 42B, when the visually recognized camera operator can view the bird's-eye view video V3-2 in a state close to his/her own viewpoint, it is easy to understand the directionality of the instruction by the instruction frustum 40DR.

That is, in FIGS. 42A and 42B, it is intuitively understood that instruction frustum 40DR directed to the own device is an instruction to turn the imaging direction to the left.

Therefore, in a case where the instruction frustum 40DR is displayed in the bird's-eye view video V3-2, the viewpoint position is set to the 3D image set as the camera position, and the view frustum 40 and the instruction frustum 40DR are displayed thereon.

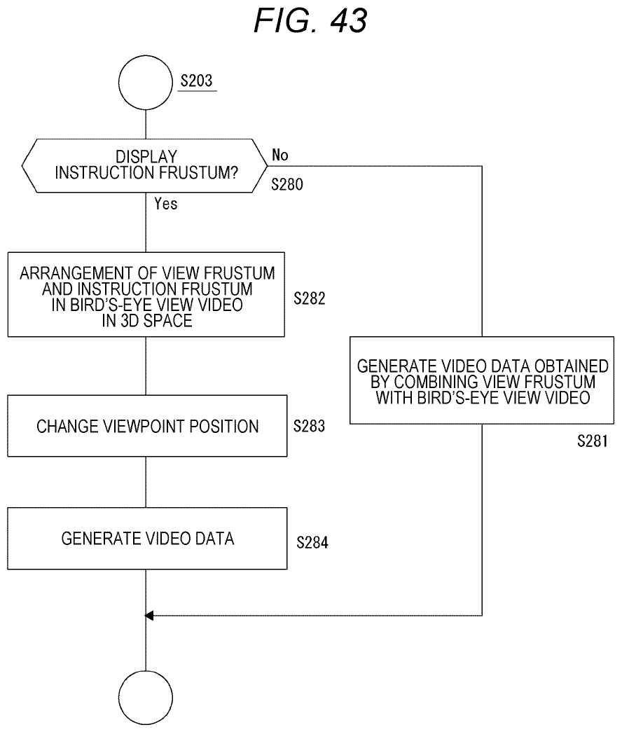

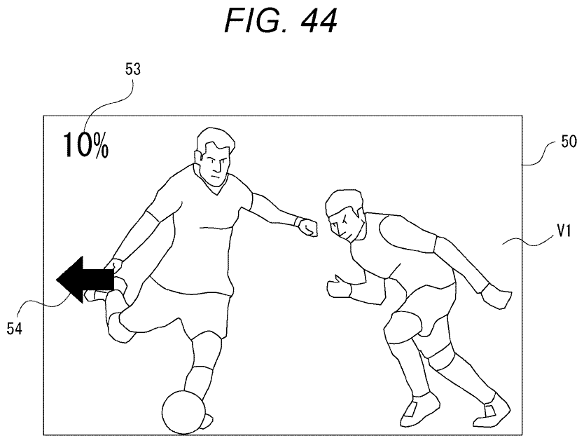

A processing example will be described. First, the AR system 5 performs steps S201 and S202 in FIG. 30 as illustrated in FIG. 41. Then, step S203 in FIG. 30 is performed as illustrated in FIG. 43.

In step S280, the AR system 5 branches the process depending on whether or not to display the instruction frustum 40DR in the current frame.

If the instruction frustum 40DR is not displayed in the bird's-eye view video V3-2 for the camera 2 to be processed, the AR system 5 proceeds to step S281 and generates video data obtained by combining the image of the view frustum 40 with the bird's-eye view video V3-2.

In a case where the instruction frustum 40DR is displayed in the current frame, the AR system 5 proceeds to step S282 and sets the arrangement of the view frustum 40 and the instruction frustum 40DR in the 3D spatial coordinates for generating the bird's-eye view video V3-2.

Then, in step S283, the AR system 5 sets the viewpoint position in the 3D spatial coordinates. That is, the coordinates of the position of a specific camera 2 among the plurality of cameras as the transmission destination of the bird's-eye view video V3-2 are set as the viewpoint position.

In step S284, the AR system 5 generates the video data of the bird's-eye view video V3-2 which is the CG combined with the view frustum 40 and the instruction frustum 40DR at the set viewpoint position.

By such processing, in a case where the bird's-eye view video V3-2 including the instruction frustum 40DR is displayed as the viewfinder display video 50, the camera operator can visually recognize the image as illustrated in FIG. 42A or 42B from the viewpoint of the camera 2. This makes it easier to understand the direction of the director.

By the way, it is convenient to enable the camera operator to arbitrarily switch the viewfinder display video 50 between the bird's-eye view video V3-2 and the captured video V1.

For example, the viewfinder display video 50 can be switched between the bird's-eye view video V3-2 as illustrated in FIG. 42A and the captured video V1 as illustrated in FIG. 44 by the operation of the camera operator.

In particular, since the camera operator needs to always confirm the captured video V1 (that is, the live view) of the camera 2 operated by the camera operator during imaging, it is necessary to display the captured video V1 on the viewfinder.

Therefore, it is conceivable that the bird's-eye view video V3-2 is combined with the captured video V1 and displayed as illustrated in FIG. 40A, but the bird's-eye view video V3-2 may be small and the instruction frustum 40DR may be difficult to understand.

Therefore, it is preferable that the bird's-eye view video V3-2 as illustrated in FIG. 42A and the captured video V1 as illustrated in FIG. 44 are switched at an arbitrary timing so as to be displayed on the entire surface.

However, it is also necessary to know that an instruction has occurred during display of the captured video V1. Therefore, as illustrated in FIG. 44, the instruction direction 54 and a match rate 53 are displayed as the instruction information on the captured video V1.

The instruction direction 54 is the imaging direction instructed by the instruction frustum 40DR. The match rate 53 indicates a match rate of the current view frustum 40 and the instruction frustum 40DR. When the match rate is 100%, the current view frustum 40 matches the instruction frustum 40DR.

By performing the display in this manner, the camera operator can normally confirm that there is an instruction from the director even when visually recognizing the captured video V1, and can respond to the instruction depending on the instruction direction 54 and the match rate 53. Furthermore, it is also possible to confirm the instruction frustum 40DR by switching the screen to the bird's-eye view video V3-2 as necessary.

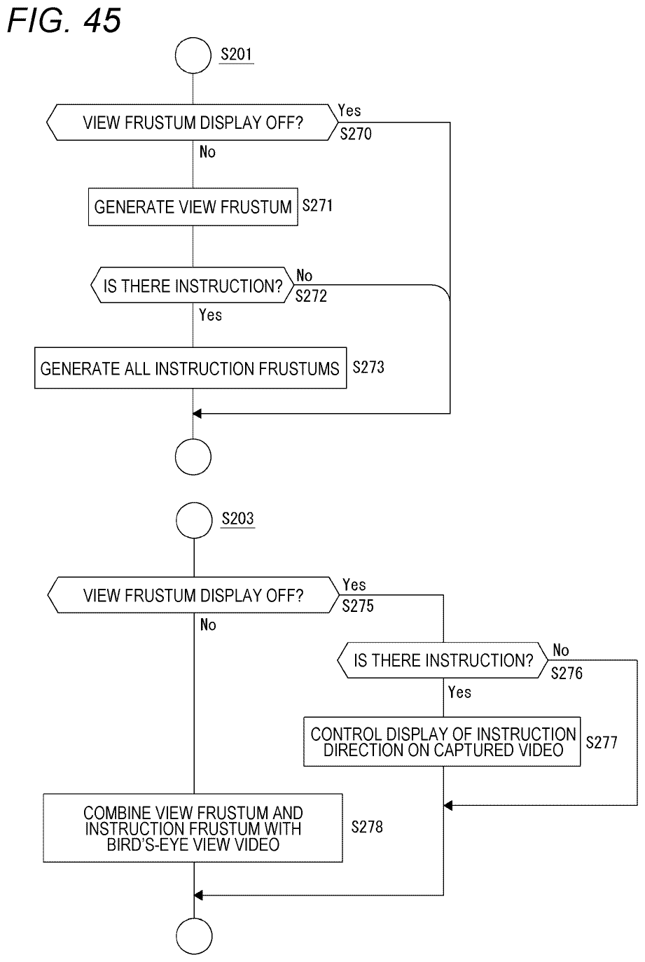

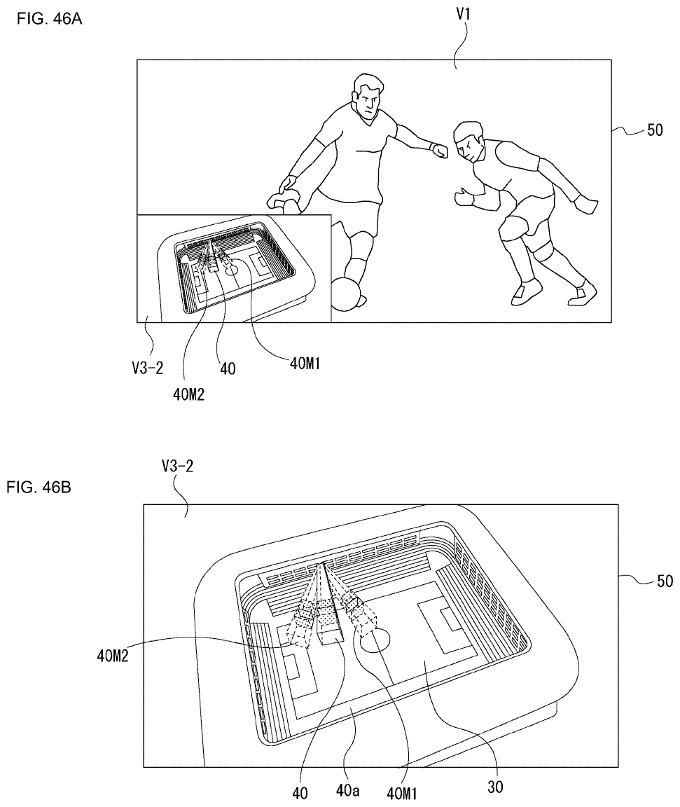

A processing example is illustrated in FIG. 45.

In step S201 of FIG. 30, the AR system 5 performs the processing from step S270 to step S273 of FIG. 45.

Furthermore, the AR system 5 performs the processing of steps S275 to S278 of FIG. 45 in step S203 of FIG. 30.

In step S270, the AR system 5 confirms whether or not the display of the view frustum 40 is OFF in the current frame. That is, it is confirmed whether or not it is a period in which not the bird's-eye view video V3-2 but the captured video V1 is displayed.

If the captured video V1 is selected as the viewfinder display video 50, the AR system 5 ends the processing of step S201. That is, it is not necessary to generate images of the view frustum 40 and the instruction frustum 40DR.

If the bird's-eye view video V3-2 is selected as the viewfinder display video 50, the AR system 5 generates the image data of the view frustum 40 on the basis of the metadata MT in step S271.

In step S272, the AR system 5 determines whether or not to display the instruction frustum 40DR.

A case where the instruction frustum 40DR is displayed is a case where the director performs an instruction operation. A mode for displaying all the above-described instruction frustums 40DR and a mode selection for displaying only the instruction frustum 40DR for the own camera are also confirmed.

If the instruction frustum 40DR is not displayed, the process of step S201 ends.

If the instruction frustum 40DR is to be displayed on the bird's-eye view video V3-2, the AR system 5 proceeds to step S273 and generates image data of the instruction frustum 40DR.

In step S203 of FIG. 30, the AR system 5 also confirms whether or not the display of the view frustum 40 is OFF in step S275 of FIG. 45. This is confirmation as to whether or not it is a period in which the captured video V1 is displayed.

If the camera 2 to be processed is currently displaying the bird's-eye view video V3-2, the AR system 5 proceeds to step S278, and combines the video data of the bird's-eye view video V3-2 with the video data of the view frustum 40. In a case where the image data of the instruction frustum 40DR is generated, the AR system 5 also generates the combined video data of the instruction frustum 40DR.

If the camera 2 to be processed is currently displaying the captured video V1, the AR system 5 proceeds to step S276 and branches the process depending on whether or not there is an instruction from the director. If there is no instruction, the processing of step S203 is ended. In a case where there is an instruction from the director, the instruction direction 54 and the match rate 53 are set to be displayed on the captured video V1 in step S277.

Thereafter, in step S205 in FIG. 30, video data is output to the camera 2. That is, the video data of the captured video V1 as illustrated in FIG. 44 or the video data of the bird's-eye view video V3-2 as illustrated in FIG. 42A is output to the camera 2.

Note that, for example, the viewfinder display video 50 may be switched among the captured video V1, the bird's-eye view video V3-2, and the combined video as illustrated in FIG. 40A by the operation of the camera operator.

### 4-4: Marker Display

Next, an example of executing marker display in the bird's-eye view video V3-2 as the viewfinder display video 50 visually recognized by the camera operator will be described.

FIG. 46A illustrates a state in which the captured video V1 and the bird's-eye view video V3-2 are displayed as the viewfinder display video 50 of the camera 2. In this example, the bird's-eye view video V3-2 is combined at the corner of the screen of the captured video V1. FIG. 46B illustrates the bird's-eye view video V3-2 in an enlarged manner.

Furthermore, as illustrated in FIG. 46B, in the bird's-eye view video V3-2 displayed by the camera 2, only the view frustum 40 of the camera itself is displayed.

In the bird's-eye view video V3-2 displayed on the GUI device 11 on the director side, the view frustums 40 of all the cameras 2 are displayed as described in FIG. 28 and the like, for example.

In the bird's-eye view video V3-2 illustrated in FIGS. 46A and 46B, marker frustums 40M1 and 40M2 are displayed in addition to the view frustum 40.

The marker frustums 40M1 and 40M2 are displayed in response to the registration of the subject position and direction to be imaged by the camera operator. That is, the camera operator frequently marks the direction in which he/she wants to image.

For example, the marker frustums 40M1 and 40M2 have a display mode different from that of the view frustum 40.

Furthermore, the marker frustum 40M1 and the marker frustum 40M2 may have different display modes.

For example, in a case where the view frustum 40 is white translucent, the marker frustum 40M1 is yellow translucent, the marker frustum 40M2 is light blue translucent, and the like.

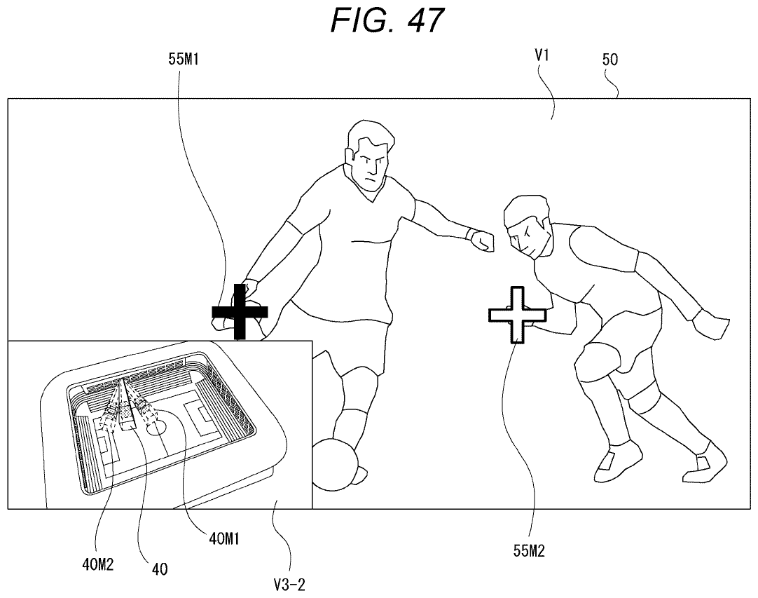

Furthermore, as illustrated in FIG. 47, the positions of the marker frustums 40M1 and 40M2 may be indicated by the markers 55M1 and 55M2 on the captured video V1.

In this case, the correspondence relationship may be clearly indicated by setting the marker 55M1 to yellow similarly to the marker frustum 40M1 and setting the marker 55M2 to light blue similarly to the marker frustum 40M2.

A processing example will be described. For description, the marker frustums 40M1 and 40M2 and the like are collectively referred to as a “marker frustum 40M”. Furthermore, the markers 55M1 and 55M2 and the like are collectively referred to as a “marker 55M”.

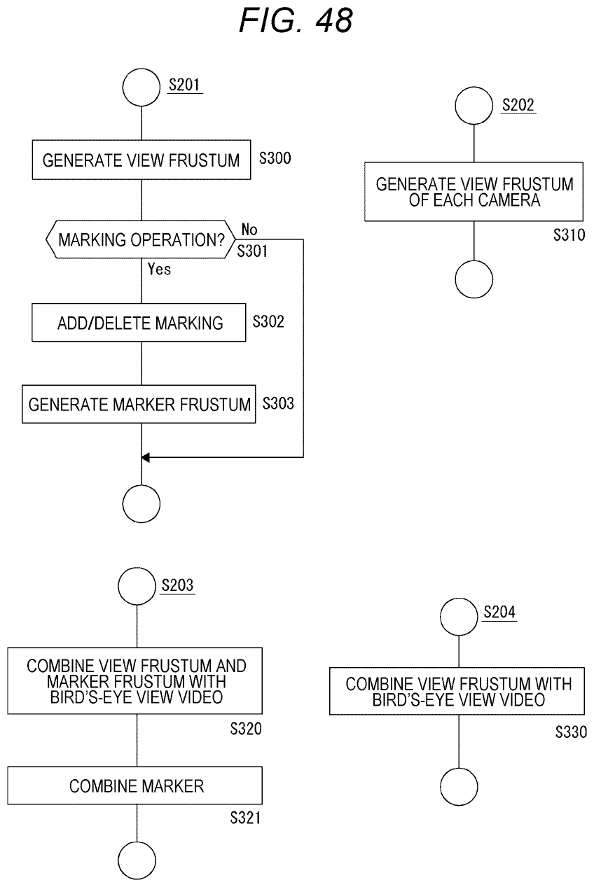

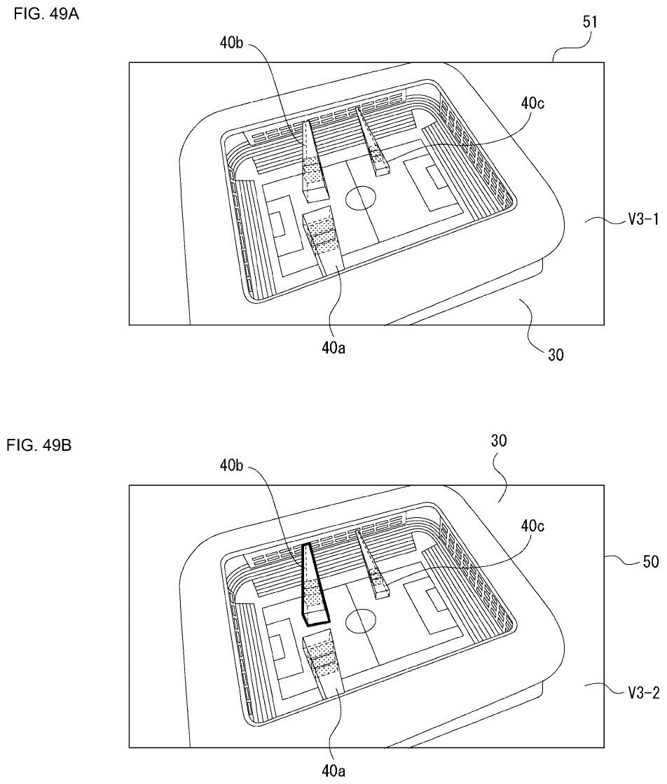

FIG. 48 illustrates a specific example of steps S201, S202, S203, and S204 in FIG. 30.

As step S201 of FIG. 30, the AR system 5 performs the processing of steps S300 to S303 of FIG. 48.

First, in step S300, the AR system 5 generates image data of the view frustum 40 on the basis of the metadata MT. For example, a view frustum 40 corresponding to the camera 2 to be processed is generated. A view frustum 40 corresponding to all the cameras 2 may also be generated.

In step S301, the AR system 5 determines whether or not a marking operation has been performed in the camera 2 to be processed. The marking operation is an operation of adding or deleting a marking. In particular, if the marking operation is not performed, the processing of step S201 is terminated.

In a case where the marking operation has been performed, the AR system 5 performs processing of adding the registration of the marking point or deleting the registration of the marking for the camera 2 to be processed in step S302.

Then, in step S303, the AR system 5 generates image data of the marker frustum 40M as necessary. That is, in a case where there is marking registration at that time, image data of the marker frustum 40M is generated.

In step S202 of FIG. 30, the AR system 5 generates a view frustum 40 for the director in step S310 of FIG. 48. In this case, the image data of the view frustum 40 corresponding to all the cameras 2 is generated.

In step S203 of FIG. 30, the AR system 5 performs the processing of steps S320 and S321 of FIG. 48.

In step S320, the AR system 5 combines the view frustum 40 with the CG data as the bird's-eye view video V3-2. Furthermore, in a case where there is marking registration, image data of the marker frustum 40M is also combined.

In step S321, the AR system 5 combines the marker 55M with the captured video V1 according to the marking registration.

As described above, the video data of the bird's-eye view video V3-2 and the captured video V1 to be transmitted to the camera 2 is generated.

In step S204 of FIG. 30, the AR system 5 performs the processing of step S330 of FIG. 48.

In step S330, the AR system 5 combines the view frustum 40 with the CG data as the bird's-eye view video V3-1.

As a result, the video data of the bird's-eye view video V3-1 is generated.

Thereafter, in step S205 of FIG. 30, the video data of the bird's-eye view video V3-2 and the captured video V1 are transmitted to the camera 2, and the video data of the bird's-eye view video V3-1 are transmitted to the GUI device 11.

As a result, the camera operator can visually recognize the marker frustum 40M and the marker 55M according to the marking registration operation.

Since the marker frustum 40M and the marker 55M are not displayed on the director side, the bird's-eye view video V3-1 is not unnecessarily complicated.

### 4-5: Examples of Various Displays

Moreover, as still another example, display examples of appropriate bird's-eye view videos V3-1 and V3-2 on the director side and the camera operator side will be described.

FIG. 49A illustrates an example in which the bird's-eye view video V3-1 is displayed as the device display image 51 of the GUI device 11, and FIG. 49B illustrates an example in which the bird's-eye view video V3-2 is simultaneously displayed as the viewfinder display video 50 of the camera 2.

In the bird's-eye view video V3-1 of FIG. 49A, the view frustums 40a, 40b, and 40c of the cameras 2 are displayed in a similar manner, for example, in white translucency.

In the bird's-eye view video V3-2 of FIG. 49B, in the camera 2 corresponding to the view frustum 40b, the view frustum 40b is highlighted in, for example, red translucency, and the view frustums 40a and 40c of the other cameras 2 are displayed in normal white translucency.

Although not illustrated, in the camera 2 corresponding to the view frustum 40a, the view frustum 40a is highlighted in, for example, red translucency, and the view frustums 40b and 40c of the other cameras 2 are displayed in normal white translucency.

Furthermore, in the camera 2 corresponding to the view frustum 40c, the view frustum 40c is highlighted in red translucency, for example, and the view frustums 40a and 40b of the other cameras 2 are displayed in normal white translucency.

In this way, the director can equally confirm the view frustum 40 of each camera 2, and the camera operator can easily confirm the view frustum 40 of the camera 2 operated by the camera operator.

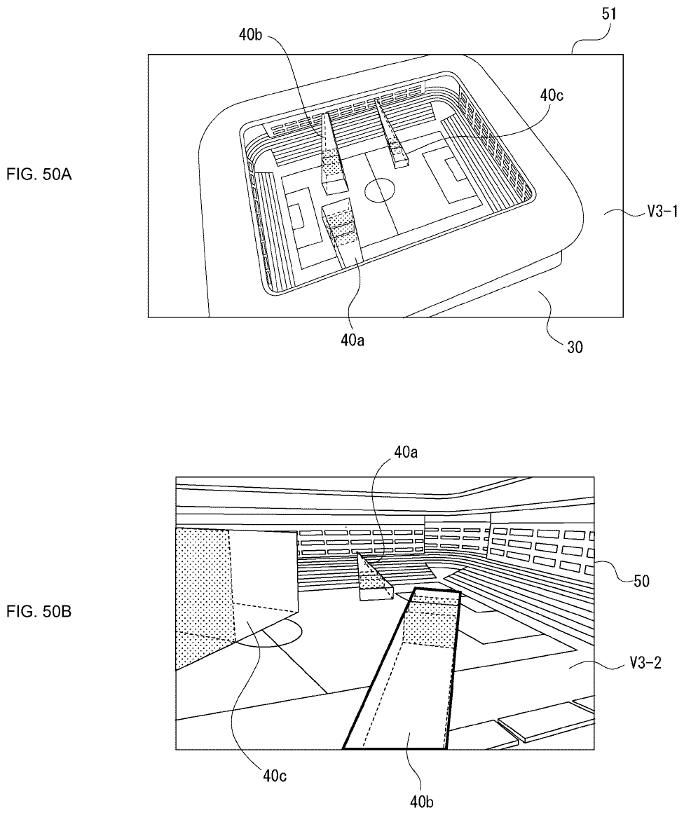

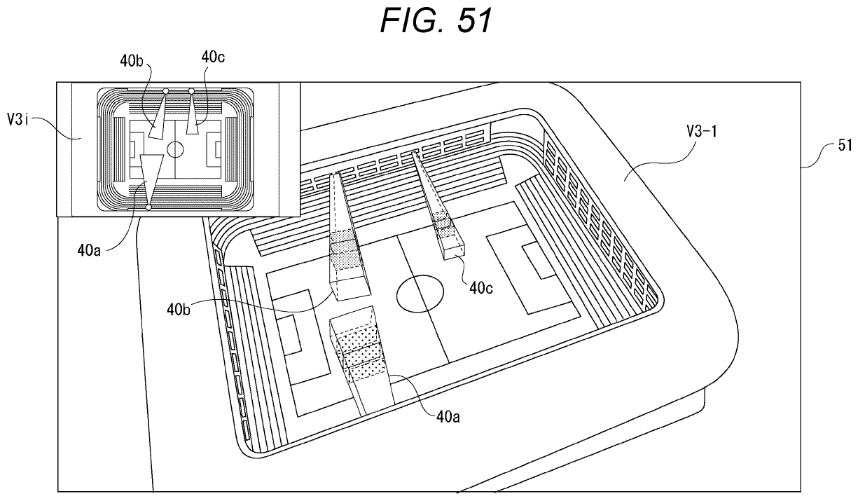

FIG. 50A illustrates an example in which the bird's-eye view video V3-1 is displayed as the device display image 51 of the GUI device 11, and FIG. 50B illustrates an example in which the bird's-eye view video V3-2 is simultaneously displayed as the viewfinder display video 50 of the camera 2.

In the bird's-eye view video V3-1 of FIG. 50A, the view frustums 40a, 40b, and 40c of the cameras 2 are displayed in a similar manner, for example, in white translucency. By setting a relatively high position in the CG space 30 corresponding to the imaging target space 8 as the viewpoint position, the entire image is easily viewed.

In the bird's-eye view video V3-2 of FIG. 50B, in the camera 2 corresponding to the view frustum 40b, the view frustum 40b is highlighted in, for example, red translucency, and the view frustums 40a and 40c of the other cameras 2 are displayed in normal white translucency. Moreover, the viewpoint position is the position of the camera 2 corresponding to the view frustum 40b.

Although not illustrated, in the bird's-eye view video V3-2 displayed by the camera 2 corresponding to the view frustum 40a, the view frustum 40a is highlighted in, for example, red translucency, the view frustums 40b and 40c of the other cameras 2 are displayed in normal white translucency, and the viewpoint position is the position of the camera 2 of the view frustum 40a.

Furthermore, in the bird's-eye view video V3-2 of the camera 2 corresponding to the view frustum 40c, the own view frustum 40 is similarly highlighted, and the viewpoint position is the position of the camera 2 of the view frustum 40c.

In this way, the director can equally confirm the view frustum 40 of each camera 2, and the camera operator can confirm the view frustum 40 of the camera 2 operated by the camera operator from a viewpoint similar to the viewpoint of the camera operator.

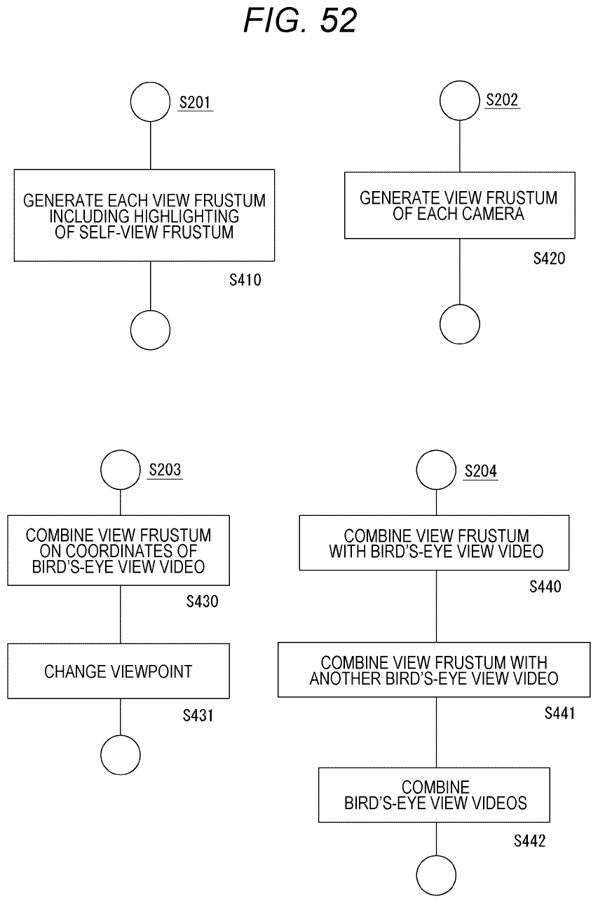

FIG. 51 illustrates an example in which a bird's-eye view video V3-1 is displayed as the device display image 51 of the GUI device 11. In this case, as the bird's-eye view videos V3-1a and V3-1b, two bird's-eye view videos are combined and displayed. The bird's-eye view video V3-1a is a video from a viewpoint obliquely above the game venue, and the bird's-eye view video V3-1b is a video from a viewpoint directly above the game venue.

The director needs to grasp the entire camera. Therefore, it is preferable to display a plurality of bird's-eye view videos V3-1 from different viewpoints.

A processing example for displaying each example as described above will be described.

FIG. 52 illustrates a specific example of steps S201, S202, S203, and S204 in FIG. 30.

In step S201 of FIG. 30, the AR system 5 performs the processing of step S410 of FIG. 52. In step S410, the AR system 5 generates image data of the view frustum 40 for the camera operator on the basis of the metadata MT. In this case, the image data is set in a state where the view frustum 40 corresponding to the camera 2 to be processed is highlighted.

In step S202 of FIG. 30, the AR system 5 generates a view frustum 40 for the director in step S420 of FIG. 52. In this case, image data in a similar display mode is generated as the view frustum 40 corresponding to all the cameras 2.

In step S203 of FIG. 30, the AR system 5 performs the processing of steps S430 and S431 of FIG. 52.

In step S430, the AR system 5 sets the arrangement of the image data of the view frustum 40 in the 3D coordinate space as the bird's-eye view video V3-2.

In step S431, the AR system 5 generates video data as the bird's-eye view video V3-2 with the position of the target camera 2 in the 3D coordinate space as the viewpoint position.

As described above, the video data of the bird's-eye view video V3-2 to be transmitted to the camera 2 is generated.

In step S204 of FIG. 30, the AR system 5 performs the processing of steps S440, S441, and S442 of FIG. 52.

In step S440, the AR system 5 combines the view frustum 40 with the CG data as the bird's-eye view video V3-1a.

In step S441, the AR system 5 combines the view frustum 40 with the CG data as the bird's-eye view video V3-1b.

In step S442, the AR system 5 generates video data in which the bird's-eye view video V3-1a and the bird's-eye view video V3-1b are combined in one screen. As a result, video data of the bird's-eye view video V3-1 to be transmitted to the GUI device 11 is generated.

Thereafter, in step S205 of FIG. 30, the video data of the bird's-eye view video V3-2 is transmitted to the camera 2, and the video data of the bird's-eye view video V3-1 is transmitted to the GUI device 11.

As a result, the camera operator can visually recognize the bird's-eye view video V3-2 as illustrated in FIG. 50B, for example, and the director can visually recognize the bird's-eye view videos V3-1a and V3-1b as illustrated in FIG. 51, for example.

Note that, in each of the examples described above with reference to FIGS. 28 to 52, the captured video V1 may be displayed together with the view frustum 40 as described with reference to FIGS. 9 to 27. That is, the examples described in the embodiments can be implemented in a combined manner.

### 5. Summary and Modifications

According to the above-described embodiments, the following effects can be obtained.

For example, the information processing apparatus 70 as the AR system 5 of the embodiment includes the video processing unit 71a that generates video data for simultaneously displaying the bird's-eye view video V3 of the imaging target space 8, the view frustum 40 (imaging range presentation video) for presenting the capturing range of the camera 2 in the bird's-eye view video V3, and the captured video V1 of the camera 2 in one screen (See FIGS. 7 and 19.).

In the bird's-eye view video V3 as the CG space 30, the view frustum 40 of the camera 2 is displayed, and the captured video V1 is also displayed at the same time, so that the viewer can easily grasp the correspondence between the image of the camera 2 and the position in the space.

Furthermore, in the embodiment, an example has been described in which the video processing unit 71a generates video data in which the captured video V1 is displayed in the view frustum 40 (See FIGS. 9 to 14.).

In other words, the video processing unit 71a generates video data in which the captured video V1 is disposed within the imaging range presentation video (view frustum 40) range.

Moreover, in other words, the video processing unit 71a generates video data in which the captured video V1 is displayed in a state of being disposed within the range of the imaging range presentation video (view frustum 40).

By displaying the captured video V1 in the view frustum 40, the relationship between the view frustum 40 and the captured video of the camera 2 corresponding to the view frustum 40 is extremely easy for the viewer to understand.

Furthermore, in the embodiment, an example has been described in which the video processing unit 71a generates video data in which the captured video V1 is displayed at a position within the depth of field range indicated by the view frustum 40 (See FIGS. 9 and 10.).

The depth of field range 42 is displayed in the view frustum 40, and the captured video V1 is displayed inside the display of the depth of field range 42. As a result, the captured video V1 is displayed at a position close to the actual position of the subject in the bird's-eye view video V3.

Therefore, the viewer can easily grasp the relationship between the imaging range by the view frustum 40, the actual captured video V1, and the imaged subject position.

Furthermore, in the embodiment, an example has been described in which the video processing unit 71a generates video data in which captured video V1 is displayed on the focus plane 41 illustrated in the view frustum 40 (See FIG. 9.).

The focus plane 41 is displayed in the view frustum 40, and the captured video V1 is displayed on the focus plane 41. As a result, the viewer can easily confirm the focus position of the camera 2 and the image of the subject at that position.

Furthermore, in the embodiment, an example is described in which the video processing unit 71a generates the video data in which captured video V1 is displayed on the farther side from depth of field range 42 as viewed from frustum starting point 46 (See FIGS. 12 to 14.).

The view frustum 40 is a video spreading in a quadrangular pyramid shape, and the area of the cross section increases as it goes farther. Therefore, the captured video V1 can be displayed relatively large in the view frustum 40 by being displayed on or near the frustum far end face 45. For example, it is suitable in a case where it is desired to confirm the content of the captured video V1.

Furthermore, in the embodiment, an example has been described in which the video processing unit 71a generates video data in which the captured video V1 is displayed at a position (the surface 47 near the frustum starting point) closer to the frustum starting point 46 than the depth of field range 42 indicated by the view frustum 40 (See FIG. 11.).

For example, in a case where it is desired to confirm the depth of field range 42 or the focus plane 41 in the view frustum 40, or in a case where it is difficult to display the captured video V1 on the frustum far end face 45, it is preferable to display the captured video V1 at a position close to the frustum starting point 46.

In the embodiment, an example has been described in which the video generation control unit 71b that variably sets the display position of the captured video V1 to be simultaneously displayed in one screen together with the bird's-eye view video V3 and the view frustum 40 and controls generation of video data is provided (See FIGS. 7, 23, and 24.).

For example, the display position of the captured video V1 is set as any position in the view frustum 40 or any position outside the view frustum 40. With appropriate position setting, the viewer can easily grasp the captured video V1, and the view frustum 40 and the captured video V1 can be prevented from interfering with each other.

In the embodiment, an example has been described in which the video generation control unit 71b performs the display position change determination of the captured video V1, and changes the setting of the display position of the captured video V1 according to the determination result (See FIG. 24.).

For example, the change determination is performed such that the display position of the captured video V1 is automatically changed to an appropriate position. As a result, the view frustum 40 and the captured video V1 are displayed in an appropriate arrangement relationship for the viewer, for example, an arrangement relationship in which favorable visibility can be obtained or an arrangement relationship in which the correspondence relationship is easily understood.

In the embodiment, an example has been described in which the video generation control unit 71b determines whether or not it is necessary to change the display position of the captured video V1 on the basis of the positional relationship between the view frustum 40 and the object expressed by the bird's-eye view video V3 in the display position change determination (See step S160, P1 in FIG. 24.).

For example, when the far end side of the view frustum 40 is stuck in the ground GR or the structure CN in the bird's-eye view video V3, or the like, if the view frustum is displayed on the frustum far end face 45, an unnatural image is obtained or cannot be displayed. In such a case, the video generation control unit 71b determines that the position setting needs to be changed, and changes the position setting of the captured video V1. As a result, it is possible to automatically provide the captured video V1 in an easily viewable state.

In the embodiment, an example has been described in which, in the display position change determination, the video generation control unit 71b determines whether or not it is necessary to change the display position of the captured video V1 on the basis of the angle determined by the line-of-sight direction from the viewpoint of the entire bird's-eye view video V3 and the axial direction of the view frustum 40 (See step S160, P2 in FIG. 24.). That is, the angle is an angle between the normal direction on the display screen and the displayed view frustum 40 in the axial direction in the case of being viewed in the line-of-sight direction from the viewpoint set for the bird's-eye view video V3 at a certain time point. As described above, the axial direction of the view frustum 40 is a direction of a vertical line in a case where the vertical line perpendicular to the frustum far end face 45 is drawn from the frustum starting point 46.

The size and direction of the view frustum 40 to be drawn change according to the angle of view and the imaging direction of the camera 2. Depending on the angle of the view frustum 40 in the bird's-eye view video V3, a sufficient surface for displaying the captured video V1 may not be obtained in the view frustum 40. In this case, it is difficult for the viewer to confirm the content even if the captured video V1 is displayed. Therefore, the video generation control unit 71b determines that the position setting needs to be changed according to the angle of the view frustum 40, and changes the position setting of the captured video V1. As a result, it is possible to automatically provide the captured video V1 in an easily viewable state.

In the embodiment, an example has been described in which the video generation control unit 71b determines whether or not it is necessary to change the display position of the captured video V1 on the basis of the viewpoint change in the bird's-eye view video V3 in the display position change determination (See ste S160, P3 in FIG. 24.).

For example, as the viewpoint of the bird's-eye view video V3 is changed, the direction, size, angle, and the like of the view frustum 40 change. Therefore, when the viewpoint of the bird's-eye view video V3 is changed, the video generation control unit 71b determines whether or not the display of the captured video V1 so far is appropriate, and changes the setting if it is necessary to change the display. Consequently, even if the viewer arbitrarily changes the bird's-eye view video V3, the captured video V1 can always be provided in an easily viewable state.

In the embodiment, an example has been described in which the video generation control unit 71b uses the type information of the camera 2 that captures the captured video V1 to set the change destination of the captured video (See step S163 in FIG. 24.).

For example, the change destination of the display position of the captured video V1 is set according to the type of whether the camera 2 is the position fixing type by the tripod 6 or the like or the movement type. As a result, it is possible to set the position according to each of the fixed-position camera 2F and the mobile camera 2M. In particular, in the case of the mobile camera 2M, the view frustum 40 fluctuates frequently, and thus, it is possible to provide an easily viewable display by displaying the captured video V1 at a position where the fluctuation of the view frustum 40 is less affected.

In the embodiment, an example has been described in which the video generation control unit 71b changes the setting of the display position of the captured video V1 according to the user operation (See FIG. 23.).

To enable a user who is a viewer to arbitrarily switch a display position of a captured video V1. As a result, the captured video V1 can be displayed at a position according to the visibility and purpose of the viewer.

In the embodiment, an example has been described in which the video generation control unit 71b changes the display position of the captured video V1 in the view frustum 40 (See FIGS. 23 and 24.).

For example, in the view frustum 40, switching is performed among the focus plane 41, the frustum far end face 45, a plane on the frustum starting point 46 side, a plane within the depth of field range, and the like. As a result, the captured video V1 can be displayed at an appropriate position while the correspondence relationship between the view frustum 40 and the captured video V1 is clarified.

In the embodiment, an example has been described in which the video generation control unit 71b changes the display position of the captured video V1 inside the view frustum 40 and outside the view frustum 40 (See FIGS. 23 and 24.).

For example, the display position of the captured video V1 is changed at a position inside the view frustum 40 such as the focus plane 41, the frustum far end face 45, the surface on the frustum starting point 46 side, and the surface within the depth of field range, or at a position outside the view frustum 40 such as the vicinity of the camera, the screen corner, and the vicinity of the focus plane 41. As a result, the display position of the captured video V1 can be widely selected according to the state of the bird's-eye view video V3 and the view frustum 40.

In the embodiment, an example has been described in which the video processing unit 71a generates video data for simultaneously displaying the bird's-eye view video V3, the view frustum 40 of each of the plurality of cameras 2, and the captured video V1 of each of the plurality of cameras 2 in one screen (See FIGS. 16, 17, and 27.).

The view frustums 40 and the captured videos V1 of the plurality of cameras 2 are displayed in the CG space 30 represented by the bird's-eye view video V3. As a result, the viewer can easily grasp the relationship between the imaging ranges of the cameras 2. This is convenient, for example, in a case where a director or the like confirms the content captured by each camera 2.

The view frustum 40 is exemplified as the imaging range presentation video, and its shape is a quadrangular pyramid shape, but the present invention is not limited thereto. For example, an image in which a plurality of square outlines having a quadrangular pyramid cross section is arranged, or an image in which the outline of the quadrangular pyramid is expressed by a broken line may be used. Furthermore, the shape is not necessarily limited to a quadrangular pyramid, and may be a conical shape or the like.

Alternatively, the imaging range presentation video may be display of only the focus plane 41, display of only the depth of field range 42, or the like.

Furthermore, for example, the information processing apparatus 70 serving as the AR system 5 of the embodiment includes the video processing unit 71a that performs the processing of generating the first video data for displaying the view frustum 40 (imaging range presentation video) of the camera 2 in the imaging target space 8 and the processing of generating the second video data for displaying the video that displays the view frustum 40 in the imaging target space 8 and has a display mode different from that of the first video data in parallel.

In particular, in the embodiment, the first video data and the second video data are the video data of the bird's-eye view video V3-1 transmitted to the GUI device 11 and the video data of the bird's-eye view video V3-l transmitted to the camera 2.

By displaying the view frustum 40 of the camera 2 in the bird's-eye view video V3 as the CG space 30, the viewer can easily grasp the correspondence between the image of the camera 2 and the position in the space. For the bird's-eye view video V3 including the view frustum 40, it is possible to realize presentation of information suitable for each viewer by video display by generating video data of different display modes according to the role or the like of each viewer.

In the embodiment, one of the video data of the bird's-eye view videos V3-1 and V3-2 is the video data of the video visually recognized by the video production instructor, and the other is the video data of the video visually recognized by the imaging operator of the camera 2 with respect to the imaging target space 8.

For example, the bird's-eye view video V3-1 is assumed to be visually recognized by a video production instructor such as a director on the GUI device 11 or the like, and the bird's-eye view video V3-2 is assumed to be visually recognized by an imaging operator such as a camera operator. As described above, by displaying the bird's-eye view videos V30-1 and V3-2 having different video contents for a director and a camera operator, it is possible to present information suitable for each of a video production instruction and an imaging operation.

Note that the video production instructor in this case refers to a staff involved in video production, such as a director or a switching engineer, and refers to a person other than the imaging operator. The imaging operator refers to a Camera operator who directly operates the camera 2 or a staff member who remotely operates the camera 2.

In the embodiment, at least one of the video data of the bird's-eye view videos V3-1 and V3-2 is video data for displaying a video including the plurality of view frustums 40 corresponding to the plurality of cameras 2.

For example, one or both of the bird's-eye view videos V3-1, V3-2 display the view frustum 40 for the plurality of cameras 2. By displaying the plurality of view frustums 40, the director, the camera operator, and the like can easily grasp the positional relationship of each camera 2 and the subject.

For the bird's-eye view video V3-1 visually recognized by the director or the like, the view frustum 40 is displayed for the plurality of cameras 2, so that various instructions, selection of the main line image, and the like can be executed while recognizing the position and direction of the subject of each camera 2.

For the bird's-eye view vido V3-2 visually recognized by the camera operator, the view frustum 40 is displayed for the plurality of cameras 2, so that the imaging operation can be performed while considering the relationship with other cameras 2.

Note that, regarding the bird's-eye view video V3-2 visually recognized by the camera operator, only the view frustum 40 may be displayed for the camera 2 of its own. In this way, the camera operator can easily grasp the position of the subject in the entire captured video V1 obtained by his/her camera operation.

Moreover, in the bird's-eye view video V3-2 visually recognized by the camera operator, only the view frustum 40 may be displayed for the camera 2 of another camera operator. In this way, the camera operator can perform his/her camera operation while recognizing the imaging place or subject of his/her other camera 2.

In the embodiment, an example has been described in which the video processing unit 71a generates, as at least one of the video data of the bird's-eye view videos V2-1 and V3-2, video data for displaying a video in which a part of the plurality of view frustums 40 corresponding to the plurality of cameras 2 has a display mode different from that of the other view frustums 40.

That is, in a case where a plurality of view frustums 40 is displayed, a part of the view frustum is displayed in a display mode different from that of the other view frustums 40. This makes it possible to realize a display in which a particular view frustum 40 has a meaning in the display of the plurality of view frustums 40.

In the embodiment, an example has been described in which the video processing unit 71a generates video data for displaying a video in which some of the plurality of view frustums 40 corresponding to the plurality of cameras 2 are highlighted as at least one of the video data of the bird's-eye view videos V3-1 and V3-2.

In the case of displaying a plurality of view frustums 40, a particular view frustum 40 may be specified by displaying a portion of the view frustum 40 more highlighted than the other view frustums.

The highlighting may be, for example, a display with increased luminance, a display in which a conspicuous color is selected, a display in which an outline or the like is emphasized, a blinking display, or the like.

In the embodiment, an example has been described in which the video processing unit 71a generates, as the bird's-eye view video V3-1, video data for displaying a video in which the view frustum 40 of the specific camera, which is the camera 2 including the subject of interest in the captured video V1 among the plurality of cameras 2, has a display mode different from that of the other view frustums 40 (See FIGS. 28 to 32.).

By clearly indicating the view frustum 40 of the camera 2 selected among the cameras 2 imaging the subject of interest, it is easy for the director to grasp which camera is appropriate in a case where he/she wants to set the video of the subject of interest as the main line video. Furthermore, the director can easily grasp the positional relationship between the camera 2 capturing the subject of interest and the imaging direction of another camera 2.

Then, the specific camera that highlights the view frustum 40 is the camera 2 having the highest screen occupancy of the subject of interest in the captured video V1 (See FIGS. 29, 30, and 31.).

By clearly indicating the camera 2 in which the subject of interest is captured the largest in the screen, the director can give an instruction while grasping the situation of the camera 2 mainly capturing the subject of interest and the other cameras 2.

Furthermore, the specific camera that highlights the view frustum 40 is the camera 2 having the longest continuous imaging time of the subject of interest in the captured video V1 (See FIG. 32.).

By clearly indicating the camera 2 that continuously captures the subject of interest, the director can grasp and instruct the situation of the camera 2 or another camera 2 that mainly captures the subject of interest.

In the embodiment, an example has been described in which the video processing unit 71a generates, as the video data of the bird's-eye view video V3-1, video data for displaying a video in which the view frustum 40 of the camera 2 that has detected the specifying operation by the imaging operator among the plurality of cameras 2 has a display mode different from that of the other view frustums 40 (See FIGS. 33 and 34.).

By enabling the camera operator to perform feedback operation to the director when a good video is captured, it is easy for the director side to grasp the voice of the camera operator side. In particular, it is easy to grasp a situation in which a good scene has been imaged suddenly.

In the embodiment, an example has been described in which, in a case where the view frustums 40 of the plurality of cameras 2 overlap in the display video, the video processing unit 71a generates, as the video data of the bird's-eye view video V3-1, video data for displaying a video in which the plurality of overlapping view frustums 40 has a display mode different from that of the view frustum 40 that does not overlap (See FIGS. 35 and 36.).

In a case where the plurality of view frustums 40 overlaps each other, the plurality of cameras 2 captures a direction of a common subject. By clearly indicating this to the director, it is suitable for an instruction for a common subject. For example, the information presentation is suitable for an instruction to change the focus position and the angle of view of the cameras 2, and is also suitable for switching the main line video.

In the embodiment, an example has been described in which, in a case where the view frustums 40 of the plurality of cameras 2 overlap each other on the display video, the video processing unit 71a generates video data for preferentially displaying one of the plurality of overlapping view frustums 40 as at least one of the bird's-eye view videos V3-1 and V3-2 (See FIGS. 37 and 38.).

In a case where a plurality of view frustums 40 overlaps, one view frustum 40 is preferentially displayed in the overlapping portion. For example, in the overlapping portion, only one prioritized view frustum 40 is caused to display the focus plane 41 and the depth of field range 42. By preventing the display of the focus plane 41 and the depth of field range 42 from overlapping, the bird's-eye view video V3 can be made easy to see without being complicated.

Furthermore, in the overlapping portion, it is also conceivable to increase the luminance of only one prioritized view frustum 40 or to set a conspicuous color. Moreover, the above-described highlighting may be performed. In the overlapping portion, a view frustum other than the prioritized view frustum 40 may not be displayed. This also allows the bird's-eye view video V3 including the plurality of view frustums 40 to be easily viewed.

As a specific example, for example, there is an example in which the view frustum 40 of the camera 2, which is the main line video, is preferentially displayed in the bird's-eye view video V3-1 visually recognized by the director, and priority setting is not particularly performed in the bird's-eye view video V3-2 visually recognized by the camera operator.

Furthermore, there is an example in which priority setting is not particularly performed in the bird's-eye view video V3-1 visually recognized by the director, and the view frustum 40 of the camera 2 operated by the camera operator is preferentially displayed in the bird's-eye view video V3-2 visually recognized by the camera operator.

In the embodiment, an example has been described in which the video processing unit 71a generates video data for displaying videos including instruction videos in display modes different from each other as the bird's-eye view videos V3-1 and V3-2, respectively (See FIGS. 39 to 45.).

For example, in a case where the director operates the view frustum 40 on the screen to give an instruction, the instruction content can be confirmed by the instruction frustum 40DR. The instruction frustum 40DR is displayed on the screen on the camera operator side so that the instruction content can be visually understood. In this case, by performing display suitable for the role in the bird's-eye view videos V3-1 and V3-2, respectively, it is possible to smoothly advance imaging.

In the embodiment, an example has been described in which the video processing unit 71a sets the video data of the bird's-eye view video V3-1 as video data for displaying instruction videos for the plurality of cameras 2, and sets the video data of the bird's-eye view video V3-2 as video data for displaying instruction videos for a specific camera 2 among the plurality of cameras (See FIGS. 39, 41, and 42.).

As a result, the director side can grasp an instruction to each camera. The camera operator can easily recognize the instruction by displaying only the instruction for himself/herself.

In the embodiment, an example has been described in which the video processing unit 71a uses the video data of the bird's-eye view video V3-2 as the video data for displaying the instruction video in the video of the viewpoint according to the position of the specific camera 2 among the plurality of cameras (See FIGS. 42 and 43.).

The instruction frustum 40DR is displayed in the bird's-eye view video V3-2 from the viewpoint position of the camera operator, so that the direction of the instruction can be easily understood from the state in which the camera operator is looking.

In the embodiment, an example has been described in which the video processing unit 71a generates, as the video data of the bird's-eye view video V3-2, the video data for displaying the current view frustum 40 and the marker video in the imaging direction based on the marking operation (See FIGS. 46 to 48.).

The bird's-eye view video V3-2 including the marker images such as the marker frustum 40M and the marker 55M is displayed in response to the camera operator performing the marking operation. As a result, the camera operator marks an image capturing position and a subject set by himself/herself, and this is useful in the case of imaging the position at an appropriate time.

Furthermore, by not displaying such a marker video on the bird's-eye view video V3-1 on the director side, it is possible to prevent the bird's-eye view video V3-1 from being unnecessarily complicated.

In the embodiment, an example has been described in which the video processing unit 71a generates, as the video data of the bird's-eye view video V3-2, video data for displaying a bird's-eye view video of a viewpoint according to the position of a specific camera 2 among the plurality of cameras, and generates, as the video data of the bird's-eye view video V3-1, video data for displaying bird's-eye view videos of different viewpoints (See FIGS. 49 to 52.).

Since the bird's-eye view video V3-2 is displayed from the viewpoint equivalent to the viewpoint position of the camera operator, the camera operator can easily recognize the entire situation and the imaging direction of the camera operator. For the director, the bird's-eye view video V3-1 is displayed not from the viewpoint of a specific camera operator but from the viewpoint that is easy to grasp the whole, which is suitable for the entire imaging conducting.

In the embodiment, an example has been described in which the video processing unit 71a generates, as the video data of the bird's-eye view video V3-1, video data for displaying a plurality of bird's-eye view videos V3-1a and V3-1b from a plurality of viewpoints (See FIGS. 51 and 52.).

Since it is necessary for the director to grasp the imaging situation of each camera 2, the bird's-eye view video V3-1 that allows the entire bird's-eye view at a plurality of viewpoint positions as illustrated in FIG. 51 is very useful.

In the embodiment, an example has been described in which the video processing unit 71a generates the bird's-eye view video V3 as a virtual image by CG.

As a result, the bird's-eye view video V3 from a free viewpoint can be generated, and the view frustum 40 and the captured video V1 can be displayed on expressions of various viewpoints.

Meanwhile, in the embodiment, the view frustum 40 presents the imaging direction and the angle of view at the time of imaging in real time, but for example, the past view frustum 40 at the time of pre-simulation of the camerawork may be displayed.

For example, the current view frustum 40 and the past view frustum 40 at the time of imaging may be simultaneously displayed and compared.

Furthermore, in such a case, the past view frustum 40 may be made different from the current view frustum 40 by increasing transparency or the like, so that the camera operator or the like can distinguish the view frustum.

The program of the embodiment is a program for causing a processor such as a CPU or a DSP, or a device including the processor to execute the above-described processing illustrated in FIGS. 20, 21, 22, 23, and 24. Furthermore, the program of the embodiment is a program for causing the information processing apparatus 70 to execute processing of generating video data for simultaneously displaying the bird's-eye view video V3 of the imaging target space, the view frustum 40 (imaging range presentation video) for presenting the imaging range of the camera 2 in the bird's-eye view video V3, and the captured video V1 of the camera 2 in one screen.

Furthermore, the program of the embodiment is a program for causing a processor such as a CPU or a DSP, or a device including the processor to execute the above-described processing illustrated in FIGS. 30, 31, 32, 34, 36, 38, 41, 43, 45, 48, and 52. That is, the program of the embodiment is a program for causing the information processing apparatus 70 to execute processing of generating first video data for displaying the view frustum 40 (imaging range presentation video) for presenting the imaging range of the camera 2 in the imaging target space and processing of generating second video data for displaying a video that displays the view frustum 40 in the imaging target space and has a display mode different from that of the video based on the first video data in parallel.

With such a program, the information processing apparatus 70 that operates like the AR system 5 described above can be implemented by various computer apparatuses.

Such a program can be recorded in advance in an HDD as a recording medium built in a device such as a computer apparatus, a ROM in a microcomputer having a CPU, or the like. Furthermore, such a program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as what is called package software.

Furthermore, such a program may be installed from the removable recording medium into a personal computer and the like, or may be downloaded from a download site through a network such as a local area network (LAN) or the Internet.

Furthermore, such a program is suitable for providing the information processing apparatus 70 of the embodiments in a wide range. For example, by downloading the program to a personal computer, a communication apparatus, a portable terminal apparatus such as a smartphone or a tablet, a mobile phone, a gaming device, a video device, a personal digital assistant (PDA), or the like, it is possible to cause these apparatuses to function as the information processing apparatus 70 of the present disclosure.

Note that the effects described in the present specification are merely examples and are not limited, and other effects may be provided.

Note that the present technology can also have the following configurations.
(1)

An information processing apparatus including
a video processing unit that performs in parallel processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.
(2)

The information processing apparatus according to (1) described above, in which
one of the first video data and the second video data includes video data of a video visually recognized by a video production instructor, and another includes video data of a video visually recognized by an imaging operator of a camera with respect to the imaging target space.
(3)

The information processing apparatus according to (1) or (2) described above, in which
at least one of the first video data and the second video data includes video data for displaying a video including a plurality of the imaging range presentation videos corresponding to a plurality of cameras, respectively.
(4)

The information processing apparatus according to any one of (1) to (3) described above, in which
the video processing unit generates, as at least one of the first video data and the second video data, video data for displaying a video in which a display mode of some of a plurality of the imaging range presentation videos corresponding to a plurality of cameras, respectively, is set to be different from a display mode of others of the imaging range presentation videos.
(5)

The information processing apparatus according to any one of (1) to (4) described above, in which
the video processing unit generates, as at least one of the first video data and the second video data, video data for displaying a video in which some of a plurality of the imaging range presentation videos corresponding to a plurality of cameras, respectively, are highlighted.
(6)

The information processing apparatus according to any one of (1) to (5) described above, in which
the video processing unit generates, as the first video data, video data for displaying a video in which a display mode of the imaging range presentation video of a specific camera is set to be different from a display mode of another imaging range presentation video, the specific camera being a camera including a subject of interest in a captured video among a plurality of cameras.
(7)

The information processing apparatus according to (6) described above, in which
the specific camera includes a camera having a highest screen occupancy of the subject of interest in the captured video.
(8)

The information processing apparatus according to (6) described above, in which
the specific camera includes a camera having a longest continuous imaging time of the subject of interest in the captured video.
(9)

The information processing apparatus according to any one of (1) to (8) described above, in which
the video processing unit generates, as the first video data, video data for displaying a video in which a display mode of the imaging range presentation video of a camera is set to be different from a display mode of another imaging range presentation video, the camera having detected a specific operation by an imaging operator among a plurality of cameras.
(10)

The information processing apparatus according to any one of (1) to (9) described above, in which
the video processing unit generates, as the first video data, video data for displaying a video in which in a case where a plurality of the imaging range presentation videos of a plurality of cameras overlaps each other in a display video, a display mode of the imaging range presentation videos that overlap is set to be different from a display mode of the imaging range presentation videos that do not overlap.
(11)

The information processing apparatus according to any one of (1) to (10) described above, in which
the video processing unit generates, as at least one of the first video data and the second video data, video data for, in a case where a plurality of the imaging range presentation videos of a plurality of cameras overlaps each other on a display video, preferentially displaying one of the imaging range presentation videos that overlap.
(12)

The information processing apparatus according to any one of (1) to (11) described above, in which
the video processing unit generates, as each of the first video data and the second video data, video data for displaying a video including an instruction video in display modes different from each other.
(13)

The information processing apparatus according to (12) described above, in which
the video processing unit sets the first video data as video data for displaying an instruction video for a plurality of cameras, and
sets the second video data as video data for displaying an instruction video for a specific camera among the plurality of cameras.
(14)

The information processing apparatus according to (12) or (13) described above, in which
the video processing unit sets the second video data as video data for displaying an instruction video in a video of a viewpoint according to a position of a specific camera among a plurality of cameras.

The information processing apparatus according to any one of (1) to (14) described above, in which
the video processing unit generates, as the second video data, video data for displaying the imaging range presentation video at present and a marker video in an imaging direction based on a marking operation.
(16)

The information processing apparatus according to any one of (1) to (15) described above, in which
the video processing unit generates, as the second video data, video data for displaying a bird's-eye view video of a viewpoint according to a position of a specific camera among a plurality of cameras, and
generates, as the first video data, video data for displaying a bird's-eye view video of a viewpoint different from the viewpoint.
(17)

The information processing apparatus according to any one of (1) to (16) described above, in which
the video processing unit generates, as the first video data, video data for displaying a plurality of bird's-eye view videos from a plurality of viewpoints.
(18)

An information processing method including:
performing in parallel, by an information processing apparatus, processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.
(19)

A program for causing an information processing apparatus to execute in parallel
processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.

### REFERENCE SIGNS LIST

1, 1A Camera system
2 Camera
3 CCU
4 AI board
5 AR system
6 Tripod
8 Imaging target space
10 Control panel
11 GUI device
12 Network hub
13 Switcher
14 Master monitor
30 CG space
35 Environment map
40, 40a, 40b, 40c View frustum
40DR Instruction frustum
40M1, 40M2, 40M Marker frustum
41 Focus plane
42 Depth of field range
43 Depth near end face
44 Depth far end face
45 Frastum far end face
46 Frastum starting point
47 Surface near frustum starting point
V1 Captured video
V2 AR superimposed video
V3 Bird's-eye view video
70 Information processing apparatus
71 CPU
71a Video processing unit
71b Video generation control unit

1. An information processing apparatus comprising
a video processing unit that performs in parallel processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.

2. The information processing apparatus according to claim 1, wherein
one of the first video data and the second video data includes video data of a video visually recognized by a video production instructor, and another includes video data of a video visually recognized by an imaging operator of a camera with respect to the imaging target space.

3. The information processing apparatus according to claim 1, wherein
at least one of the first video data and the second video data includes video data for displaying a video including a plurality of the imaging range presentation videos corresponding to a plurality of cameras, respectively.

4. The information processing apparatus according to claim 1, wherein
the video processing unit generates, as at least one of the first video data and the second video data, video data for displaying a video in which a display mode of some of a plurality of the imaging range presentation videos corresponding to a plurality of cameras, respectively, is set to be different from a display mode of others of the imaging range presentation videos.

5. The information processing apparatus according to claim 1, wherein
the video processing unit generates, as at least one of the first video data and the second video data, video data for displaying a video in which some of a plurality of the imaging range presentation videos corresponding to a plurality of cameras, respectively, are highlighted.

6. The information processing apparatus according to claim 1, wherein
the video processing unit generates, as the first video data, video data for displaying a video in which a display mode of the imaging range presentation video of a specific camera is set to be different from a display mode of another imaging range presentation video, the specific camera being a camera including a subject of interest in a captured video among a plurality of cameras.

7. The information processing apparatus according to claim 6, wherein
the specific camera includes a camera having a highest screen occupancy of the subject of interest in the captured video.

8. The information processing apparatus according to claim 6, wherein
the specific camera includes a camera having a longest continuous imaging time of the subject of interest in the captured video.

9. The information processing apparatus according to claim 1, wherein
the video processing unit generates, as the first video data, video data for displaying a video in which a display mode of the imaging range presentation video of a camera is set to be different from a display mode of another imaging range presentation video, the camera having detected a specific operation by an imaging operator among a plurality of cameras.

10. The information processing apparatus according to claim 1, wherein
the video processing unit generates, as the first video data, video data for displaying a video in which in a case where a plurality of the imaging range presentation videos of a plurality of cameras overlaps each other in a display video, a display mode of the imaging range presentation videos that overlap is set to be different from a display mode of the imaging range presentation videos that do not overlap.

11. The information processing apparatus according to claim 1, wherein
the video processing unit generates, as at least one of the first video data and the second video data, video data for, in a case where a plurality of the imaging range presentation videos of a plurality of cameras overlaps each other on a display video, preferentially displaying one of the imaging range presentation videos that overlap.

12. The information processing apparatus according to claim 1, wherein
the video processing unit generates, as each of the first video data and the second video data, video data for displaying a video including an instruction video in display modes different from each other.

13. The information processing apparatus according to claim 12, wherein
the video processing unit sets the first video data as video data for displaying an instruction video for a plurality of cameras, and
sets the second video data as video data for displaying an instruction video for a specific camera among the plurality of cameras.

14. The information processing apparatus according to claim 12, wherein
the video processing unit sets the second video data as video data for displaying an instruction video in a video of a viewpoint according to a position of a specific camera among a plurality of cameras.

15. The information processing apparatus according to claim 1, wherein
the video processing unit generates, as the second video data, video data for displaying the imaging range presentation video at present and a marker video in an imaging direction based on a marking operation.

16. The information processing apparatus according to claim 1, wherein
the video processing unit generates, as the second video data, video data for displaying a bird's-eye view video of a viewpoint according to a position of a specific camera among a plurality of cameras, and
generates, as the first video data, video data for displaying a bird's-eye view video of a viewpoint different from the viewpoint.

17. The information processing apparatus according to claim 1, wherein
the video processing unit generates, as the first video data, video data for displaying a plurality of bird's-eye view videos from a plurality of viewpoints.

18. An information processing method comprising:
performing in parallel, by an information processing apparatus, processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.

19. A program for causing an information processing apparatus to execute in parallel
processing of generating first video data for displaying an imaging range presentation video that presents an imaging range of a camera in an imaging target space, and processing of generating second video data for displaying a video that displays the imaging range presentation video in the imaging target space and in a display mode different from a video according to the first video data.
